(19) United States
(12) Patent Application Publication
(10) Pub. No.: US 2025/0142066 A1
(43) Pub. Date: May 1, 2025

(54) PARALLEL PROCESSING OF IMAGE REGIONS WITH NEURAL NETWORKS – DECODING, POST FILTERING, AND RDOQ

(71) Applicant: HUAWEI TECHNOLOGIES CO., LTD., Shenzhen (CN)

(72) Inventors: Johannes Sauer, Munich (DE); Panqi Jia, Munich (DE); Elena Alexandrovna Alshina, Munich (DE); Atanas Boev, Munich (DE)

(73) Assignee: HUAWEI TECHNOLOGIES CO., LTD., Shenzhen (CN)

(21) Appl. No.: 19/007,327

(22) Filed: Dec. 31, 2024

Related U.S. Application Data
(63) Continuation of application No. PCT/EP2022/068295, filed on Jul. 1, 2022.

(51) Int. Cl. H04N 19/119; H04N 19/176; H04N 19/186

(52) U.S. Cl. CPC H04N 19/119; H04N 19/176; H04N 19/186

(57) ABSTRACT

The present disclosure relates to picture encoding and decoding of image regions on tile-basis. In particular, multiple components of an input tensor including a first and second component in spatial dimensions is processed within multiple pipelines. The processing of the first component includes dividing the first component in the spatial dimensions into a first plurality of tiles. Likewise, the processing of the second component includes dividing the second component in the spatial dimensions into a second plurality of tiles. The respective first and second plurality of tiles are then processed each separately. Among the first and second plurality of tiles there are at least two respective collocated tiles differing in size. In case of compression, the processing of the first and/or second component includes picture encoding, rate distortion optimization quantization, and picture filtering. In case of decompression, the processing includes picture decoding and picture filtering.

### CROSS-REFERENCE TO RELATED APPLICATIONS

This application is a continuation of International Application No. PCT/EP2022/068295, filed on Jul. 1, 2022, the disclosure of which is hereby incorporated by reference in its entirety.

### TECHNICAL FIELD

Embodiments of the present disclosure generally relate to the field of picture or video encoding and decoding, and in particular to encoding and decoding of neural-network-based bitstreams.

### BACKGROUND

Video coding (video encoding and decoding) is used in a wide range of digital video applications, for example broadcast digital TV, video transmission over internet and mobile networks, real-time conversational applications such as video chat, video conferencing, DVD and Blu-ray discs, video content acquisition and editing systems, and camcorders of security applications.

The amount of video data needed to depict even a relatively short video can be substantial, which may result in difficulties when the data is to be streamed or otherwise communicated across a communications network with limited bandwidth capacity. Thus, video data is generally compressed before being communicated across modern day telecommunications networks. The size of a video could also be an issue when the video is stored on a storage device because memory resources may be limited. Video compression devices often use software and/or hardware at the source to code the video data prior to transmission or storage, thereby decreasing the quantity of data needed to represent digital video images. The compressed data is then received at the destination by a video decompression device that decodes the video data. With limited network resources and ever increasing demands of higher video quality, improved compression and decompression techniques that improve compression ratio with little to no sacrifice in picture quality are desirable.

Neural networks (NNs) and deep-learning (DL) techniques, making use of artificial neural networks have now been used for some time, also in the technical field of encoding and decoding of videos, images (e.g. still images) and the like.

It is desirable to further improve efficiency of such picture coding (video picture coding or still picture coding) based on trained networks (e.g. neural networks NN) that account for limitations in available memory and/or processing speed of the decoder and/or encoder.

### SUMMARY

Some embodiments of the present disclosure provide methods and apparatuses for encoding and/or decoding of a picture in an efficient manner, thus reducing the memory footprint and the required operation frequency of the processing units. In particular, the present disclosure enables a tradeoff between memory resources and computational complexity within an NN-based video/picture encoding-decoding framework, applicable for moving and still images.

The foregoing and other objects are achieved by the subject matter of the independent claims. Further implementation forms are apparent from the dependent claims, the description, and the figures.

According to an aspect of the present disclosure, a method is provided for processing an input tensor representing picture data, the method comprising steps of: processing a plurality of components of the input tensor including a first component and a second component in spatial dimensions, the processing including: processing the first component including dividing the first component in the spatial dimensions into a first plurality of tiles and processing the tiles of the first plurality of tiles separately; processing the second component including dividing the second component in the spatial dimensions into a second plurality of tiles and processing the tiles of the second plurality of tiles separately; wherein at least two respective collocated tiles of the first plurality of tiles and the second plurality of tiles differ in size. As a result, an input tensor representing picture data may be efficiently processed on a component basis by use of tiles in a sample aligned manner within multiple pipelines. Hence, the memory requirements are lowered, while improving the processing performance (e.g. compression and decompression) without increase of computational complexity.

In some exemplary implementations, at least two tiles of the first plurality of tiles are processed independently or in parallel; and/or at least two tiles of the second plurality of tiles are processed independently or in parallel. Thus, components of an input tensor may be processed fast, improving the processing efficiency.

In a further implementation, the first component represents luma component of the picture data; and the second component represents a chroma component of the picture data. Accordingly, both luma and chroma components may be processed via multiple pipelines within the same processing framework.

In one example, tiles of the first plurality of tiles that are adjacent in at least one dimension of the spatial dimensions partly overlap; and/or tiles of the second plurality of tiles that are adjacent in at least one dimension of the spatial dimensions partly overlap. Thus, the quality of the reconstructed picture may be improved, in particular along the boundaries of the tiles. Hence, picture artefacts may be reduced.

According to an implementation, said dividing of the first component includes determining sizes of tiles in the first plurality of tiles based on a first predefined condition; and/or said dividing of the second component includes determining sizes of tiles in the second plurality of tiles based on a second predefined condition. For example, the first predefined condition and/or the second predefined condition is based on available decoder hardware resources and/or motion present in the picture data. Hence, the tile sizes may be adapted and optimized according to available decoder resources and/or motion, enabling content-based tile sizes. In a further example, said determining the sizes of tiles in the second plurality of tiles includes scaling the tiles of the first plurality of tiles. As a result, tiles sizes of the second plurality of tiles may be determined quickly, improving the efficiency of processing of the tiles.

In an exemplary implementation, an indication of the determined sizes of tiles in the first plurality of tiles and/or in the second plurality of tiles is encoded into a bitstream. Hence, the indication of tile sizes is efficiently included into the bitstream requiring low level processing.

In another implementation, sizes of all tiles in the first plurality of tiles is same and/or sizes of all tiles in the second plurality of tiles is same. As a result, the tiles may be processed efficiently without additional processing for handling different tiles sizes, accelerating the tile processing.

In a second example, the indication further includes positions of the tiles in the first plurality of tiles and/or in the second plurality of tiles.

According to an implementation, the first component is a luma component and the indication of the sizes of the tiles of the first plurality of tiles is included in the bitstream; and the second component is chroma component and the indication of a scaling factor is included in the bitstream, wherein the scaling factor relates the sizes of the tiles of the first plurality of tiles and the sizes of the tiles of the second plurality of tiles. Hence, tile sizes of the chroma component may be obtained quickly by fast operation of scaling tiles sizes of the luma component. Further, the overhead for signaling tiles sizes for chroma may be reduced by use of a scaling factor as indication.

In an exemplary implementation, the processing of the input tensor includes processing that is part of picture or moving picture compression. For example, the processing of the first component and/or the second component includes one of: picture encoding by a neural network; and rate distortion optimization quantization, RDOQ; and picture filtering. Hence, the compression processing may be performed in a flexible manner including various kind of processing (encoding, RDOQ and filtering).

A further exemplary implementation comprises: generating the bitstream by including an output of the processing of the first component and the second component into the bitstream. Thus, the processing output may be included quickly into the bitstream requiring low level processing.

In an exemplary implementation, the processing of the input tensor includes processing that is part of picture or moving picture decompression. For example, the processing of the first component and/or the second component includes one of: picture decoding by a neural network; and picture filtering. Hence, the decompression processing may be performed in a flexible manner including various kind of processing (encoding and filtering). For example, the processing of the second component includes decoding of a chroma component of the picture based on a representation of a luma component of the picture. Hence, the luma component may be used as auxiliary information for decoding chroma component(s). This may improve the quality of the decoded chroma. In a further example, the processing of the first component and/or the second component includes picture post-filtering; for at least two tiles of the first plurality of tiles one or more parameters of post-filtering differ and are extracted from said bitstream; and for at least two tiles of the second plurality of tiles one or more parameters of post-filtering differ and are extracted from said bitstream. Hence, filter parameters may be efficiently signaled via the bitstream. Moreover, the post filtering may be performed with filter parameters adapted to the tiles sizes, improving the quality of the reconstructed picture data.

In an exemplary implementation, the input tensor is a picture or a sequence of pictures including one or more components, among the plurality of components, at least one of which is a color component.

According to an aspect of the present disclosure, provided is a computer program stored on a non-transitory medium comprising code which when executed on one or more processors performs steps of any of the previous aspects of the present disclosure.

According to an aspect of the present disclosure, an apparatus is provided for processing an input tensor representing picture data, the apparatus comprising processing circuitry configured to: process a plurality of components of the input tensor including a first component and a second component in spatial dimensions, the processing including: processing the first component including dividing the first component in the spatial dimensions into a first plurality of tiles and processing the tiles of the first plurality of tiles separately; processing the second component including dividing the second component in the spatial dimensions into a second plurality of tiles and processing the tiles of the second plurality of tiles separately; wherein at least two respective collocated tiles of the first plurality of tiles and the second plurality of tiles differ in size.

According to an aspect of the present disclosure, an apparatus for processing an input tensor representing picture data, the apparatus comprising: one or more processors; and a non-transitory computer-readable storage medium coupled to the one or more processors and storing programming for execution by the one or more processors, wherein the programming, when executed by the one or more processors, configures the processing apparatus to carry out the method according to any of the previous aspects of the present disclosure.

The present disclosure is applicable both to end-to-end AI codecs and hybrid AI codecs. In Hybrid AI codec, for example, the filtering operation (filtering of the reconstructed picture) can be performed by means of a neural network (NN). The present disclosure applies to such NN-based processing modules. In general, the present disclosure can be applied to the whole or a part of a video compression and decompression process, if at least part of the processing includes an NN, and if such NN includes convolution or transposed convolution operations. For example, the present disclosure is applicable to individual processing tasks as being performed as a part of processing performed by an encoder and/or decoder, including in-loop filtering and/or post-filtering and/or pre-filtering.

It is noted that the present disclosure is not limited to a particular framework. Moreover, the present disclosure is not restricted to image or video compression, and may be applied to object detection, image generation, and recognition systems as well.

The invention can be implemented in hardware (HW) and/or software (SW). Moreover, HW-based implementations may be combined with SW-based implementations.

For the purpose of clarity, any one of the foregoing embodiments may be combined with any one or more of the other foregoing embodiments to create a new embodiment within the scope of the present disclosure.

Details of one or more embodiments are set forth in the accompanying drawings and the description below. Other features, objects, and advantages will be apparent from the description, drawings, and claims.

### BRIEF DESCRIPTION OF THE DRAWINGS

In the following embodiments of the invention are described in more detail with reference to the attached figures and drawings, in which:

FIG. 1A is a block diagram showing an example of a video coding system configured to implement embodiments of the invention.

FIG. 1B is a block diagram showing another example of a video coding system configured to implement embodiments of the invention.

FIG. 2 is a block diagram illustrating an example of an encoding apparatus or a decoding apparatus.

FIG. 3 is a block diagram illustrating another example of an encoding apparatus or a decoding apparatus.

FIG. 4 is a block diagram illustrating an exemplary hybrid encoder configured to implement embodiments of the invention.

FIG. 5 is a block diagram illustrating an exemplary hybrid decoder configured to implement embodiments of the invention.

FIG. 6A is a schematic drawing illustrating a variational autoencoder architecture including a hyperprior model.

FIG. 6B is a schematic drawing illustrating another example of a variational autoencoder architecture including a hyperprior model similar to FIG. 6A.

FIG. 7 is a block diagram illustrating parts of an exemplary autoencoder.

FIG. 8 illustrates the compression of input data by the encoder, and the decompression of data by the decoder, with the compressed data represented by the latent space.

FIG. 9 is a block diagram of an encoder and a decoder in line with a VAE framework.

FIG. 9A is a block diagram of an encoder with respective components according to FIG. 9.

FIG. 9B is a block diagram of a decoder with respective components according to FIG. 9.

FIG. 10 illustrates the total receptive field including all input samples needed to generate the output samples.

FIG. 11 illustrates the subset of the total receptive field, in which case the output samples are generated by a lower amount of samples (subset) as the number of samples of the total receptive field. Padding of samples may be needed.

FIG. 12 illustrates downsampling of input samples to one output sample using two convolutional layers.

FIG. 13 exemplifies calculating the total receptive field for a set of 2×2 output samples using two convolutional layers with a 3×3 kernel size.

FIG. 14 illustrates an example of parallel processing where a picture is divided into two tiles, with the decoding of the respective bitstreams and the sample reconstruction being performed both independently.

FIG. 15 illustrates an example of parallel processing where a coding tree block (CTB) is divided into slices (rows) where the bitstream of each slice is decoded (nearly) independently, but not the sample reconstruction of the slices.

FIG. 16 is a block diagram of an encoder and decoder with respective modules, including NN-based subnetworks for processing a first and a second plurality of tiles according to the FIRST EMBODIMENT.

FIG. 17A shows an example of dividing a first and/or second tensor into overlapping regions Li (i.e. first and second tiles), the subsequent cropping of samples in the overlap region, and the concatenation of the cropped regions. Each Li comprises the total receptive field.

FIG. 17B shows another example of dividing a first and/or second tensor into overlapping regions Li (i.e. first and second tiles) similar to FIG. 17A, except that cropping is dismissed.

FIG. 18 shows an example of dividing a first and/or second tensor into overlapping regions Li (i.e. first and second tiles), the subsequent cropping of samples in the overlap region and the concatenation of the cropped regions. Each Li comprises a subset of the total receptive field.

FIG. 19 shows an example of dividing a first and/or second tensor into non-overlapping regions Li (i.e. first and second tiles), the subsequent cropping of samples, and the concatenation of the cropped regions. Each Li comprises a subset of the total receptive field.

FIG. 20 illustrates the various parameters, such as the sizes of regions Li, Ri, and overlap regions etc. of first and/or second tiles, that may be included into (and parsed from) the bitstream. Any of the various parameters may be included as an indication into (and parsed from) the bitstream.

FIG. 21 shows a flowchart of the method for encoding an input tensor representing picture data according to the first embodiment.

FIG. 22 shows a flowchart of the method for decoding a tensor representing picture data according to the FIRST EMBODIMENT.

FIG. 23 shows a block diagram of a processing apparatus for encoding an input tensor representing picture data, comprising a processing circuitry. The processing circuitry may be configured such that the circuitry includes modules performing the processing of the encoding method according to the FIRST EMBODIMENT.

FIG. 24 shows a block diagram of a processing apparatus for decoding a tensor representing picture data, comprising a processing circuitry. The processing circuitry may be configured such that the circuitry includes modules performing the processing of the decoding method according to the FIRST EMBODIMENT.

FIG. 25 is a block diagram of an encoder-decoder with respective modules, where luma and chroma components of a tensor are processed separately in multiple pipelines and each pipeline processing separately a plurality of tiles of respective component according to the SECOND EMBODIMENT.

FIG. 26 shows a flowchart of the method for processing an input tensor representing picture data according to the SECOND EMBODIMENT.

FIG. 27 shows a block diagram of an apparatus for processing an input tensor representing picture data, comprising respective processing circuitry and modules according to the SECOND EMBODIMENT.

### DESCRIPTION

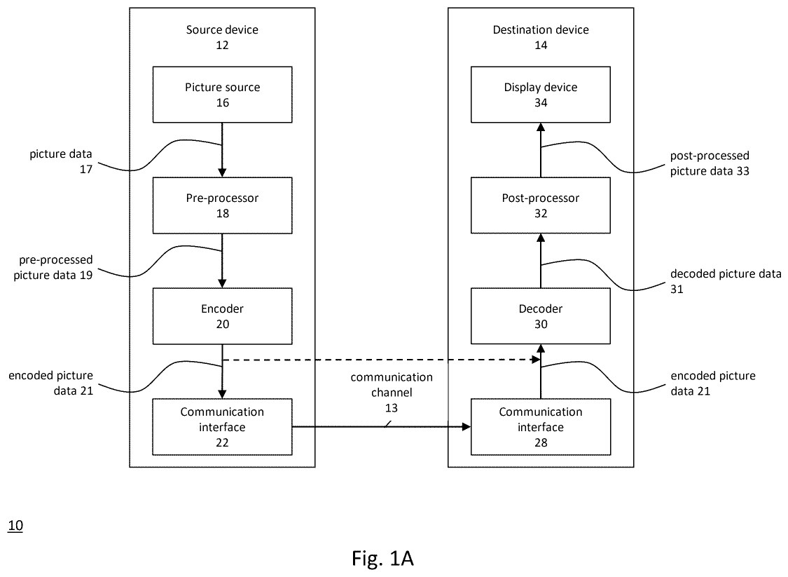

In the following, some embodiments of the present disclosure are described with reference to the Figures. FIGS. 1 to 3 refer to video coding systems and methods that may be used together with more specific embodiments of the invention described in the further Figures. Specifically, the embodiments described in relation to FIGS. 1 to 3 may be used with encoding/decoding techniques described further below that make use of a neural network for encoding a bitstream and/or decoding a bitstream.

In the following description, reference is made to the accompanying Figures, which form part of the disclosure, and which show, by way of illustration, specific aspects of the present disclosure or specific aspects in which embodiments of the present disclosure may be used. It is understood that the embodiments may be used in other aspects and comprise structural or logical changes not depicted in the figures. The following detailed description, therefore, is not to be taken in a limiting sense, and the scope of the present disclosure is defined by the appended claims.

For instance, it is understood that a disclosure in connection with a described method may also hold true for a corresponding device or system configured to perform the method and vice versa. For example, if one or a plurality of specific method steps are described, a corresponding device may include one or a plurality of units, e.g. functional units, to perform the described one or plurality of method steps (e.g. one unit performing the one or plurality of steps, or a plurality of units each performing one or more of the plurality of steps), even if such one or more units are not explicitly described or illustrated in the figures. On the other hand, for example, if a specific apparatus is described based on one or a plurality of units, e.g. functional units, a corresponding method may include one step to perform the functionality of the one or plurality of units (e.g. one step performing the functionality of the one or plurality of units, or a plurality of steps each performing the functionality of one or more of the plurality of units), even if such one or plurality of steps are not explicitly described or illustrated in the figures. Further, it is understood that the features of the various exemplary embodiments and/or aspects described herein may be combined with each other, unless specifically noted otherwise.

Video coding typically refers to the processing of a sequence of pictures, which form the video or video sequence. Instead of the term “picture”, the term “frame” or “image” may be used as synonyms in the field of video coding. Video coding (or coding in general) comprises two parts video encoding and video decoding. Video encoding is performed at the source side, typically comprising processing (e.g. by compression) the original video pictures to reduce the amount of data required for representing the video pictures (for more efficient storage and/or transmission). Video decoding is performed at the destination side and typically comprises the inverse processing compared to the encoder to reconstruct the video pictures. Embodiments referring to “coding” of video pictures (or pictures in general) shall be understood to relate to “encoding” or “decoding” of video pictures or respective video sequences. The combination of the encoding part and the decoding part is also referred to as CODEC (Coding and Decoding).

In case of lossless video coding, the original video pictures can be reconstructed, i.e. the reconstructed video pictures have the same quality as the original video pictures (assuming no transmission loss or other data loss during storage or transmission). In case of lossy video coding, further compression, e.g. by quantization, is performed, to reduce the amount of data representing the video pictures, which cannot be completely reconstructed at the decoder, i.e. the quality of the reconstructed video pictures is lower or worse compared to the quality of the original video pictures.

Several video coding standards belong to the group of “lossy hybrid video codecs” (i.e. combine spatial and temporal prediction in the sample domain and 2D transform coding for applying quantization in the transform domain). Each picture of a video sequence is typically partitioned into a set of non-overlapping blocks and the coding is typically performed on a block level. In other words, at the encoder the video is typically processed, i.e. encoded, on a block (video block) level, e.g. by using spatial (intra picture) prediction and/or temporal (inter picture) prediction to generate a prediction block, subtracting the prediction block from the current block (block currently processed/to be processed) to obtain a residual block, transforming the residual block and quantizing the residual block in the transform domain to reduce the amount of data to be transmitted (compression), whereas at the decoder the inverse processing compared to the encoder is applied to the encoded or compressed block to reconstruct the current block for representation. Furthermore, the encoder duplicates the decoder processing loop such that both will generate identical predictions (e.g. intra- and inter predictions) and/or re-constructions for processing, i.e. coding, the subsequent blocks. Recently, some parts or the entire encoding and decoding chain has been implemented by using a neural network or, in general, any machine learning or deep learning framework.

In the following embodiments of a video coding system 10, a video encoder 20 and a video decoder 30 are described based on FIG. 1.

FIG. 1A is a schematic block diagram illustrating an example coding system 10, e.g. a video coding system 10 (or short coding system 10) that may utilize techniques of this present application. Video encoder 20 (or short encoder 20) and video decoder 30 (or short decoder 30) of video coding system 10 represent examples of devices that may be configured to perform techniques in accordance with various examples described in the present application.

As shown in FIG. 1A, the coding system 10 comprises a source device 12 configured to provide encoded picture data 21, e.g. to a destination device 14 for decoding the encoded picture data 13.

The source device 12 comprises an encoder 20, and may additionally, i.e. optionally, comprise a picture source 16, a pre-processor (or pre-processing unit) 18, e.g. a picture pre-processor 18, and a communication interface or communication unit 22. Some embodiments of the present disclosure (e.g. relating to an initial rescaling or rescaling between two proceeding layers) may be implemented by the encoder 20. Some embodiments (e.g. relating to an initial rescaling) may be implemented by the picture pre-processor 18.

The picture source 16 may comprise or be any kind of picture capturing device, for example a camera for capturing a real-world picture, and/or any kind of a picture generating device, for example a computer-graphics processor for generating a computer animated picture, or any kind of other device for obtaining and/or providing a real-world picture, a computer generated picture (e.g. a screen content, a virtual reality (VR) picture) and/or any combination thereof (e.g. an augmented reality (AR) picture). The picture source may be any kind of memory or storage storing any of the aforementioned pictures.

In distinction to the pre-processor 18 and the processing performed by the pre-processing unit 18, the picture or picture data 17 may also be referred to as raw picture or raw picture data 17.

Pre-processor 18 is configured to receive the (raw) picture data 17 and to perform pre-processing on the picture data 17 to obtain a pre-processed picture 19 or pre-processed picture data 19. Pre-processing performed by the pre-processor 18 may, e.g., comprise trimming, colour format conversion (e.g. from RGB to YCbCr or from RGB to YUV in general), colour correction, or de-noising. It can be understood that the pre-processing unit 18 may be optional component. In the following, the colour space components (such as R, G, B for the RGB space and the Y, U, V for the YUV space) are also referred to as colour channels. Moreover, in YUV or YCbCr color spaces, Y stands for luminance (or luma) and U, V, Cb, Cr for chrominance (chroma) channels (components).

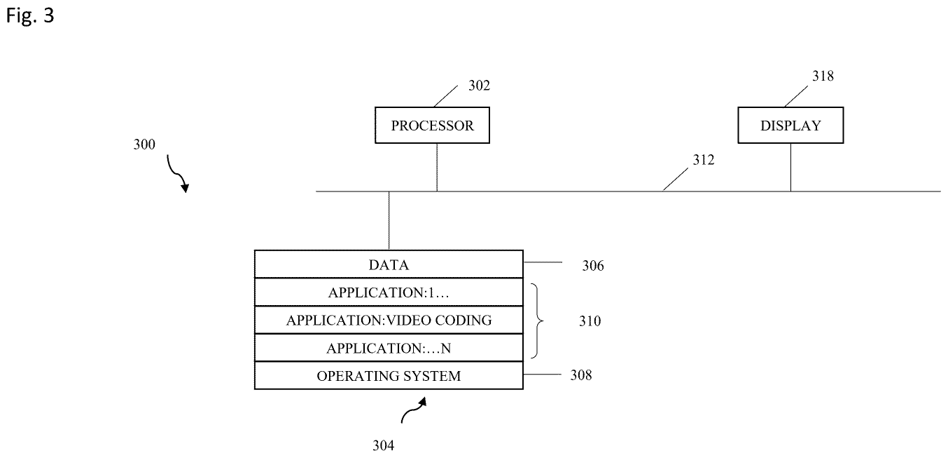

The video encoder 20 is configured to receive the pre-processed picture data 19 and provide encoded picture data 21 (further details will be described below, e.g. based on FIG. 4). The encoder 20 may be implemented via processing circuitry 46 to embody the various modules as discussed with respect to encoder 20 of FIG. 4 and/or any other encoder system or subsystem described herein.

Communication interface 22 of the source device 12 may be configured to receive the encoded picture data 21 and to transmit the encoded picture data 21 (or any further processed version thereof) over communication channel 13 to another device, e.g. the destination device 14 or any other device, for storage or direct reconstruction.

The destination device 14 comprises a decoder 30 (e.g. a video decoder 30), and may additionally, i.e. optionally, comprise a communication interface or communication unit 28, a post-processor 32 (or post-processing unit 32) and a display device 34.

The communication interface 28 of the destination device 14 is configured receive the encoded picture data 21 (or any further processed version thereof), e.g. directly from the source device 12 or from any other source, e.g. a storage device, e.g. an encoded picture data storage device, and provide the encoded picture data 21 to the decoder 30.

The communication interface 22 and the communication interface 28 may be configured to transmit or receive the encoded picture data 21 or encoded data 13 via a direct communication link between the source device 12 and the destination device 14, e.g. a direct wired or wireless connection, or via any kind of network, e.g. a wired or wireless network or any combination thereof, or any kind of private and public network, or any kind of combination thereof.

The communication interface 22 may be, e.g., configured to package the encoded picture data 21 into an appropriate format, e.g. packets, and/or process the encoded picture data using any kind of transmission encoding or processing for transmission over a communication link or communication network.

The communication interface 28, forming the counterpart of the communication interface 22, may be, e.g., configured to receive the transmitted data and process the transmission data using any kind of corresponding transmission decoding or processing and/or de-packaging to obtain the encoded picture data 21.

Both, communication interface 22 and communication interface 28 may be configured as unidirectional communication interfaces as indicated by the arrow for the communication channel 13 in FIG. 1A pointing from the source device 12 to the destination device 14, or bi-directional communication interfaces, and may be configured, e.g. to send and receive messages, e.g. to set up a connection, to acknowledge and exchange any other information related to the communication link and/or data transmission, e.g. encoded picture data transmission.

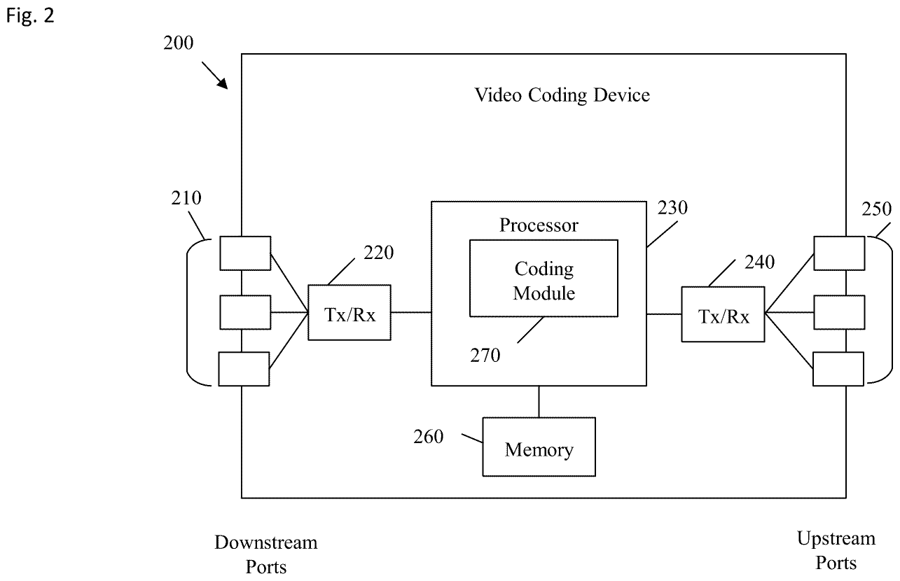

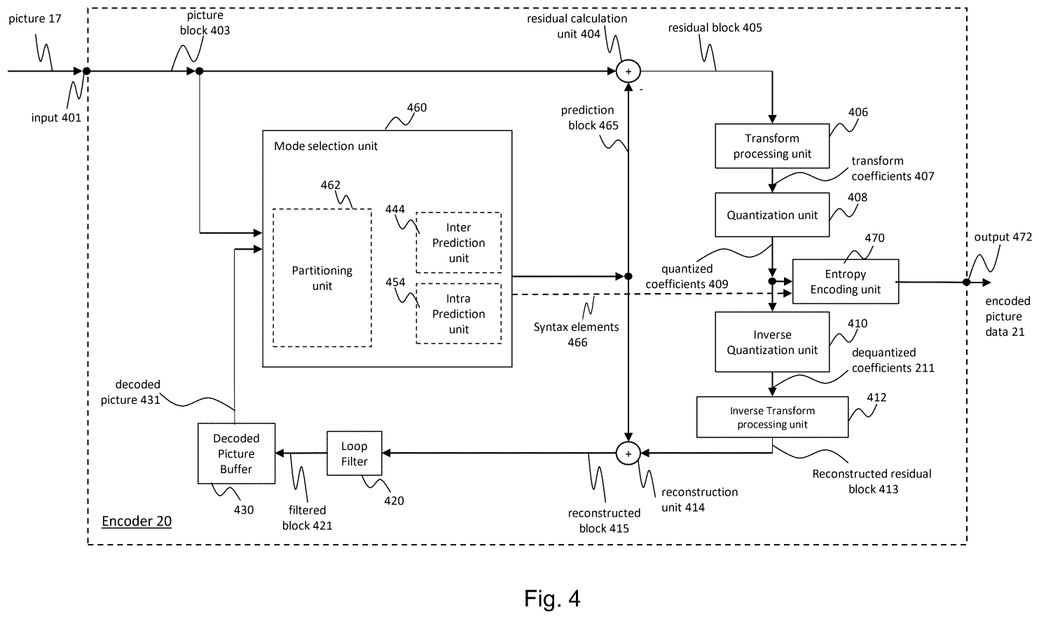

The decoder 30 is configured to receive the encoded picture data 21 and provide decoded picture data 31 or a decoded picture 31 (further details will be described below, e.g., based on FIG. 3 and FIG. 5). The decoder 30 may be implemented via processing circuitry 46 to embody the various modules as discussed with respect to decoder 30 of FIG. 5 and/or any other decoder system or subsystem described herein.

The post-processor 32 of destination device 14 is configured to post-process the decoded picture data 31 (also called reconstructed picture data), e.g. the decoded picture 31, to obtain post-processed picture data 33, e.g. a post-processed picture 33. The post-processing performed by the post-processing unit 32 may comprise, e.g. colour format conversion (e.g. from YCbCr to RGB), colour correction, trimming, or re-sampling, or any other processing, e.g. for preparing the decoded picture data 31 for display, e.g. by display device 34.

Some embodiments of the disclosure may be implemented by the decoder 30 or by the post-processor 32.

The display device 34 of the destination device 14 is configured to receive the post-processed picture data 33 for displaying the picture, e.g. to a user or viewer. The display device 34 may be or comprise any kind of display for representing the reconstructed picture, e.g. an integrated or external display or monitor. The displays may, e.g. comprise liquid crystal displays (LCD), organic light emitting diodes (OLED) displays, plasma displays, projectors, micro LED displays, liquid crystal on silicon (LCoS), digital light processor (DLP) or any kind of other display.

Although FIG. 1A depicts the source device 12 and the destination device 14 as separate devices, embodiments of devices may also comprise both or both functionalities, the source device 12 or corresponding functionality and the destination device 14 or corresponding functionality. In such embodiments the source device 12 or corresponding functionality and the destination device 14 or corresponding functionality may be implemented using the same hardware and/or software or by separate hardware and/or software or any combination thereof.

As will be apparent for the skilled person based on the description, the existence and (exact) split of functionalities of the different units or functionalities within the source device 12 and/or destination device 14 as shown in FIG. 1A may vary depending on the actual device and application.

The encoder 20 (e.g. a video encoder 20) or the decoder 30 (e.g. a video decoder 30) or both encoder 20 and decoder 30 may be implemented via processing circuitry, as shown in FIG. 1B, such as one or more microprocessors, digital signal processors (DSPs), application-specific integrated circuits (ASICs), field-programmable gate arrays (FPGAs), discrete logic, hardware, video coding dedicated or any combinations thereof. The encoder 20 may be implemented via processing circuitry 46 to embody various modules and/or any other encoder system or subsystem described herein. The decoder 30 may be implemented via processing circuitry 46 to embody various modules and/or any other decoder system or subsystem described herein. The processing circuitry may be configured to perform the various operations as discussed later. As shown in FIG. 3, if the techniques are implemented partially in software, a device may store instructions for the software in a suitable, non-transitory computer-readable storage medium and may execute the instructions in hardware using one or more processors to perform the techniques of this disclosure. Either of video encoder 20 and video decoder 30 may be integrated as part of a combined encoder/decoder (CODEC) in a single device, for example, as shown in FIG. 1B.

Source device 12 and destination device 14 may comprise any of a wide range of devices, including any kind of handheld or stationary devices, e.g. notebook or laptop computers, mobile phones, smart phones, tablets or tablet computers, cameras, desktop computers, set-top boxes, televisions, display devices, digital media players, video gaming consoles, video streaming devices (such as content services servers or content delivery servers), broadcast receiver device, broadcast transmitter device, or the like and may use no or any kind of operating system. In some cases, the source device 12 and the destination device 14 may be equipped for wireless communication. Thus, the source device 12 and the destination device 14 may be wireless communication devices.

In some cases, video coding system 10 illustrated in FIG. 1A is merely an example and the techniques of the present application may apply to video coding settings (e.g., video encoding or video decoding) that do not necessarily include any data communication between the encoding and decoding devices. In other examples, data is retrieved from a local memory, streamed over a network, or the like. A video encoding device may encode and store data to memory, and/or a video decoding device may retrieve and decode data from memory. In some examples, the encoding and decoding is performed by devices that do not communicate with one another, but simply encode data to memory and/or retrieve and decode data from memory.

For convenience of description, some embodiments are described herein, for example, by reference to High-Efficiency Video Coding (HEVC) or to the reference software of Versatile Video coding (VVC), the next generation video coding standard developed by the Joint Collaboration Team on Video Coding (JCT-VC) of ITU-T Video Coding Experts Group (VCEG) and ISO/IEC Motion Picture Experts Group (MPEG). One of ordinary skill in the art will understand that embodiments of the invention are not limited to HEVC or VVC.

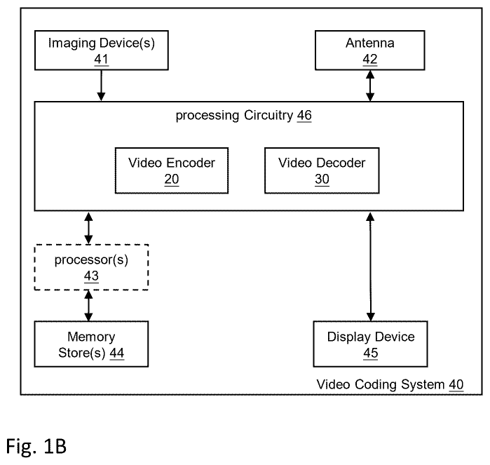

FIG. 2 is a schematic diagram of a video coding device 200 according to an embodiment of the disclosure. The video coding device 200 is suitable for implementing the disclosed embodiments as described herein. In an embodiment, the video coding device 200 may be a decoder such as video decoder 30 of FIG. 1A or an encoder such as video encoder 20 of FIG. 1A.

The video coding device 200 comprises ingress ports 210 (or input ports 210) and receiver units (Rx) 220 for receiving data; a processor, logic unit, or central processing unit (CPU) 230 to process the data; transmitter units (Tx) 240 and egress ports 250 (or output ports 250) for transmitting the data; and a memory 260 for storing the data. The video coding device 200 may also comprise optical-to-electrical (OE) components and electrical-to-optical (EO) components coupled to the ingress ports 210, the receiver units 220, the transmitter units 240, and the egress ports 250 for egress or ingress of optical or electrical signals.

The processor 230 is implemented by hardware and software. The processor 230 may be implemented as one or more CPU chips, cores (e.g., as a multi-core processor), FPGAs, ASICS, and DSPs. The processor 230 is in communication with the ingress ports 210, receiver units 220, transmitter units 240, egress ports 250, and memory 260. The processor 230 comprises a coding module 270. The coding module 270 implements the disclosed embodiments described above. For instance, the coding module 270 implements, processes, prepares, or provides the various coding operations. The inclusion of the coding module 270 therefore provides a substantial improvement to the functionality of the video coding device 200 and effects a transformation of the video coding device 200 to a different state. Alternatively, the coding module 270 is implemented as instructions stored in the memory 260 and executed by the processor 230.

The memory 260 may comprise one or more disks, tape drives, and solid-state drives and may be used as an over-flow data storage device, to store programs when such programs are selected for execution, and to store instructions and data that are read during program execution. The memory 260 may be, for example, volatile and/or non-volatile and may be a read-only memory (ROM), random access memory (RAM), ternary content-addressable memory (TCAM), and/or static random-access memory (SRAM).

FIG. 3 is a simplified block diagram of an apparatus 300 that may be used as either or both of the source device 12 and the destination device 14 from FIG. 1 according to an exemplary embodiment.

A processor 302 in the apparatus 300 can be a central processing unit. Alternatively, the processor 302 can be any other type of device, or multiple devices, capable of manipulating or processing information now-existing or hereafter developed. Although the disclosed implementations can be practiced with a single processor as shown, e.g., the processor 302, advantages in speed and efficiency can be achieved using more than one processor.

A memory 304 in the apparatus 300 can be a read only memory (ROM) device or a random access memory (RAM) device in an implementation. Any other suitable type of storage device can be used as the memory 304. The memory 304 can include code and data 306 that is accessed by the processor 302 using a bus 312. The memory 304 can further include an operating system 308 and application programs 310, the application programs 310 including at least one program that permits the processor 302 to perform the methods described here. For example, the application programs 310 can include applications 1 through N, which further include a video coding application that performs the methods described here.

The apparatus 300 can also include one or more output devices, such as a display 318. The display 318 may be, in one example, a touch sensitive display that combines a display with a touch sensitive element that is operable to sense touch inputs. The display 318 can be coupled to the processor 302 via the bus 312.

Although depicted here as a single bus, the bus 312 of the apparatus 300 can be composed of multiple buses. Further, the secondary storage 314 can be directly coupled to the other components of the apparatus 300 or can be accessed via a network and can comprise a single integrated unit such as a memory card or multiple units such as multiple memory cards. The apparatus 300 can thus be implemented in a wide variety of configurations.

FIG. 4 shows a schematic block diagram of an example video encoder 20 that is configured to implement the techniques of the present application. In the example of FIG. 4, the video encoder 20 comprises an input 401 (or input interface 401), a residual calculation unit 404, a transform processing unit 406, a quantization unit 408, an inverse quantization unit 410, and inverse transform processing unit 412, a reconstruction unit 414, a loop filter unit 420, a decoded picture buffer (DPB) 430, a mode selection unit 460, an entropy encoding unit 470 and an output 472 (or output interface 472). The mode selection unit 460 may include an inter prediction unit 444, an intra prediction unit 454 and a partitioning unit 462. Inter prediction unit 444 may include a motion estimation unit and a motion compensation unit (not shown). A video encoder 20 as shown in FIG. 4 may also be referred to as hybrid video encoder or a video encoder according to a hybrid video codec.

The encoder 20 may be configured to receive, e.g. via input 401, a picture 17 (or picture data 17), e.g. picture of a sequence of pictures forming a video or video sequence. The received picture or picture data may also be a pre-processed picture 19 (or pre-processed picture data 19). For sake of simplicity the following description refers to the picture 17. The picture 17 may also be referred to as current picture or picture to be coded (in particular in video coding to distinguish the current picture from other pictures, e.g. previously encoded and/or decoded pictures of the same video sequence, i.e. the video sequence which also comprises the current picture).

A (digital) picture is or can be regarded as a two-dimensional array or matrix of samples with intensity values. A sample in the array may also be referred to as pixel (short form of picture element) or a pel. The number of samples in horizontal and vertical direction (or axis) of the array or picture define the size and/or resolution of the picture. For representation of color, typically three color components are employed, i.e. the picture may be represented or include three sample arrays. In RGB format or color space a picture comprises a corresponding red, green and blue sample array. However, in video coding each pixel is typically represented in a luminance and chrominance format or color space, e.g. YCbCr, which comprises a luminance component indicated by Y (sometimes also L is used instead) and two chrominance components indicated by Cb and Cr. The luminance (or short luma) component Y represents the brightness or grey level intensity (e.g. like in a grey-scale picture), while the two chrominance (or short chroma) components Cb and Cr represent the chromaticity or color information components. Accordingly, a picture in YCbCr format comprises a luminance sample array of luminance sample values (Y), and two chrominance sample arrays of chrominance values (Cb and Cr). Pictures in RGB format may be converted or transformed into YCbCr format and vice versa, the process is also known as color transformation or conversion. If a picture is monochrome, the picture may comprise only a luminance sample array. Accordingly, a picture may be, for example, an array of luma samples in monochrome format or an array of luma samples and two corresponding arrays of chroma samples in 4:2:0, 4:2:2, and 4:4:4 color format.

Embodiments of the video encoder 20 may comprise a picture partitioning unit (not depicted in FIG. 2) configured to partition the picture 17 into a plurality of (typically non-overlapping) picture blocks 403. These blocks may also be referred to as root blocks, macro blocks (H.264/AVC) or coding tree blocks (CTB) or coding tree units (CTU) (H.265/HEVC and VVC). The picture partitioning unit may be configured to use the same block size for all pictures of a video sequence and the corresponding grid defining the block size, or to change the block size between pictures or subsets or groups of pictures, and partition each picture into the corresponding blocks. The abbreviation AVC stands for Advanced Video Coding.

In further embodiments, the video encoder may be configured to receive directly a block 403 of the picture 17, e.g. one, several or all blocks forming the picture 17. The picture block 403 may also be referred to as current picture block or picture block to be coded.

Like the picture 17, the picture block 403 again is or can be regarded as a two-dimensional array or matrix of samples with intensity values (sample values), although of smaller dimension than the picture 17. In other words, the block 403 may comprise, e.g., one sample array (e.g. a luma array in case of a monochrome picture 17, or a luma or chroma array in case of a color picture) or three sample arrays (e.g. a luma and two chroma arrays in case of a color picture 17) or any other number and/or kind of arrays depending on the color format applied. The number of samples in horizontal and vertical direction (or axis) of the block 403 define the size of block 403. Accordingly, a block may, for example, an M×N (M-column by N-row) array of samples, or an M×N array of transform coefficients.

Embodiments of the video encoder 20 as shown in FIG. 4 may be configured to encode the picture 17 block by block, e.g. the encoding and prediction is performed per block 403.

Embodiments of the video encoder 20 as shown in FIG. 4 may be further configured to partition and/or encode the picture by using slices (also referred to as video slices), wherein a picture may be partitioned into or encoded using one or more slices (typically non-overlapping), and each slice may comprise one or more blocks (e.g. CTUs).

Embodiments of the video encoder 20 as shown in FIG. 4 may be further configured to partition and/or encode the picture by using tile groups (also referred to as video tile groups) and/or tiles (also referred to as video tiles), wherein a picture may be partitioned into or encoded using one or more tile groups (typically non-overlapping), and each tile group may comprise, e.g. one or more blocks (e.g. CTUs) or one or more tiles, wherein each tile, e.g. may be of rectangular shape and may comprise one or more blocks (e.g. CTUs), e.g. complete or fractional blocks.

FIG. 5 shows an example of a video decoder 30 that is configured to implement the techniques of this present application. The video decoder 30 is configured to receive encoded picture data 21 (e.g. encoded bitstream 21), e.g. encoded by encoder 20, to obtain a decoded picture 531. The encoded picture data or bitstream comprises information for decoding the encoded picture data, e.g. data that represents picture blocks of an encoded video slice (and/or tile groups or tiles) and associated syntax elements.

The entropy decoding unit 504 is configured to parse the bitstream 21 (or in general encoded picture data 21) and perform, for example, entropy decoding to the encoded picture data 21 to obtain, e.g., quantized coefficients 309 and/or decoded coding parameters (not shown in FIG. 3), e.g. any or all of inter prediction parameters (e.g. reference picture index and motion vector), intra prediction parameter (e.g. intra prediction mode or index), transform parameters, quantization parameters, loop filter parameters, and/or other syntax elements. Entropy decoding unit 504 may be configured to apply the decoding algorithms or schemes corresponding to the encoding schemes as described with regard to the entropy encoding unit 470 of the encoder 20. Entropy decoding unit 504 may be further configured to provide inter prediction parameters, intra prediction parameter and/or other syntax elements to the mode application unit 360 and other parameters to other units of the decoder 30. Video decoder 30 may receive the syntax elements at the video slice level and/or the video block level. In addition or as an alternative to slices and respective syntax elements, tile groups and/or tiles and respective syntax elements may be received and/or used.

The reconstruction unit 514 (e.g. adder or summer 514) may be configured to add the reconstructed residual block 513, to the prediction block 565 to obtain a reconstructed block 515 in the sample domain, e.g. by adding the sample values of the reconstructed residual block 513 and the sample values of the prediction block 565.

Embodiments of the video decoder 30 as shown in FIG. 5 may be configured to partition and/or decode the picture by using slices (also referred to as video slices), wherein a picture may be partitioned into or decoded using one or more slices (typically non-overlapping), and each slice may comprise one or more blocks (e.g. CTUs).

Embodiments of the video decoder 30 as shown in FIG. 5 may be configured to partition and/or decode the picture by using tile groups (also referred to as video tile groups) and/or tiles (also referred to as video tiles), wherein a picture may be partitioned into or decoded using one or more tile groups (typically non-overlapping), and each tile group may comprise, e.g. one or more blocks (e.g. CTUs) or one or more tiles, wherein each tile, e.g. may be of rectangular shape and may comprise one or more blocks (e.g. CTUs), e.g. complete or fractional blocks.

Other variations of the video decoder 30 can be used to decode the encoded picture data 21. For example, the decoder 30 can produce the output video stream without the loop filtering unit 520. For example, a non-transform based decoder 30 can inverse-quantize the residual signal directly without the inverse-transform processing unit 512 for certain blocks or frames. In another implementation, the video decoder 30 can have the inverse-quantization unit 510 and the inverse-transform processing unit 512 combined into a single unit.

It should be understood that, in the encoder 20 and the decoder 30, a processing result of a current step may be further processed and then output to the next step. For example, after interpolation filtering, motion vector derivation or loop filtering, a further operation, such as Clip or shift, may be performed on the processing result of the interpolation filtering, motion vector derivation or loop filtering.

In the following, more specific, non-limiting, and exemplary embodiments of the invention are described. Before that, some explanations and definitions are provided aiding in the understanding of the disclosure:

### Picture Size

Picture size refers to the width w or height h, or the width-height pair of a picture. Width and height of an image is usually measured in the number of luma samples.

### Downsampling

Downsampling is a process, where the sampling rate (sampling interval) of the discrete input signal is reduced. For example, if the input signal is an image, which has a size of h and w, and the output of the downsampling has a size of h2 and w2, at least one of the following holds true:
h2<h
w2<w

In one example implementation, downsampling may be implemented by keeping only each m-th sample, while discarding the rest of the imput signal (e.g. image).

### Upsampling:

Upsampling is a process, where the sampling rate (sampling interval) of the discrete input signal is increased. For example, if the input image has a size of h and w, and the output of the downsampling has a size h2 and w2, at least one of the following holds true:
h2>h
w2>w

### Resampling:

Downsampling and upsampling processes are both examples of resampling. Resampling is a process where the sampling rate (sampling interval) of the input signal is changed. Resampling is an approach for resizing (or rescaling) of an input signal.

During the upsampling or downsampling processes, filtering may be applied to improve the accuracy of the resampled signal and to reduce the aliasing effect. Interpolation filtering usually includes a weighted combination of sample values at sample positions around the resampling position. It can be implemented as:

ƒ(xᵣ,yᵣ)=Σ_{(x,y)ϵΩ}_{ᵣ}s(x,y)C(k),

with f( ) referring to the resampled signal, (xᵣ, yᵣ) are the resampling coordinates (coordinates of the resampled samples), C(k) are the interpolation filter coefficients, and s(x,y) is the input signal. The coordinates x, y are coordinates of the samples of the input image. The summation operation is performed for (x,y) that are in the vicinity Ωᵣ of (xᵣ, yᵣ). In other words, a new sample ƒ(xᵣ, yᵣ) is obtained as a weighted sum of input picture samples s(x, y). The weighting is performed by the coefficients C(k), wherein k denotes the position (index) of the filter coefficient within the filter mask. For example, in case of a 1D filter, k would take values from one to the order of the filter. In case of 2D filter which may be applied to a 2D image, k may be an index denoting one among all possible (non-zero) filter coefficients. The index is associated, by convention, with a particular position of the coefficient within the filter mask (filter kernel).

### Cropping:

Trimming (cutting) off the outside edges of a digital image. Cropping can be used to make an image smaller (in terms of the number of samples) and/or to change the aspect ratio (length to width) of the image. It can be understood as removing samples from a signal, usually the samples at borders of the signal.

### Padding:

Padding refers to increasing the size of the input (i.e. an input image) by generating new samples (e.g. at the borders of the image) by either using sample values that are predefined or by using (e.g. copying or combining) sample values at the existing positions in the input image. The generated samples are approximations of non-existing actual sample values.

### Resizing:

Resizing is a general term where the size of the input image is changed. Resizing may be performed using one of the methods of padding or cropping. Alternatively, resizing may be performed by resampling.

### Integer Division:

Integer division is division in which the fractional part (remainder) is discarded.

### Convolution:

Convolution may be defined for the input signal f( ) and a filter g ( ) in one dimension as:

$$( f * g ) [ n ] = {\sum }_{m = - ∞}^{∞} f [ m ] g [ n - m ]$$

Here, m is an index within the input signal and the filter. And n indicates the position (shift) of the filter with regard to the input signal. Both n and m are integers. S convolution in 2D may work similarly, as is well-known from the art. For the sake of generality, the m can be considered to have values between minus infinity to plus infinity as in the equation above. In practice, however, the filter f[ ] might have a finite length, in which case the filter coefficients f[m] would be equal to zero for m that exceed the filter size.

### Artificial Neural Networks

Artificial neural networks (ANN) or connectionist systems are computing systems vaguely inspired by the biological neural networks that constitute animal brains. Such systems “learn” to perform tasks by considering examples, generally without being programmed with task-specific rules. For example, in image recognition, they might learn to identify images that contain cats by analyzing example images that have been manually labeled as “cat” or “no cat” and using the results to identify cats in other images. They do this without any prior knowledge of cats, for example, that they have fur, tails, whiskers and cat-like faces. Instead, they automatically generate identifying characteristics from the examples that they process.

An ANN is based on a collection of connected units or nodes called artificial neurons, which loosely model the neurons in a biological brain. Each connection, like the synapses in a biological brain, can transmit a signal to other neurons. An artificial neuron that receives a signal then processes it and can signal neurons connected to it. In ANN implementations, the “signal” at a connection is a real number, and the output of each neuron can be computed by some non-linear function of the sum of its inputs. The connections are called edges. Neurons and edges typically have a weight that adjusts as learning proceeds. The weight increases or decreases the strength of the signal at a connection. Neurons may have a threshold such that a signal is sent only if the aggregate signal crosses that threshold. Typically, neurons are aggregated into layers. Different layers may perform different transformations on their inputs. Signals travel from the first layer (the input layer), to the last layer (the output layer), possibly after traversing the layers multiple times.

The original goal of the ANN approach was to solve problems in the same way that a human brain would. Over time, attention moved to performing specific tasks, leading to deviations from biology. ANNs have been used on a variety of tasks, including computer vision, speech recognition, machine translation, social network filtering, playing board and video games, medical diagnosis, and even in activities that have traditionally been considered as reserved to humans, like painting.

### Downsampling Layer:

A layer of a neural network that results in a reduction of at least one of the dimensions of the input. In general, the input might have 3 or more dimensions, where the dimensions may include the number of channels, width, and height. The downsampling layer usually refers to a reduction of the width and/or height dimensions. It can be implemented using convolution (possibly with a stride), averaging, max-pooling etc. operations.

### Upsampling Layer:

A layer of a neural network than results in an increase of at least one of the dimensions of the input. In general, the input might have 3 or more dimensions, where the dimensions may include the number of channels, width, and height. The upsampling layer usually refers to an increase in the width and/or height dimensions. It can be implemented with de-convolution, replication etc. operations.

### Feature Map:

Feature maps are generated by applying filters (kernels) or feature detectors to the input image or the feature map output of the prior layers. Feature map visualization provides insight into the internal representations for a specific input for each of the convolutional layers in the model. In general terms, feature map is an output of a neural network layer. Feature map typically includes one or more feature elements.

### Convolutional Neural Network

The name “convolutional neural network” (CNN) indicates that the network employs a mathematical operation called convolution. Convolution is a specialized kind of linear operation. Convolutional networks are simply neural networks that use convolution in place of general matrix multiplication in at least one of their layers. A convolutional neural network consists of an input and an output layer, as well as multiple hidden layers. Input layer is the layer to which the input is provided for processing.

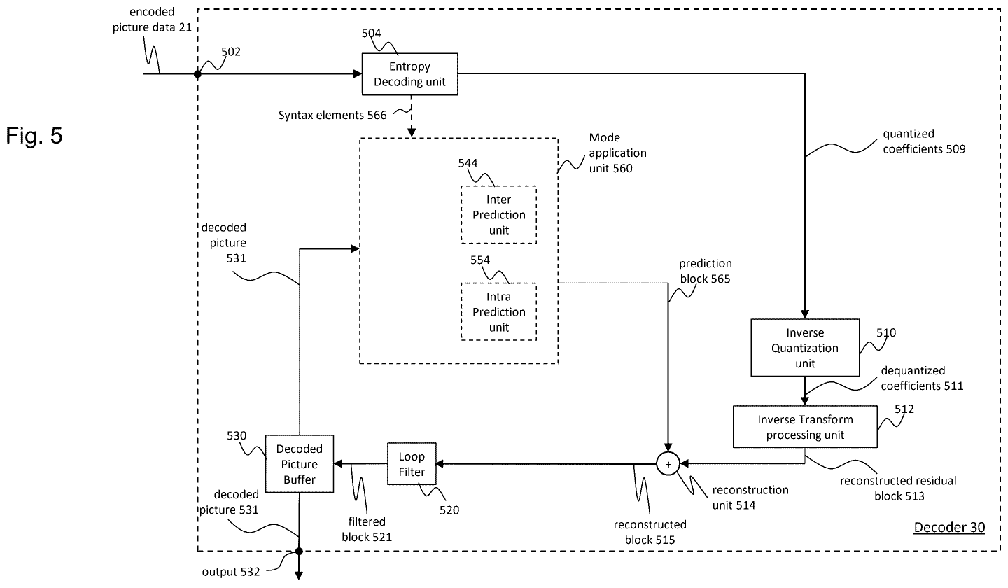

For example, the neural network of FIG. 6A is a CNN. The hidden layers of a CNN typically consist of a series of convolutional layers (e.g. conv layers 601 to 612 in FIG. 6A) that convolve with a multiplication or other dot product. The result of a layer is one or more feature maps, sometimes also referred to as channels. There may be a subsampling involved in some or all of the layers. As a consequence, the feature maps may become smaller. The activation function in a CNN may be a RELU (Rectified Linear Unit) layer or a GDN layer as already exemplified above, and may subsequently be followed by additional convolutions such as pooling layers, fully connected layers and normalization layers, referred to as hidden layers because their inputs and outputs are masked by the activation function and final convolution. Though the layers are colloquially referred to as convolutions, this is only by convention. Mathematically, it is technically a sliding dot product or cross-correlation. This has significance for the indices in the matrix, in that it affects how a weight is determined at a specific index point.

When programming a CNN for processing pictures or images, the input is a tensor (e.g. an input tensor, such as tensor x 614 in FIG. 6A) with shape (number of images)×(image width)×(image height)×(image depth). Then, after passing through a convolutional layer, the image becomes abstracted to a feature map (feature tensor), with shape (number of images)×(feature map width)×(feature map height)×(feature map channels). In FIG. 6A, such feature map is y, for example. A convolutional layer within a neural network should have the following attributes. Convolutional kernels defined by a width and height (hyper-parameters). The number of input channels and output channels (hyper-parameter). The depth of the convolution filter (the input channels) should be equal to the number channels (depth) of the input feature map. For example conv N×5×5 in FIG. 6A refers to a kernel of size 5×5 and N channels, with N being an integer equal to or larger than one.

In the past, traditional multilayer perceptron (MLP) models have been used for image recognition. However, due to the full connectivity between nodes, they suffered from high dimensionality, and did not scale well with higher resolution images. A 1000×1000-pixel image with RGB color channels has 3 million weights, which is too high to feasibly process efficiently at scale with full connectivity. Also, such network architecture does not take into account the spatial structure of data, treating input pixels which are far apart in the same way as pixels that are close together. This ignores locality of reference in image data, both computationally and semantically. Thus, full connectivity of neurons is wasteful for purposes such as image recognition that are dominated by spatially local input patterns.

Convolutional neural networks are biologically inspired variants of multilayer perceptrons that are specifically designed to emulate the behavior of a visual cortex. CNN models mitigate the challenges posed by the MLP architecture by exploiting the strong spatially local correlation present in natural images. The convolutional layer is the core building block of a CNN. The layer's parameters consist of a set of learnable filters (the above-mentioned kernels), which have a small receptive field, but extend through the full depth of the input volume. During the forward pass, each filter is convolved across the width and height of the input volume, computing the dot product between the entries of the filter and the input and producing a 2-dimensional activation map of that filter. As a result, the network learns filters that activate when it detects some specific type of feature at some spatial position in the input.

Stacking the activation maps for all filters along the depth dimension forms the full output volume of the convolution layer. Every entry in the output volume can thus also be interpreted as an output of a neuron that looks at a small region in the input and shares parameters with neurons in the same activation map. A feature map, or activation map, is the output activations for a given filter. Feature map and activation has same meaning. In some papers it is called an activation map because it is a mapping that corresponds to the activation of different parts of the image, and also a feature map because it is also a mapping of where a certain kind of feature is found in the image. A high activation means that a certain feature was found.

Another important concept of CNNs is pooling, which is a form of non-linear down-sampling. There are several non-linear functions to implement pooling among which max pooling is the most common. It partitions the input image into a set of non-overlapping rectangles and, for each such sub-region, outputs the maximum. Intuitively, the exact location of a feature is less important than its rough location relative to other features. This is the idea behind the use of pooling in convolutional neural networks. The pooling layer serves to progressively reduce the spatial size of the representation, to reduce the number of parameters, memory footprint and amount of computation in the network, and hence to also control overfitting. It is common to periodically insert a pooling layer between successive convolutional layers in a CNN architecture. The pooling operation provides another form of translation invariance.

The pooling layer operates independently on every depth slice of the input and resizes it spatially. The most common form is a pooling layer with filters of size 2×2 applied with a stride of 2 down-samples at every depth slice in the input by 2 along both width and height, discarding 75% of the activations. In this case, every max operation is over 4 numbers. The depth dimension remains unchanged.

In addition to max pooling, pooling units can use other functions, such as average pooling or 82-norm pooling. Average pooling was often used historically but has recently fallen out of favour compared to max pooling, which performs better in practice. Due to the aggressive reduction in the size of the representation, there is a recent trend towards using smaller filters or discarding pooling layers altogether. “Region of Interest” pooling (also known as ROI pooling) is a variant of max pooling, in which output size is fixed and input rectangle is a parameter. Pooling is an important component of convolutional neural networks for object detection based on Fast R-CNN architecture.

The above-mentioned ReLU is the abbreviation of rectified linear unit, which applies the non-saturating activation function. It effectively removes negative values from an activation map by setting them to zero. It increases the nonlinear properties of the decision function and of the overall network without affecting the receptive fields of the convolution layer. Other functions are also used to increase nonlinearity, for example the saturating hyperbolic tangent and the sigmoid function. ReLU is often preferred to other functions because it trains the neural network several times faster without a significant penalty to generalization accuracy.

After several convolutional and max pooling layers, the high-level reasoning in the neural network is done via fully connected layers. Neurons in a fully connected layer have connections to all activations in the previous layer, as seen in regular (non-convolutional) artificial neural networks. Their activations can thus be computed as an affine transformation, with matrix multiplication followed by a bias offset (vector addition of a learned or fixed bias term).

The “loss layer” specifies how training penalizes the deviation between the predicted (output) and true labels and is normally the final layer of a neural network. Various loss functions appropriate for different tasks may be used. Softmax loss is used for predicting a single class of K mutually exclusive classes. Sigmoid cross-entropy loss is used for predicting K independent probability values in [0, 1]. Euclidean loss is used for regressing to real-valued labels.

### Subnetwork

A neural network might comprise multiple subnetworks. A subnetwork consist of 1 or more layers. Different subnetworks have a different input/output size, resulting in different memory requirements and/or computational complexity.

### Pipeline

A series of subnetworks which process a particular component of an image. For example, an image component may be any of a R, G, or B component. A component may be also one of a luma Y or a chorma component U or V. An example could be a system with 2 pipelines, where the first pipeline only processes the luma component and the second pipeline processes the chroma component(s). One pipeline processes only one component, while a second component (e.g. luma component) may be used as auxiliary information to aid the processing (e.g. chroma component(s)). For example the pipeline which has the chroma component as output can have the latent representation of both luma and chroma components as input (conditional coding of chroma component).

### Rate-Distortion Optimized Quantization (RDOQ)

RDOQ is an encoder-only technology, meaning that it applies to processing performed by the encoder, but not the decoder. Before writing to the bit-stream, parameters are quantized (de-scaled, rounding, etc.) to a prescribed standard fixed precision. Among multiple ways of rounding, minimal RD-cost variant may be often selected, as used in HEVC or VVC for transform coefficients coding, for example.

### Conditional Color Separation (CCS)

In NN architectures for image/video coding/processing, CCS refers to independent coding/processing of the primary color component (e.g. luma component), while the secondary color components (e.g. chroma UV) are conditionally coded/processed, using primary component as auxiliary input.

### Autoencoders and Unsupervised Learning

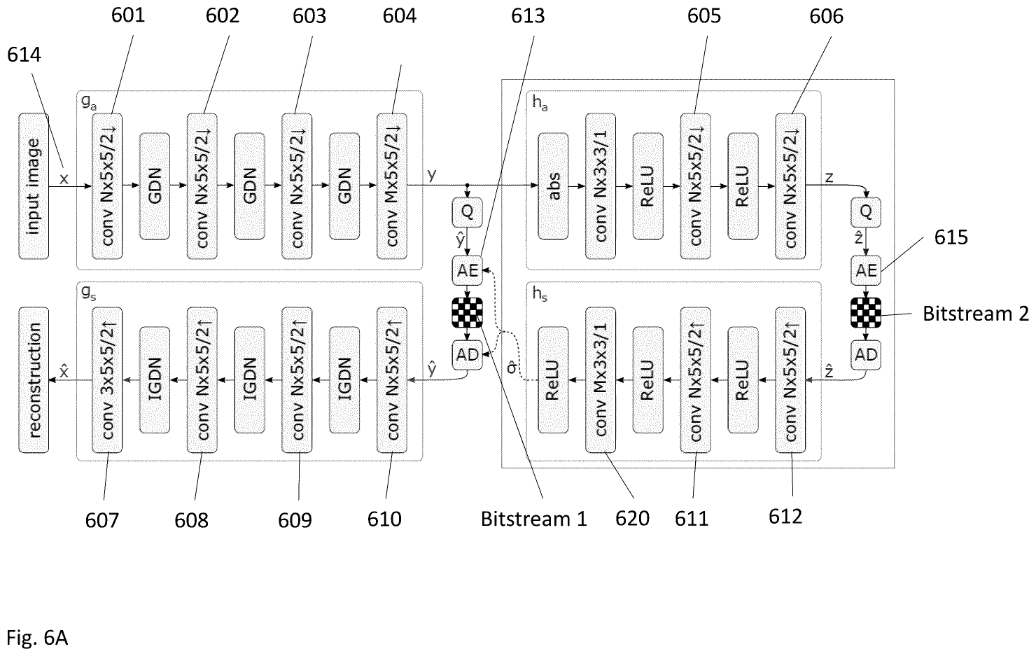

An autoencoder is a type of artificial neural network used to learn efficient data codings in an unsupervised manner. A schematic drawing thereof is shown in FIG. 7 which may be considered as a simplified representation of the CNN-based VAE (variational autoencoder) structure of FIG. 6A or FIG. 6B. The aim of an autoencoder is to learn a representation (encoding) for a set of data, typically for dimensionality reduction, by training the network to ignore signal “noise”. Along with the reduction side, a reconstructing side is learned, where the autoencoder tries to generate from the reduced encoding a representation as close as possible to its original input, hence its name.

In the simplest case, given one hidden layer, the encoder stage of an autoencoder takes the input x and maps it to h

h=σ(Wx+b).

This image h is usually referred to as code, latent variables, or latent representation. Here, σ is an element-wise activation function, such as a sigmoid function or a rectified linear unit. W is a weight matrix b is a bias vector. Weights and biases are usually initialized randomly, and then updated iteratively during training through Backpropagation. After that, the decoder stage of the autoencoder maps h to the reconstruction x′ of the same shape as x:

x′=σ′(W′h′+b′)

where σ′, W′ and b′ for the decoder may be unrelated to the corresponding σ, W and b for the encoder.

Variational autoencoder models make strong assumptions concerning the distribution of latent variables. They use a variational approach for latent representation learning, which results in an additional loss component and a specific estimator for the training algorithm called the Stochastic Gradient Variational Bayes (SGVB) estimator. It assumes that the data are generated by a directed graphical model p_{θ}(x|h) and that the encoder is learning an approximation q_{ϕ}(h|x) to the posterior distribution p_{θ}(h|x) where ϕ and θ denote the parameters of the encoder (recognition model) and decoder (generative model) respectively. The probability distribution of the latent vector of a VAE typically matches that of the training data much closer than a standard autoencoder. The objective of VAE has the following form:

$$ℒ ( ϕ , θ , x ) = {D}_{K L} ( {q}_{ϕ} ( h \vert x ) \vert \vert {p}_{θ} ( h ) ) - {E}_{{q}_{ϕ} ( h \vert x )} ( log {p}_{θ} ( x \vert h ) )$$

Here, D_{KL} stands for the Kullback-Leibler divergence. The prior over the latent variables is usually set to be the centered isotropic multivariate Gaussian p_{θ}(h)=N(0, l). Commonly, the shape of the variational and the likelihood distributions are chosen such that they are factorized Gaussians:

$${q}_{ϕ} ( h \vert x ) = ( ρ ( x ) , {ω}^{2} ( x ) I )$$

$${p}_{ϕ} ( x \vert h ) = ( μ ( h ) , {σ}^{2} ( h ) I )$$

where ρ(x) and ωw²(x) are the encoder output, while μ(h) and σ²(h) are the decoder outputs.

Recent progress in artificial neural networks area and especially in convolutional neural networks enables researchers' interest of applying neural networks based technologies to the task of image and video compression. For example, End-to-End Optimized Image Compression has been proposed, which uses a network based on variational autoencoder (VAE). Accordingly, data compression is considered as a fundamental and well-studied problem in engineering, and is commonly formulated with the goal of designing codes for a given discrete data ensemble with minimal entropy. The solution relies heavily on knowledge of the probabilistic structure of the data, and thus the problem is closely related to probabilistic source modeling. However, since all practical codes must have finite entropy, continuous-valued data (such as vectors of image pixel intensities) must be quantized to a finite set of discrete values, which introduces error. In this context, known as the lossy compression problem, one must trade off two competing costs: the entropy of the discretized representation (rate) and the error arising from the quantization (distortion). Different compression applications, such as data storage or transmission over limited-capacity channels, demand different rate-distortion trade-offs. Joint optimization of rate and distortion is difficult. Without further constraints, the general problem of optimal quantization in high-dimensional spaces is intractable.

For this reason, most existing image compression methods operate by linearly transforming the data vector into a suitable continuous-valued representation, quantizing its elements independently, and then encoding the resulting discrete representation using a lossless entropy code. This scheme is called transform coding due to the central role of the transformation. For example, JPEG uses a discrete cosine transform on blocks of pixels, and JPEG 2000 uses a multi-scale orthogonal wavelet decomposition. Typically, the three components of transform coding methods-transform, quantizer, and entropy code—are separately optimized (often through manual parameter adjustment). Modern video compression standards like HEVC, VVC and EVC also use transformed representation to code residual signal after prediction. The several transforms are used for that purpose such as discrete cosine and sine transforms (DCT, DST), as well as low frequency non-separable manually optimized transforms (LFNST).

### Latent Space:

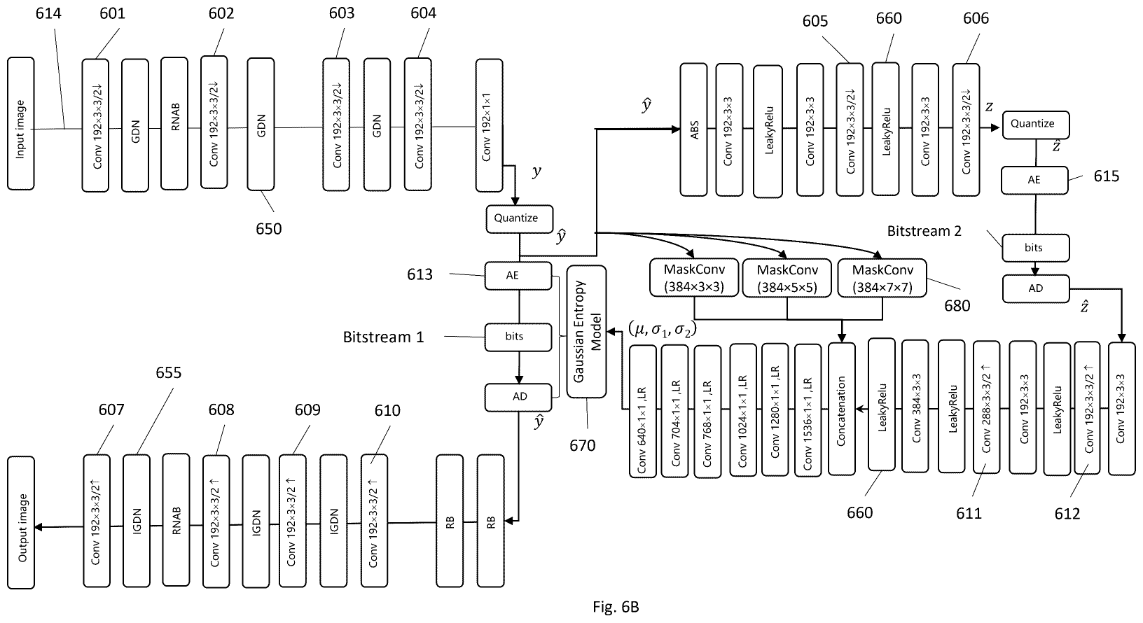

The latent space refers to the feature map generated in the bottleneck layer of the NN. This is illustrated in the example shown in FIG. 7 and FIG. 8. In the case of the NN topologies, where the purpose of the network is the reduction of dimensionality of the input signal (like in an autoencoder topology), the bottleneck layer usually refers to the layer at which the dimensionality of the input signal is reduced to a minimum. The purpose of the reduction of dimensionality is usually to achieve a more compact representation of the input. Therefore, the bottleneck layer is a layer that is suitable for compression, and therefore in the case of video coding applications, the bitstream is generated based on the bottleneck layer.

The autoencoder topology usually consists of an encoder and a decoder that are connected to the each other at the bottleneck layer. The purpose of the encoder is to reduce the dimensionality of the input and make it more compact (or more intuitive). The purpose of the decoder is to revert the operation of the encoder and hence, reconstruct the input as best as possible based on the bottleneck layer.

### Variational Auto-Encoder (VAE) Framework

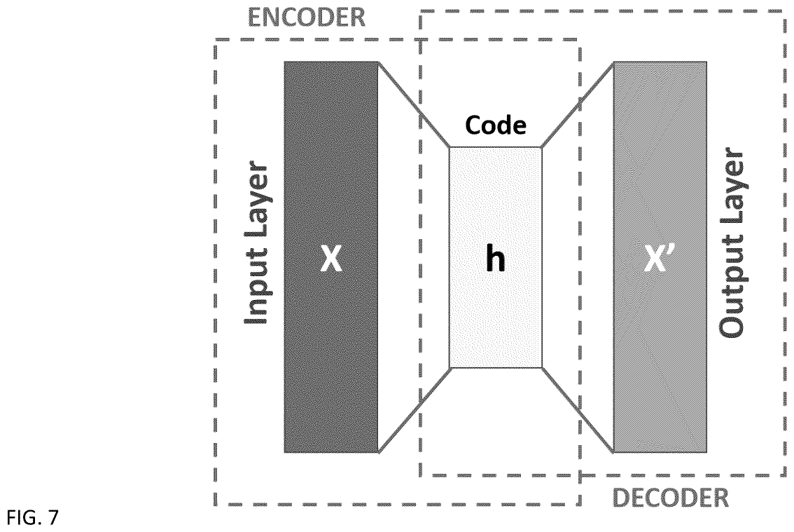

The VAE framework can be considered as a nonlinear transforming coding model. The transforming process can be mainly divided into four parts. This is exemplified in FIG. 9 showing a VAE framework.

The transforming process may be divided into four parts: FIG. 9 exemplifies the VAE framework, including both the encoder and decoder branch. In FIG. 9, the encoder 901 maps an input image x into a latent representation (denoted by y) via the function y=ƒ(x). This latent representation may also be referred to as a part of or a point within a “latent space” in the following. The function f( ) is a transformation function that converts the input signal x into a more compressible representation y. The quantizer 902 transforms the latent representation y into the quantized latent representation ŷ with (discrete) values by ŷ=Q(y), with Q representing the quantizer function. The quantizer function may be RDOQ. The entropy model, or the hyper encoder/decoder (also known as hyperprior) 903 estimates the distribution of the quantized latent representation ŷ to get the minimum rate achievable with a lossless entropy source coding.

The latent space can be understood as a representation of compressed data (e.g. picture data) in which similar data points are closer together in the latent space. The latent space is useful for learning data features and for finding simpler representations of data for analysis.

The quantized latent representation T, ŷ and the side information \hat{z} of the hyperprior 903 are included into a bitstream 2 (are binarized) using arithmetic coding (AE), as shown in FIG. 9.

Furthermore, a decoder 904 is provided that transforms the quantized latent representation to the reconstructed image \hat{x},\hat{x}=g(ŷ). The signal x is the estimation of the input image x. It is desirable that x is as close to \hat{x} as possible, in other words the reconstruction quality is as high as possible. However, the higher the similarity between \hat{x} and x, the higher the amount of side information necessary to be transmitted. Such side information may include bitstream1 and bitstream2 shown in FIG. 9, which are generated by the encoder and transmitted to the decoder. Normally, the higher the amount of side information, the higher the reconstruction quality. However, a high amount of side information means that the compression ratio is low. Therefore, one purpose of the system described in FIG. 9 is to balance the reconstruction quality and the amount of side information conveyed in the bitstream.

In FIG. 9, the component AE 605 is the Arithmetic Encoding module, which converts samples of the quantized latent representation ŷ and the side information \hat{z} into a binary representation bitstream 1. The samples of ŷ and \hat{z} might for example comprise integer or floating point numbers. One purpose of the arithmetic encoding module is to convert (via the process of binarization) the sample values into a string of binary digits (which is then included in the bitstream that may comprise further portions corresponding to the encoded image or further side information).

The arithmetic decoding (AD) 906 is the process of reverting the binarization process, where binary digits are converted back to sample values. The arithmetic decoding is provided by the arithmetic decoding module 906.

It is noted that the present disclosure is not limited to this particular framework. Moreover the present disclosure is not restricted to image or video compression, and can be applied to object detection, image generation, and recognition systems as well.

In FIG. 9 there are two subnetworks concatenated to each other. A network in this context is a logical division between the parts of the total network. For example, in FIG. 9 the processing units (modules) 901, 902, 904, 905 and 906 are called auto-encoder/decoder or simply the “Encoder/Decoder” network. In other words, the network may be defined in terms of the processing units (modules) connected so as to enable a function. As to the connected modules 901, 902, 904, 905 and 906 in FIG. 9, the respective network performs a function of encoding and decoding processing of an input picture x (e.g. input tensor). Hence, the “Encoder/Decoder” network (first network) in the example of FIG. 9 is responsible for encoding (generating) and decoding (parsing) of the first bitstream “bitstream1”. In turn, the connected processing units (modules) 903, 908, 909, 910, and 907 form another network (second network), which may be called “hyper encoder/decoder” network. The second network is responsible for encoding (generating) and decoding (parsing) of the the second bitstream “bitstream2”. In the example of FIG. 9, the first bitstream includes encoded picture data y, while the second bitstream includes side information 2. Hence, the purposes of the two networks are different. Any of the processing units (modules) of the first and second network may itself be a network, referred to as subnetwork and means that a specific module is part of a (larger) network. For example, any of the modules 901, 902, 904, 905 and 906 in FIG. 9 is a subnetwork of the first network. Likewise, any of the modules 903, 908, 909, 910, and 907 is a subnetwork of the second network. Within the respective network, each of the processing units (modules) perform a specific function as needed to realize the processing of the entire first and second network, respectively. In the example of FIG. 9, said function is encoding-decoding processing of picture data (first network) and encoding-decoding processing of side information (second subnetwork). In addition, the connected modules 901, 902, and 905 may be considered as encoder subnetwork (i.e. subnetwork of encoder-decoder network), while modules 904 and 906 may be considered as decoder subnetwork. As is clear from the above discussion, the first and second network may in turn be each interpreted as subnetwork with respect to the total network comprising all the processing units.

The first subnetwork is responsible for:
the transformation 901 of the input image x into its latent representation y (which is easier to compress than x),
quantizing 902 the latent representation y into a quantized latent representation ŷ,
compressing the quantized latent representation ŷ using the AE by the arithmetic encoding module 905 to obtain bitstream “bitstream 1”,
parsing the bitstream 1 via AD using the arithmetic decoding module 906, and
reconstructing 904 the reconstructed image (\hat{x}) using the parsed data.

The purpose of the second subnetwork is to obtain statistical properties (e.g. mean value, variance and correlations between samples of bitstream 1) of the samples of “bitstream1”, such that the compressing of bitstream 1 by first subnetwork is more efficient. The second subnetwork generates a second bitstream “bitstream2”, which comprises said information (e.g. mean value, variance and correlations between samples of bitstream1).

The second network includes an encoding part which comprises transforming 903 of the quantized latent representation ŷ into side information z, quantizing the side information z into quantized side information \hat{z}, and encoding (e.g. binarizing) 909 the quantized side information \hat{z} into bitstream2. In this example, the binarization is performed by an arithmetic encoding (AE). A decoding part of the second network includes arithmetic decoding (AD) 910, which transforms the input bitstream2 into decoded quantized side information \hat{z}′. The \hat{z}′ might be identical to \hat{z}, since the arithmetic encoding and decoding operations are lossless compression methods. The decoded quantized side information \hat{z}′ is then transformed 907 into decoded side information ŷ′. ŷ′ represents the statistical properties of ŷ (e.g. mean value of samples of ŷ, or the variance of sample values or like). The decoded latent representation ŷ′ is then provided to the above-mentioned Arithmetic Encoder 905 and Arithmetic Decoder 906 to control the probability model of ŷ.

FIG. 9 describes an example of VAE (variational auto encoder), details of which might be different in different implementations. For example, in a specific implementation, additional components might be present to more efficiently obtain the statistical properties of the samples of bitstream 1. In one such implementation, a context modeler might be present, which targets extracting cross-correlation information of the bitstream 1. The statistical information provided by the second subnetwork might be used by AE (arithmetic encoder) 905 and AD (arithmetic decoder) 906 components.

FIG. 9 depicts the encoder and decoder in a single figure. As is clear to those skilled in the art, the encoder and the decoder may be, and very often are, embedded in mutually different devices, as exemplified in FIG. 9A and FIG. 9B.

FIG. 9A depicts the encoder and FIG. 9B depicts the decoder components of the VAE framework in isolation. As input, the encoder receives, according to some embodiments, a picture (picture data). The input picture may include one or more channels, such as color channels or other kind of channels, e.g. depth channel or motion information channel, or the like. The output of the encoder (as shown in FIG. 9A) is a bitstream1 and a bitstream2. The bitstream1 is the output of the first subnetwork of the encoder and the bitstream2 is the output of the second subnetwork of the encoder.

Similarly, in FIG. 9B, the two bitstreams, bitstream1 and bitstream2, are received as input and \hat{x}, which is the reconstructed (decoded) image, is generated at the output.

As indicated above, the VAE can be split into different logical units that perform different actions, as exemplified in FIGS. 9A and 9B so that FIG. 9A depicts components that participate in the encoding of a signal, like a video and provided encoded information. This encoded information is then received by the decoder components depicted in FIG. 9B for encoding, for example. As such, same reference numerals in FIGS. 9, 9A, and 9B indicate that the respective processing units (module) perform the same function.

Specifically, as is seen in FIG. 9A, the encoder comprises the encoder 901 that transforms an input x into a signal y which is then provided to the quantizer 902. The quantizer 902 provides information to the arithmetic encoding module 905 and the hyper encoder 903. The hyper encoder 903 provides the bitstream2 already discussed above to the hyper decoder 907 that in turn signals information to the arithmetic encoding module 605.

The output of the arithmetic encoding module is the bitstream1. The bitstream1 and bitstream2 are the output of the encoding of the signal, which are then provided (transmitted) to the decoding process.

Although the unit 901 is called “encoder”, it is also possible to call the complete subnetwork described in FIG. 9A as “encoder”. The process of encoding in general means the unit (module) that converts an input to an encoded (e.g. compressed) output. It can be seen from FIG. 9A, that the unit 901 can be actually considered as a core of the whole subnetwork, since it performs the conversion of the input x into y, which is the compressed version of the x. The compression in the encoder 901 may be achieved, e.g. by applying a neural network, or in general any processing network with one or more layers. In such a network, the compression may be performed by cascaded processing (i.e. sequential processing) including downsampling which reduces size and/or number of channels of the input. Thus, the encoder may be referred to, e.g. as a neural network (NN) based encoder, or the like.

The remaining parts in the figure (quantization unit, hyper encoder, hyper decoder, arithmetic encoder/decoder) are all parts that either improve the efficiency of the encoding process or are responsible for converting the compressed output y into a series of bits (bitstream). Quantization may be provided to further compress the output of the NN encoder 901 by a lossy compression. The AE 905 in combination with the hyper encoder 903 and hyper decoder 907 used to configure the AE 905 may perform the binarization which may further compress the quantized signal by a lossless compression. Therefore, it is also possible to call the whole subnetwork in FIG. 9A an “encoder”. Similar applies to FIG. 9B, where the whole subnetwork may be called a “decoder”.

A majority of Deep Learning (DL) based image/video compression systems reduce dimensionality of the signal before converting the signal into binary digits (bits). In the VAE framework for example, the encoder, which is a non-linear transform, maps the input image x into y, where y has a smaller width and height than x. Since y has a smaller width and height and hence a smaller size, the (size of the) dimension of the signal is reduced, so that it is easier to compress the signal y. It is noted that in general, the encoder does not necessarily need to reduce the size in both (or in general all) dimensions. Rather, some exemplary implementations may provide an encoder which reduces size only in one (or in general a subset of) dimension.

The general principle of compression is exemplified in FIG. 8. The latent space, which is the output of the encoder and input of the decoder, represents the compressed data. It is noted that the size of the latent space may be much smaller than the input signal size. Here, the term size may refer to resolution, e.g. to a number of samples of the feature map(s) output by the encoder. The resolution may be given as a product of number of samples per each dimension (e.g. width x heighth x number of channels of an input image or of a feature map).

The reduction in the size of the input signal is exemplified in FIG. 8, which represents a deep-learning based encoder and decoder. In FIG. 8, the input image x corresponds to the input Data, which is the input of the encoder. The transformed signal y corresponds to the Latent Space, which has a smaller dimensionality or size in at least one dimension than the input signal. Each column of circles represent a layer in the processing chain of the encoder or decoder. The number of circles in each layer indicate the size or the dimensionality of the signal at that layer.

One can see from FIG. 8 that the encoding operation corresponds to a reduction in the size of the input signal, whereas the decoding operation corresponds to a reconstruction of the original size of the image.

One of the methods for reduction of the signal size is downsampling. As mentioned above, downsampling is a process where the sampling rate of the input signal is reduced. For example if the input image has a size of h and w, and the output of the downsampling is h2 and w2, at least one of the following holds true:
h2<h
w2<w

The reduction in the signal size usually happens step by step along the chain of processing layers, not all at once. For example, if the input image x has dimensions (or size of dimensions) of h and w (indicating the height and the width), and the latent space y has dimensions h/16 and w/16, the reduction of size might happen at 4 layers during the encoding, wherein each layer reduces the size of the signal by a factor of 2 in each dimension.

Some deep learning based video/image compression methods employ multiple downsampling layers. As an example, the VAE framework shown in FIG. 6A, utilizes 6 downsampling layers that are marked as 601 to 606. The layers that include downsampling are indicated with the downward arrow ⬇ in the layer description. The layer description “Conv N×5×5/2\” means that the layer is a convolution layer, with N channels and the convolution kernel is 5×5 in size. As stated, the 2⬇ means that a downsampling by a factor of 2 is performed in this layer. Downsampling by a factor of 2 results in one of the dimensions of the input signal being reduced by half at the output. In FIG. 6A, the 2⬇ indicates that both width and height of the input image is reduced by a factor of 2. Since there are 6 downsampling layers, if the width and height of the input image 814 (also denoted with x) is given by w and h, the output signal \hat{z} 813 is has width and height equal to w/64 and h/64 respectively.

The modules denoted by AE and AD are arithmetic encoder and arithmetic decoder, which have been explained above already with respect to FIGS. 9, 9A, and 9B. The arithmetic encoder and decoder are specific implementations of entropy coding. AE and AD (as part of the component 613 and 615 in FIG. 6A and FIG. 6B) can be replaced by other means of entropy coding. In information theory, an entropy encoding is a lossless data compression scheme that is used to convert the values of a symbol into a binary representation which is a revertible process. Also, the “Q” in the figure corresponds to the quantization operation that was also referred to above in relation to FIG. 6A and FIG. 6B and is further explained above in the section “Quantization”. Also, the quantization operation and a corresponding quantization unit as part of the component 613 or 615 is not necessarily present and/or can be replaced with another unit.

In FIG. 6A and FIG. 6B, there is also shown the decoder comprising upsampling layers 607 to 612. A further layer 620 is provided between the upsampling layers 611 and 610 in the processing order of an input that is implemented as convolutional layer but does not provide an upsampling to the input received. A corresponding convolutional layer 620 is also shown for the decoder. Such layers can be provided in NNs for performing operations on the input that do not alter the size of the input but change specific characteristics. However, it is not necessary that such a layer is provided.

When seen in the processing order of bitstream2 through the decoder, the upsampling layers are run through in reverse order, i.e. from upsampling layer 612 to upsampling layer 607. Each upsampling layer is shown here to provide an upsampling with an upsampling ratio of 2, which is indicated by the ⬇. It is, of course, not necessarily the case that all upsampling layers have the same upsampling ratio and also other upsampling ratios like 3, 4, 8 or the like may be used. The layers 607 to 612 are implemented as convolutional layers (conv). Specifically, as they may be intended to provide an operation on the input that is reverse to that of the encoder, the upsampling layers may apply a deconvolution operation to the input received so that its size is increased by a factor corresponding to the upsampling ratio. However, the present disclosure is not generally limited to deconvolution and the upsampling may be performed in any other manner such as by bilinear interpolation between two neighboring samples, or by nearest neighbor sample copying, or the like.

In the first subnetwork, some convolutional layers (601 to 603) are followed by generalized divisive normalization (GDN) at the encoder side and by the inverse GDN (IGDN) at the decoder side. In the second subnetwork, the activation function applied is ReLU. It is noted that the present disclosure is not limited to such implementation and in general, other activation functions may be used instead of GDN or ReLU.

FIG. 6B shows another example of a VAE-based encoder-decoder structure, similar to the one of FIG. 6A. In FIG. 6B, it is shown that the encoder and the decoder may comprise a number of downsampling and upsampling layers. Each layer applies a downsampling by a factor of 2 or an upsampling by a factor of 2. Furthermore, the encoder and the decoder can comprise further components, like a generalized divisive normalization (GDN) 650 at the encoder side and by the inverse GDN (IGDN) 655 at the decoder side. Furthermore, both the encoder and the decoder may comprise one or more ReLUs, specifically, leaky ReLUs 660 and 665. There can also be provided a factorized entropy model at the encoder and a Gaussian entropy model 670 at the decoder. Moreover, a plurality of convolution masks 680 may be provided. Moreover, the encoder includes, in the embodiments of FIG. 6B, a universal quantizer (UnivQuan) and the decoder comprises an attention module.

The total number of downsampling operations and strides defines conditions on the input channel size, i.e. the size of the input to the neural network.

Here, if input channel size is an integer multiple of 64=2×2×2×2×2×2, then the channel size remains integer after all proceeding downsampling operations. By applying corresponding upsampling operations in the decoder during the upsampling, and by applying the same rescaling at the end of the processing of the input through the upsampling layers, the output size is again identical to the input size at the encoder.

Thereby, a reliable reconstruction of the original input is obtained.

### Receptive Field:

Within the context of neural networks, the receptive field is defined as the size of the region in the input that produces a sample at the output feature map. Basically, it is a measure of association of an output feature (of any layer) with the input region (patch). It is noted that the concept of receptive fields applies to local operations (i.e. convolution, pooling, or the like). For example, a convolution operation with a kernel of size 3×3 has a receptive field of 3×3 samples in the input layer. In this example, 9 input samples are used to obtain 1 output sample by the convolution node.

### Total Receptive Field:

The total receptive field (TRF) refers to a set of input samples that are used to obtain a specified set of output samples by applying one or more processing layers, for example, of a neural network.

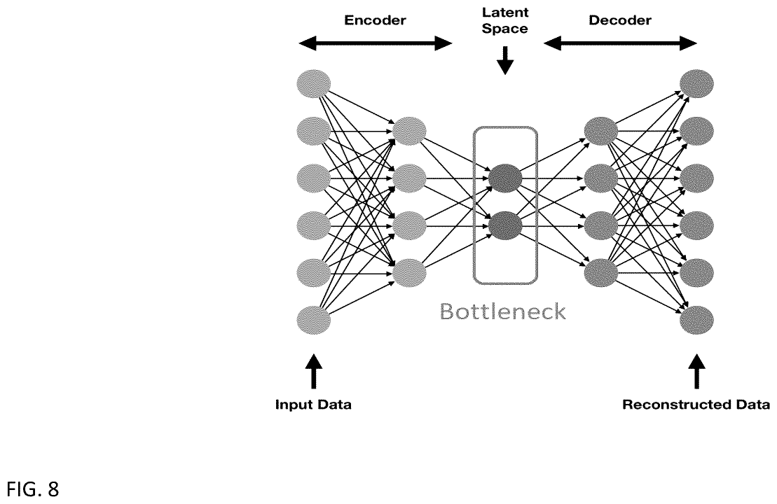

The total receptive field can be exemplified by FIG. 10. In FIG. 10, the processing of a one dimensional input (the 7 samples on the left of the figure) with 2 consecutive transposed convolution (also called as deconvolution) layers are exemplified. The input is processed from left to right, i.e. “deconv layer 1” processes the input first, whose output is processed by “deconv layer 2”. In the example, the kernels have a size of 3 in both deconvolution layers. This means that 3 input samples are necessary to obtain 1 output sample at each layer. In the example, the set of output samples are marked inside a dashed rectangle and include 3 samples. Due to the size of the deconvolution kernel, 7 samples are necessary at the input to obtain an output set of samples comprising 3 output samples. Therefore, the total receptive field of the marked 3 output samples is the 7 samples at the input.

In FIG. 10, there are 7 input samples, 5 intermediate output samples, and 3 output samples. The reduction in the number of samples is due to the fact that, since the input signal is finite (not extending to infinity in each direction), at the borders of the input there are “missing samples”. In other words, since a deconvolution operation requires 3 input samples corresponding to each output sample, only 5 intermediate output samples can be generated, if the number of input samples is 7. In fact, the amount of output samples that can be generated is (k−1) samples less than the number of input samples, where k is the kernel size. Since in FIG. 10 the number of input samples is 7, after the first deconvolution with kernel size 3, the number of intermediate samples is 5. After the second deconvolution with kernel size 3, the number of output samples is 3.

As it can be observed in FIG. 10, the total receptive field of the 3 output samples are 7 samples at the input. The size of the total receptive field increases by successive application of processing layers with kernel size greater than 1. In general, the total receptive field of a set of output samples are calculated by tracing the connections of each node starting from the output layer till the input layer, and then finding the union of all of the samples in the input that are directly or indirectly (via more than 1 processing layer) connected to the set of output samples. In FIG. 10 for example, each output sample is connected to 3 samples in a previous layer. The union set includes 5 samples in the intermediate output layer, which are connected to 7 samples in the input layer.

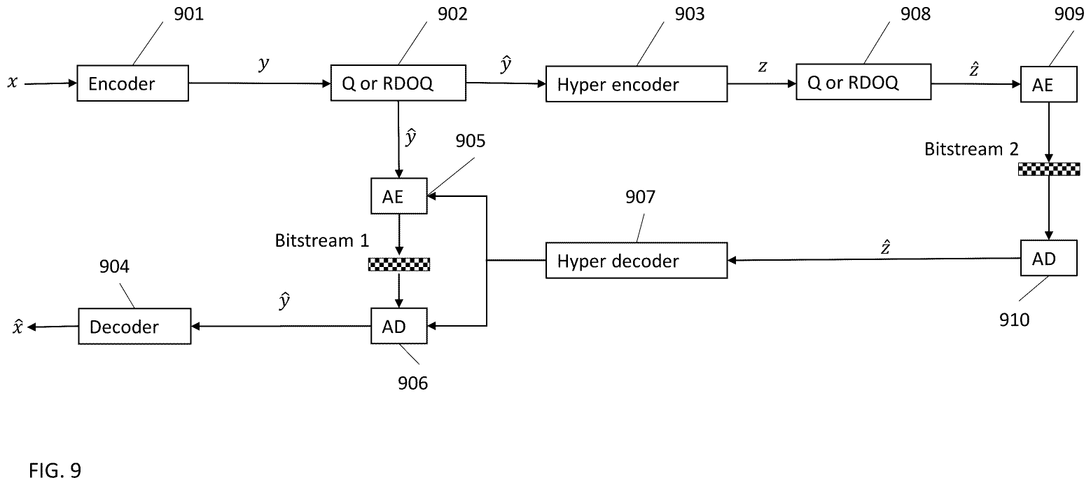

It is sometimes desirable to keep the number of samples the same after each operation (convolution or deconvolution or other). In such a case, one can apply padding at the boundaries of the input to compensate for “missing samples”. FIG. 11 illustrates this case, when the number of samples are kept equal. It is noted that the present disclosure is applicable to both cases, as padding is not a mandatory operation for convolution, deconvolution, or any other processing layer.

This is not to be confused with downsampling. In the process of downsampling, for every M samples there are N samples at the output and N<M. The difference is that M is usually much smaller than the number of inputs. In FIG. 10, there is no downsampling, rather the reduction in the number of samples results from the fact that the size of the input is not infinite and there are “missing samples” at the input. For example, if the number of input samples were 100, since the kernel size is k=3, the number of output samples would have been 100−(k−1)−(k−1)=96, when two convolution layers are used. In contrast, if both deconvolution layers were performing downsampling (with a ratio of M=2 and N=1), then the number of output samples would have been

$$ceil ( \frac{ceil ( \frac{( 100 - ( k - 1 ) )}{2} ) - ( k - 1 )}{2} ) = 22.$$

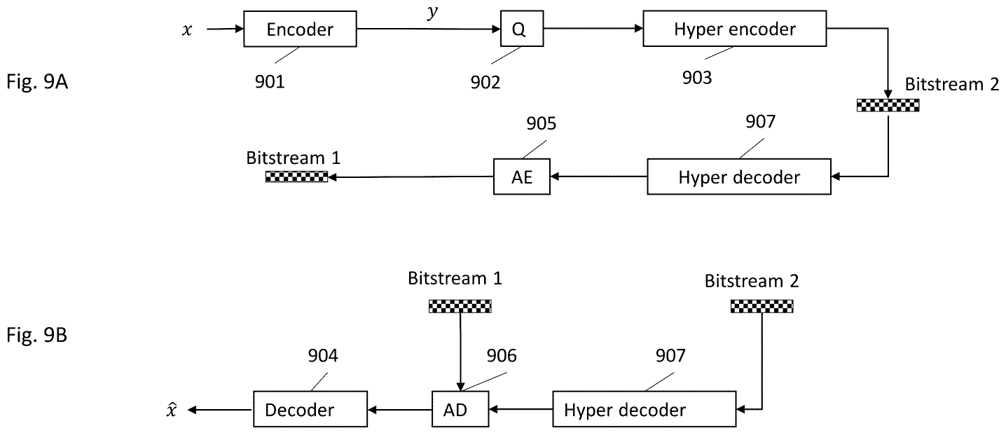

FIG. 12 exemplifies downsampling using 2 convolution layers with a downsampling ratio of 2 (N=1 and M=2). In this example, 7 input samples become 3 due to the combined effect of downsampling and “missing samples” at the boundary. The number of output samples can be calculated after each processing layer using the equation:

$$ceil ( \frac{( 100 - ( k - 1 ) )}{r} ) ,$$

where k is the kernel size and r is the downsampling ratio.

The operation of convolution and deconvolution (i.e. transposed convolution) are from the mathematical expression point of view identical. The difference stems from the fact that the deconvolution operation assumes that a previous convolution operation took place. In other words, deconvolution is the process of filtering a signal to compensate for a previously applied convolution. The goal of deconvolution is to recreate the signal as it existed before the convolution took place. The present disclosure applies to both convolution and deconvolution operations (and in fact any other operation where the kernel size is greater than 1 as explained later on).

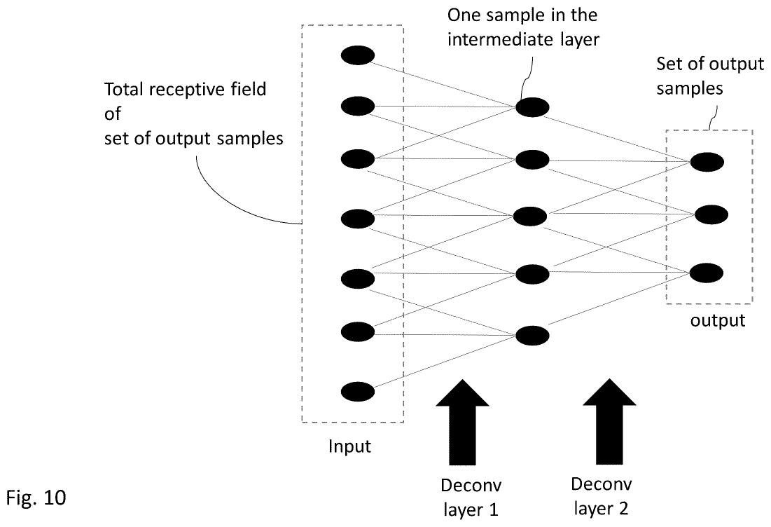

FIG. 13 shows another example to explain how to calculate the total receptive field. In FIG. 13, a two dimensional input sample array is processed by 2 convolution layers with kernel sizes of 3×3 each. After the application of the 2 deconvolution layers, the output array is obtained. The set (array) of output samples is marked with solid rectangle (“output samples”) and comprise 2×2=4 samples. The total receptive field of this set of output samples comprises 6×6=36 samples. The total receptive field can be calculated as:
each output sample is connected to 3×3 samples in the intermediate output. The union of all of the samples in the intermediate output that are connected to the set of output samples comprises 4×4=16 samples.
each of the 16 samples in the intermediate output are connected to 3×3 samples in the input. The union of all of the samples in the input that are connected to the 16 samples in the intermediate output comprises 6×6=36 samples. Accordingly, the total receptive field of the 2×2 output samples is 36 samples at the input.

In image and video compression systems, compressing and decompressing of an input image that has a very large size is usually performed by division of the input image into multiple parts. VVC and HEVC employ such division methods, for example, by partitioning the input image into tiles or wavefront processing units.

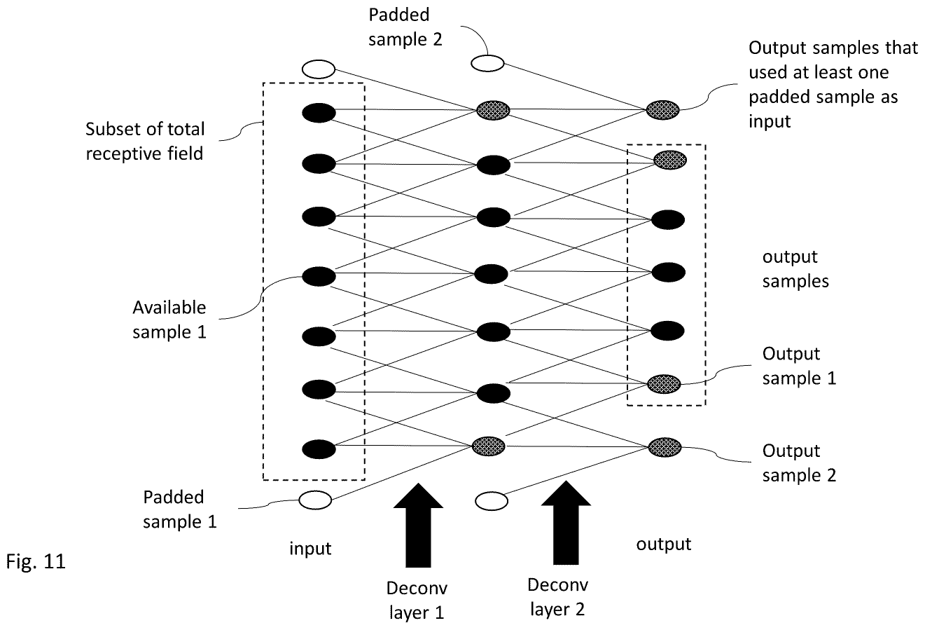

When tiles are used in traditional video coding systems, an input image is usually divided into multiple parts of rectangular shape. FIG. 14 exemplifies one such partitioning. In FIG. 14, part 1 and part 2 may be processed independently of each other, and the bitstreams for decoding of each part is encapsulated into independently decodable units. As a result, the decoder can parse (obtain the syntax elements necessary for sample reconstruction) each bitstream (corresponding to part 1 and part 2) independently and can reconstruct the samples of each part independently as well.

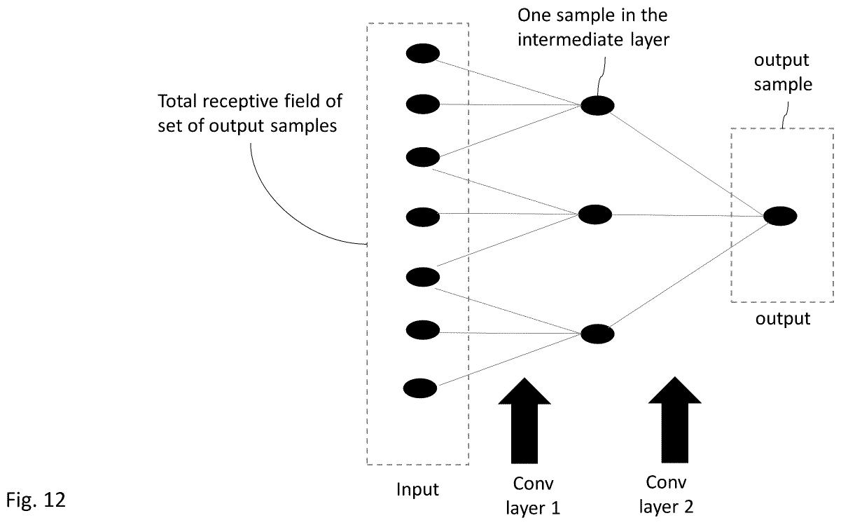

In wavefront parallel processing illustrated in FIG. 15, each part usually consists of 1 row of Coding tree blocks (CTB). The difference between wavefront parallel processing and tiles is that, in wavefront parallel processing, the bitstream corresponding to each part can be decoded almost independently of each other. However, the sample reconstruction cannot be performed independently, since the sample reconstruction of each part still has dependencies between the parts. In other words, wavefront parallel processing makes the parsing process independent, while keeping the sample reconstruction dependent.

Both wavefront and tiles are technologies to make it possible to perform a whole or a part of the decoding operation independently of each other. The benefit of independent processing is:
More than 1 identical processing cores can be used to process the whole image. Hence, the speed of processing can be increased.
If the capability of a processing core is not enough to process a big image, the image can be split into multiple parts, which require less resources for the processing. In this case, a less capable processing unit can process each part, even if it cannot process the whole image due to resource limitation.

In order to meet the demands in processing speed and/or memory, HEVC/VVC, uses a processing memory that is large enough to handle encoding/decoding of a whole frame. Top of the line GPU cards are used to achieve this. In the case of traditional codecs, such as HEVC/VVC, the memory requirement for processing the whole frame is usually not a big concern, as the whole frame is divided into blocks and each block is processed one by one. However, the processing speed is a major concern. Therefore, if a single processing unit is used to process a whole frame, the speed of the processing unit must be very high, and hence the processing unit is usually very expensive.

NN-based video compression algorithms on the other hand consider the whole frame in encoding/decoding, instead of block-based in conventional hybrid coder. The memory requirement is too high for processing via NN-based coding/decoding modules.

In traditional hybrid video encoders and decoders, the amount of necessary memory is proportional to the maximum allowed block size. For example, in VVC the maximum block size is 128×128 samples.

The necessary memory for NN-based video compression is, however, proportional to the size W×H, where W and H denote the width and height of the input/output image. It can be seen that the memory requirement can be extraordinarily high compared to hybrid video coders, since a typical video resolutions include 3840×2160 picture sizes (4K video). In image and video compression systems, the compressing and decompressing of an input image that has a very large size is usually performed by dividing the input image into multiple parts. In order to cope with memory restriction, NN based video coding algorithms may apply tiling in the latent space.

When tiling is applied without overlapping, boundary artifacts may be visible in the reconstructed image. This problem may be partly solved by overlapping tiles in latent space or signal domain, where the overlap is sufficiently large to avoid these artifacts. If the overlap is larger than the size of the receptive field of the NN, the operation can be performed in non-normative manner, and may cause some overhead in computational complexity. In turn, if the overlap is smaller than the size of the receptive field, the tiling operation is not lossless/transparent and needs to be specified (normative).

Moreover, in case of a structure with multiple pipelines (e.g. pipelines for processing luma and/or chroma, or generally multiple channels of an input tensor) or multiple subnetworks, the straightforward approach where the tiles have always the same size may result in a loss of performance. Rate distortion optimization quantization (RDOQ) (e.g. FIG. 9: unit 908) is another computationally complex and memory intensive operation. Selecting the same tile size in RDOQ as for all subnetworks may not be optimal either. Also, if the scene representation in different pipelines is not sample-aligned during tiling (e.g. CCS), a straight-forward tiling may not preserve information on the correlation along the different components. Sample-aligned means that the size of the luma does not match the size of the chroma. In such cases, the video processing may suffer from inferior performance, since spatial and/or temporal correlation is missing or is at least less pronounced. As a result, the quality of the reconstructed image may be reduced.

Another problem is, in order to process a large input with a single processing unit (e.g. a CPU or a GPU), the processing unit must be very fast since the unit needs to perform a high amount of operations per unit time. This requires that the unit needs to have a high clock frequency and a high memory bandwidth, which are expensive design criteria for chip manufacturers. In particular, it is not easy to increase memory bandwidth and clock frequency due to physical limitations.

Even though state of the art deep-learning-based image and video compression algorithms follow the Variational Auto-Encoder (VAE) framework, the NN-based video coding algorithms for encoding and/or decoding are still in the early development stage, and no consumer device includes an implementation of a VAE that is depicted in FIGS. 9, 9A, and 9B. Also, the consumer device costs are very sensitive to the implemented memory.

For NN-based video coding algorithms to become cost efficient so as to be implemented in consumer devices, such as mobile phones, it is therefore necessary to reduce the memory footprint and the required operation frequency of the processing units. Such optimizations are yet to be done.

The present disclosure is applicable both to end-to-end AI codecs and hybrid AI codecs. In Hybrid AI codec, for example, the filtering operation (filtering of the reconstructed picture) can be performed by means of a neural network (NN). The present disclosure applies to such NN-based processing modules. In general, the present disclosure can be applied to a whole or a part of a video compression and decompression process, if at least part of the process includes NN and if such NN includes convolution or transposed convolution operations. For example, the present disclosure is applicable to individual processing tasks as being performed as a processing part by the encoder and/or decoder, including in-loop filtering, post-filtering, and/or prefiltering, as well as encoder-only rate distortion optimization quantization (RDOQ).

Some embodiments of the present disclosure may provide solution for the above-mentioned problems in terms of enabling a tradeoff between memory resources and computational complexity within an NN-based video encoding-decoding framework. In particular, the present disclosure provides possibility to process parts of the input independently and yet still different image components being sample-aligned. This lowers the memory requirements while keeping the compression performance and has almost no additional computational complexity.

The processing may be decoding or encoding. The said neural network (NN) in the exemplary implementations discussed in the following can be:
A network including at least one processing layer where more than 1 input samples are used to obtain an output sample (this is the general condition when the problem addressed in the present disclosure arises).
A network including at least one 1 convolutional (or transposed convolution) layer. In one example, the kernel of the convolution is greater than 1.
A network including at least one pooling layer (max pooling, average pooling etc.).
A decoding network, a hyper decoder network, or an encoding network.
A part (subnetwork) of above.

The said input can be:
A feature map.
An output of a hidden layer.
A latent space feature map. The latent space might be obtained according to a bitstream.
An input image.

### FIRST EMBODIMENT

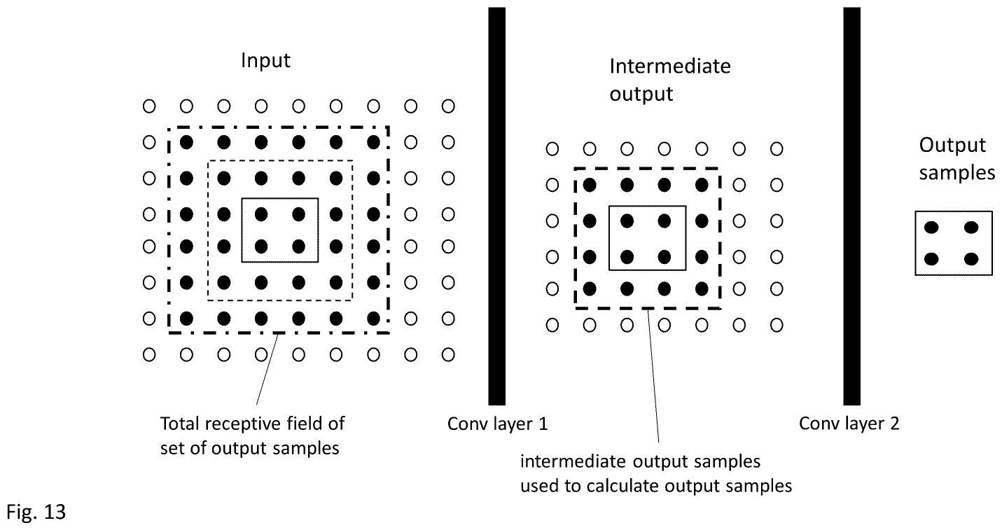

In the following, methods and apparatuses for picture/video encoding-decoding (compression-decompression) is described, where multiple subnetworks are used to process an input tensor representing picture data, as shown in FIG. 16.

In this exemplary and non-limiting embodiment, a method is provided for encoding an input tensor representing picture data. The input tensor can have a matrix form with width=w, height=h in spatial dimensions, and a third dimension (e.g. number of channels) whose size is equal to D. For instance, the input tensor may be directly an input image having D components that may include one or more color components and possibly further channels such as a depth channel or motion channel or the like. However, the present disclosure is not limited to such input. In general, the input tensor may be a representation of picture data, e.g. a latent representation that may be a result of previous processing (e.g. pre-processing).

The input tensor is processed by a neural network that includes at least a first subnetwork and a second subnetwork. Examples of the first and/or second subnetwork for the encoding branch is illustrated in FIG. 16, including encoder 1601 and rate distortion optimizing quantizer (RDOQ) 1602. The processing comprises applying the first subnetwork to a first tensor including dividing the first tensor in spatial dimensions into a first plurality of tiles and processing the first plurality of tiles by the first subnetwork. After applying the first subnetwork, the second subnetwork is applied to a second tensor including dividing the second tensor in the spatial dimensions into a second plurality of tiles and processing the second plurality of tiles by the second subnetwork.

In the example of FIG. 16, the output of the first subnetwork 1601 is provided as input to the second subnetwork, which is the RDOQ 1602. In this case, the first tensor is the input image x representing the picture data, which may be the raw picture data. In turn, the second tensor input to the second subnetwork is a feature tensor in a latent space. However, the present disclosure is not limited to cases in which the first subnetwork and the second subnetwork are directly cascaded. In general, the second subnetwork follows the first subnetwork, i.e. is applied after applying the first network, but there may be some additional processing between the first and the second subnetworks. Thus, the above term “after” does not limit above processing to immediately after in terms of an output of the first subnetwork is directly input to the second subnetwork. Rather, “after” means that the first and second plurality of tiles are processed, for example, within a same processing pipe.

The one or more channels of the first and second tensor are divided into so-called tiles, which basically represent data obtained by partitioning the input tensor in a spatial dimension or in a plurality of spatial dimensions. As in the current video coding standards, tiles are intended to provide possibility of being decoded in parallel, i.e. independently from each other. A tile may include one or more samples. A tile may have a rectangular shape, but is not limited to such regular shapes. The rectangular shape may be a square shape. An example of dividing into regular-shaped tiles is shown in FIG. 14. However, the present disclosure is not limited to rectangular or specifically to square shapes. For example, the shape may be chess-like or irregular. The dividing of the first and second input tensors may be done such that the tiles have a triangular shape or any other shape, which may depend on the particular application and/or the type of the processing performed by the subnetwork.

In FIG. 16, a general processing of N components is shown in subnetworks 1601 and 1602. Herein, the components may be the input tensor channels (e.g. color components or latent space representations) that may be processed in parallel. Such processing may include dividing the channels into tiles (including the first plurality of tiles) in spatial domain.

However, the N components in FIG. 16 may also correspond to respective N tiles (or groups of tiles) of one or more channels. The N tiles (or groups of tiles) may be processed in parallel. After such processing of the first and/or second plurality of tiles, the respective subnetwork may merge the processed tiles into an output tensor. In FIG. 16, such a merged output tensor is y for subnetwork encoder 1601 and y for subnetwork RDOQ 1602. It is noted that in FIG. 16, the number of components in the first subnetwork 1601 and in the second subnetwork 1602 is the same (N). However, this is not necessarily the case, there may be a number of parallel processing pipes within the first subnetwork different from the number of parallel processing pipes in the second subnetwork. For example, in case of post filtering, the first subnetwork is a post-filter which processes each component (e.g. Y, U, and V) separately. In turn, case of encoding or decoding processing, the encoder or decoder is the second subnetwork, respectively, where a difference is made between Y and UV, i.e. UV are jointly processed.

Further, at least two respective collocated tiles of the first plurality of tiles and the second plurality of tiles differ in size. Here, the term “collocated” means that the two tiles (i.e. one from the first plurality and one from the second plurality) are at corresponding (e.g. at least partially overlapping) positions within the first and second input tensor in spatial dimensions. In other words, the subdivision into tiles can differ for each subnetwork, and hence each subnetwork can use different tiling (different division into tiles).

In an exemplary implementation, the input of each subnetwork (i.e. the first and second tensor) is split (in the spatial domain) into a grid of tiles of the same size, except for tiles at bottom and right image boundary, which can have a smaller size because the input tensor does not necessarily have a size that is an integer multiple of the tile size. Such grid with tiles of the same size may be advantageous due to a possibility of efficient signaling of such grid in a bitstream and low processing complexity. On the other hand, a grid that may include tiles of different sizes, may lead to a better performance and content adaptivity.

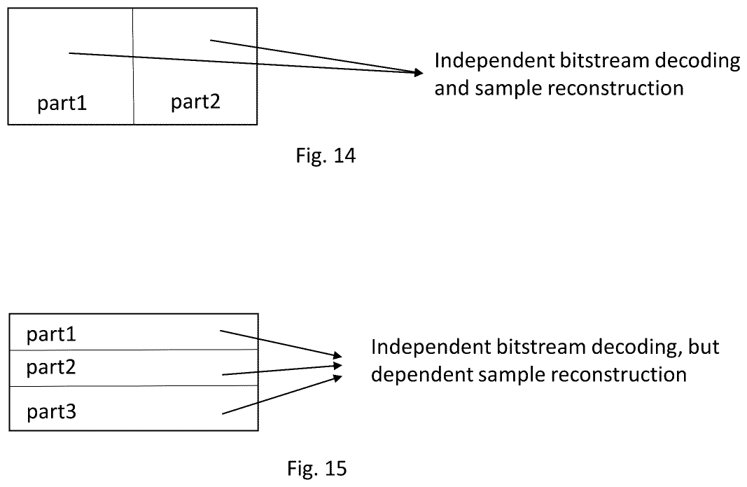

In the above exemplary implementation, the tiles of the first plurality of tiles that are adjacent in at least one dimension of the spatial dimensions partly overlap in the at least one spatial dimension. In addition or alternatively, the tiles of the second plurality of tiles that are adjacent in at least one dimension of the spatial dimensions partly overlap in the at least one spatial dimension. The term adjacent means that respective tiles are neighboring. Adjacent tiles part 1 and part 2 are shown in FIG. 14, which are adjacent but do not overlap. FIG. 17A illustrates the partial overlap, where the first tensor is divided into four tiles (i.e. regions L₁, L₂, L₃, and L₄) in 2D in the x-y plane, for example. Similar considerations may be applicable for the second input tensor. The first tile of the first plurality of tiles is L1, and the second tile is L2, respectively. L1 and L2 are adjacent to each other in the direction of the x-axis and have the overlapping boundary along the y-axis. As shown, L1 and L2 partly overlap. Partly overlap means that tile L1 and L2 include one or more of the same tensor elements. Tensor elements may, in some embodiments, correspond to picture sample(s) for the first input tensor.

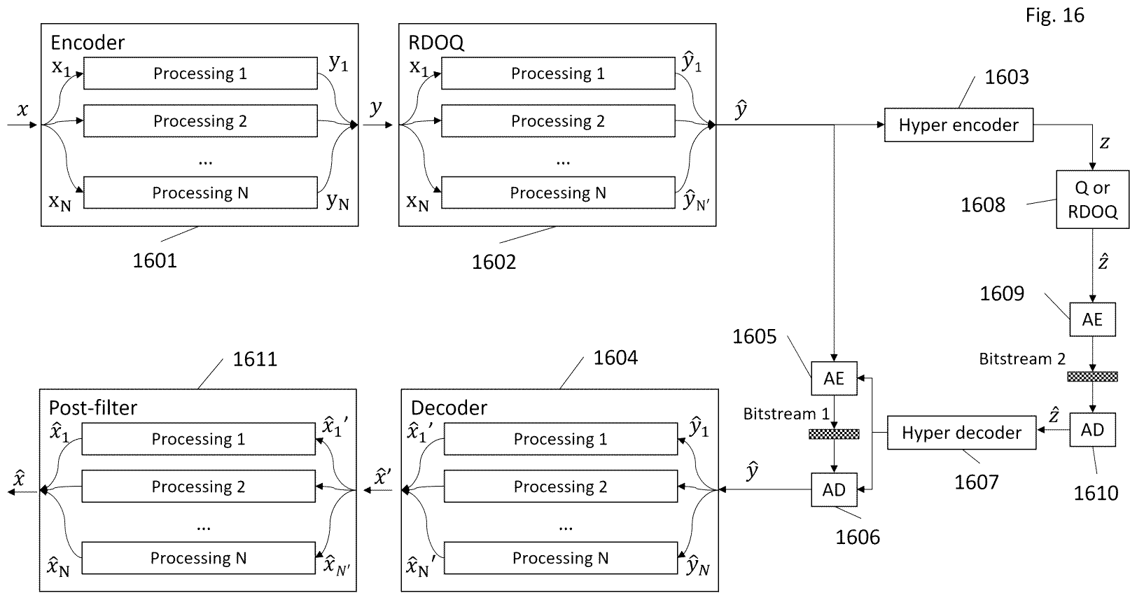

FIG. 17B shows the same scenario of the partial overlap in the x-axis and y-axis directions as in FIG. 17A. In both FIGS. 17A and 17B, L1 further overlaps with its adjacent tile to the right (in the y dimension, with overlapping boundary along the x dimension). L1 also slightly overlaps with its diagonally adjacent tile (in both dimensions). Similarly, L2 overlaps with both directly and diagonally adjacent tiles to its right. FIG. 18 shows another example of partial overlap for the tiles L1 and L2, which may be tiles of the first plurality of tiles. L1 and L2 have an overlap with another tile only in one respective dimension. L1 partly overlaps with its adjacent tile to the right with boundary along the x-axis (i.e. the partial overlap in y dimension). In turn, L2 partly overlaps with its adjacent tile, L1, at the top. In the Example of FIGS. 17A and 17B, the overlap between L1 and L2 meant that L1 also includes samples of L2 and L2 also includes samples from L1. In FIG. 18, L2 also includes samples from L1, but L1 does not include samples from L2. As is clear to those skilled in the art, there may be further variations of overlapping. The present disclosure is not limited to any particular way or extend of overlap. It may also include tile arrangements without overlap.

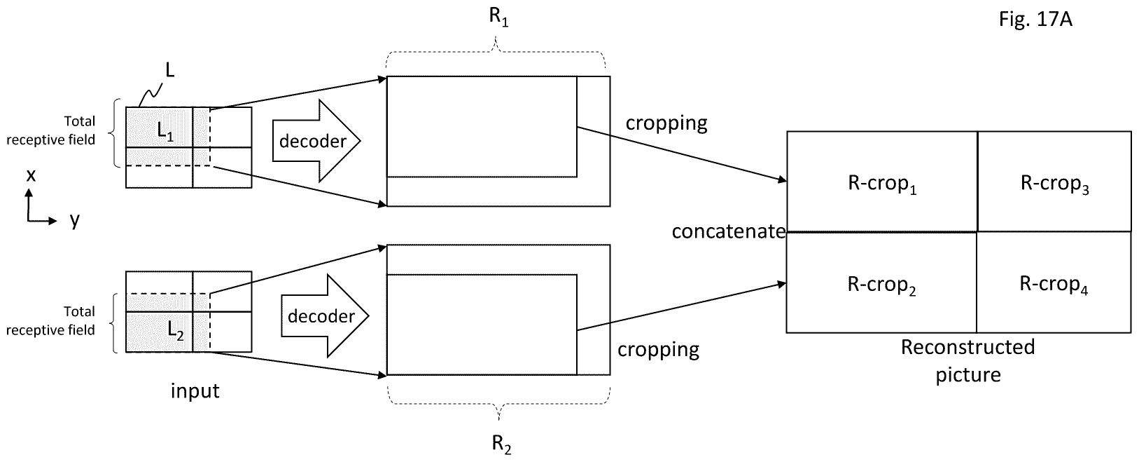

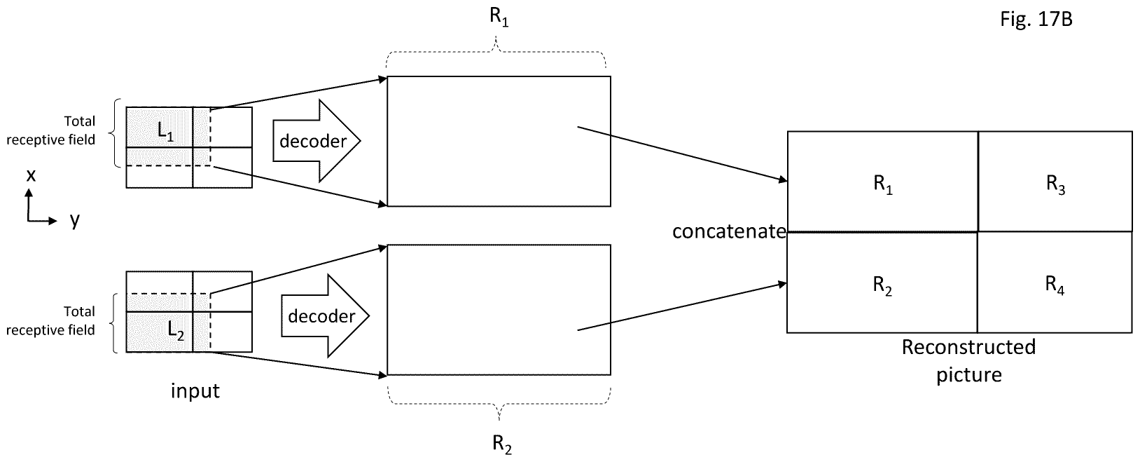

FIG. 19 is a further example of L1 and L2 without overlap with each other or with any other tile. FIG. 20 is similar to FIGS. 17A and 17B, with further details on the partial overlap region explained further below.

In an exemplary implementation, tiles (such as L1 and L2) of the first plurality of tiles are processed independently by the first subnetwork. In addition or alternatively, tiles of the second plurality of tiles are processed independently by the second subnetwork. In other words, the processing of the tiles is independent from each other, and hence is mutually independent. The independent processing provides the possibility of parallelization. For example, in some implementations, at least two tiles of the first plurality of tiles are processed in parallel by the first subnetwork and/or at least two tiles of the second plurality of tiles are processed in parallel by the second subnetwork. The parallel processing is illustrated in FIG. 16, involving processing 1 to processing N (processing pipes 1 to N) in the subnetwork encoder 1601 or quantizer RDOQ 1602. Using encoder subnetwork 1601 as first subnetwork, encoder 1601 takes input tensor x which is split into N tiles x1 to xN of the first input tensor. The respective tils are then processed by the respective blocks, i.e. processing 1 to processing N which do not have to interact with each other (e.g. wait for each other during the processing). The result of each processing is an output tensor y1 to yN for the respective tile, which may be a feature map in a latent space. The output tensor y1 to yN may be further combined into an output tensor y. The combination may (but does not have to) involve cropping as illustrated in FIGS. 17 to 19. It is noted that the combination into tensor y does not need to be performed. It is conceivable that a second subnetwork reuses the tiling of the first subnetwork and merely modifies it (refines the tiling by further division of tiles or coarsens the tiling by joining a plurality of tiles into one). In the example of FIG. 16, the processing 1 to N may perform the processing on a tile basis, i.e. processing i processes a tile i. Alternatively, processing i may process a component i among multiple components of an input tensor. In this case, processing i divides component i into a plurality of tiles and processes the tiles separately or in parallel.

Above, for simplicity reason, parallel processing of all N input tensor tiles by respective N processing pipes has been exemplified. However, the present disclosure is not limited to such parallel processing. There may be more than N tiles in the input tensor, divided into N groups of tiles that are processed in parallel within the respective N processing pipes (instances of the first subnetwork and/or instances of the second subnetwork). As is clear to those skilled in the art, once the tiles are independent from each other, their processing may be in principle parallelized. A skilled person may design any number of parallel processing pipes according to their respective performance requirements and/or hardware availability.

As FIGS. 17A/B to FIG. 20 illustrate, the respective tiles have a certain size, which may have a certain width and a certain height that may differ from each other in case of a rectangular shaped tiles or be the same in case of square shaped tiles. In an implementation, the dividing of the first tensor includes determining sizes of tiles in the first plurality of tiles based on a first predefined condition; and/or the dividing of the second tensor includes determining sizes of tiles in the second plurality of tiles based on a second predefined condition. For example, the first predefined condition and/or the second predefined condition is based on available decoder hardware resources and/or motion present in the picture data. As an example for available hardware resources, a first and/or second predefined condition may be memory resources of the processing apparatus (decoder or encoder). When the available amount of memory is lower than a predefined value (of amount of memory resources), the determined tile sizes may be smaller than tiles sizes when the available memory is equal to or larger than said predefined value. However, the hardware resources are not limited to memory. The first and/or second condition may be based on availability of processing power, e.g. number or processors and/or processing speed of one or more processor.

Alternatively or in addition, the presence of motion may be used in the first and/or second condition. For example, the tiles sizes may be determined to be smaller in case there is more motion present in the input tensor parts corresponding to a tile than in case when said presence of motion is less pronounced or when there is no motion at all. Whether a motion is pronounced (i.e. fast motion and/or fast/frequent motion changes), may be determined by respective motion vector(s) in terms of changes of its magnitude and direction, and compared to corresponding predefined values (thresholds) for magnitude and/or direction and/or frequency.

An alternative or additional condition may be region of interest (ROI), where the tile sizes may be determined based on presence of ROI. For example, a ROI within the picture data may be detected objects (e.g. vehicles, bikes, motor cycles, pedestrians, animals etc.) which may have a different size, move fast or slowly, and/or alter their direction of motion fast or slowly and/or many times (i.e. more frequent with reference to a predefined value of frequency). In an exemplary implementation, the size or tiles in at least one dimension may be smaller for ROI than for the remaining parts of the input tensor.

Hence, the tile sizes may be adapted or optimized to hardware resources or to content of the picture data, including scene-specific tile sizes. It is also possible to jointly adapt or optimize the tile size to both hardware resources and content of picture data.

FIGS. 17A/B to FIG. 20 exemplify the division of a first (or second) tensor into a plurality of tiles, which partly overlap with their adjacent tiles. As a result of the overlap and/or of the tiles processing, the processed tiles corresponding to regions Ri may be subjected to cropping. In FIGS. 17A/B to FIG. 20, the indices of L and R are the same for the corresponding divisions in the input and output. For example, L4 corresponds to R₄. The placement of Ri follows the same pattern as of Li, meaning that, if L1 corresponds to the top-left of the input space, R1 corresponds to the top-left of output space. If L2 is to the right of L1, R2 is to the right of R1. In the example of FIG. 17A, the division of the first tensor is such that each region Li comprises the complete receptive field of Rᵢ, respectively. Moreover, the union of Ri makes up the whole target picture R.

The determination of the total receptive field depends on the kernel size of each processing layer. It can be determined by tracing the input sample of the first tensor back in the opposite direction of the processing. The total receptive field consists of the union set of input samples that are all used in the calculation of a set of output samples. The total receptive field, therefore, depends on the connections between each layer and can be determined by tracing all of the connections starting from the output in the direction of the input.

In the example of the convolution layers shown FIG. 13, the kernel sizes of the convolution layers 1 and 2 are K1×K1 and K2×K2, and the downsampling ratios are R1 and R2, respectively. The convolution layers usually employ regular input output connections (e.g. always K×K input samples are used for each output). In this example, the calculation of the size of the total receptive field can be done as follows:

$$W = ( ( w \times R 2 ) + K 2 - 1 ) \times R 1 + ( K 1 - 1 ) ,$$

$$H = ( ( h \times R 2 ) + K 2 - 1 ) \times R 1 + ( K 1 - 1 ) ,$$

where H and W denote the sizes of the total receptive field, and h and w are the height and width of the output sample set, respectively.

In the above examples, the convolution operation is described in a two dimensional space. When the number of dimensions of the space where the convolution is applied is higher, a 3D convolution operation might be applied. The 3D convolution operation is a straightforward extension of the 2D convolution operation, wherein an additional dimension is added to all of the operations. For example, the kernel sizes can be represented as K1×K1×N and K2×K2×N, and the total receptive fields can be represented as W×H×N based on the previous example, where N represents the size of the third dimension). Since the extension from the 2D convolution and 3D convolution operations is straightforward, the present invention applies both to 2D and 3D convolution operations. In other words, the size of the third (or even fourth dimension) can be greater than one and the invention can be applied in the same manner.

The equations above are an example that shows how the size of the total receptive field can be determined. The determination of the total receptive field depends on the actual input-output connections of each layer. The output of the encoding process is Rᵢ. The union of Rᵢ makes up the feature tensor y whose components y₁ to y_{N} are merged (FIG. 16). In the example, Rᵢ have overlapping regions, so therefore cropping operation is applied first to obtain R-cropᵢ having no overlapping region. Finally, the R-cropᵢ are concatenated to obtain the merged feature tensor y. In the example, the Lᵢ comprise the total receptive field of Rᵢ. as noted above.

The determination of Rᵢ and Lᵢ (i.e. of the sizes of the first and/or second plurality of tiles) can be done as follows:
First determine N non-overlapping regions R-cropᵢ. for example R-cropᵢ might be equally sized N×M regions, where N×M are determined by the decoder according to memory limitation.
Determine the total receptive field of R-cropᵢ. Lᵢ is set equal to total receptive field of each R-crop; respectively.
Process each Lᵢ to obtain Rᵢ. this means that Rᵢ are the size of the output sample set generated by the NN. It is noted that an actual processing may not be necessary, once the size of Lᵢ is determined, it might be possible to determine the size and position of Rᵢ according to a function, Since the structure of the NN is already known, the relationship between the sizes Lᵢ and Rᵢ can already be known, therefore Rᵢ can be calculated by a function according to Lᵢ without actually performing the processing.
If the size Rᵢ is not equal to R-cropᵢ, crop Rᵢ to obtain R-cropᵢ.
   The size of R-cropᵢ might not be equal to Rᵢ, if padding operation is applied during the processing by the NN to the input or intermediate output samples. Padding might, for example, be applied to the NN if some size requirements must be met for input and intermediate output samples. For example, it might be required by the NN (e.g. due to its certain structure) that the input size must be a multiple of 16 samples. In this case, if the Lᵢ is not a multiple of 16 samples in one direction, padding might be applied in that direction to make it multiple of 16. In other words, the padded samples are dummy samples to ensure an integer multiplicity of each Li with the size requirements of the respective NN layer.
   The sample to be cropped out can be obtained by determining “output samples that include padded samples in its calculation”. This option may be applicable to the exemplary implementation discussed.

This is illustrated in FIG. 17A, where after processing of the first plurality of tiles (i.e. regions Li) via the first subnetwork (e.g. encoder 1601 in FIG. 16), the sizes Ri out by the first subnetwork are too large and hence may not have a suitable size for input of the following subnetwork, such as the second subnetwork RDOQ 1602 in FIG. 16. Hence, the processed tiles R1 and R2 of FIG. 17A are subject to cropping operation after which the cropped R-crop1 to R-crop4 are merged in this example.

FIG. 17B shows an example of partial overlap of regions L1 to L4 (i.e. of the first and/or second plurality of tiles), where no cropping of the processed tiles (i.e. regions R1 to R4) is involved. The determination of Rᵢ and Lᵢ can be done as follows and may be referred to as “simple” non-cropping case which is illustrated in FIG. 17B:
First, determine N non-overlapping regions Rᵢ. For example, Rᵢ might be equally sized N×M regions, where N×M are determined by the decoder according to memory limitation.
Determine the total receptive field of Rᵢ. Lᵢ is set equal to the total receptive field of each Rᵢ, respectively. The total receptive field is calculated by tracing each one of the output samples in Rᵢ in the backwards direction till Lᵢ. Lᵢ therefore consists of all the samples that are used in the calculation of at least one of the samples in Rᵢ.
Process each Lᵢ to obtain Rᵢ. This means that Rᵢ is the size of the output sample set generated by the NN.

The exemplary implementation solves the problem of total peak memory by dividing the input space into multiple smaller independently processible regions.

In the above exemplary implementation, the overlapping regions of Li require an additional processing compared to not dividing the input into regions. The larger the overlapping regions, the more extra processing is required. Especially in some cases, the total receptive field of Ri might be too large. In such cases, the total number of computations to obtain the whole reconstructed picture might increase too much.

FIG. 18 shows another example of partly overlapping tiles (i.e. regions L1 to L4), which involves also cropping of the processed tiles R1 to R4 similar to FIG. 17A. Compared to FIGS. 17A and 17B, the input regions Lᵢ (i.e. the tiles) are now smaller as shown in FIG. 18, since they represent only a subset of the total receptive field of respective Rᵢ. Each region Li is processed by the respective subnetwork (e.g. encoder 1601 and/or RDOQ 1602 of FIG. 16) independently, thereby obtaining the two regions R1 and R2 (i.e. the output sub-sets). Since a subset of the total receptive field is used to obtain a set of output samples, a padding operation might be necessary to generate missing samples. In an exemplary implementation, the processing by the first subnetwork of the first plurality of tiles and/or by second subnetwork of the second plurality of tiles may include padding before processing with the one or more layers. Hence, samples missing in the input sub-sets may be added by the padding process, which improves the quality of the reconstructed output sub-sets Ri. Accordingly, the quality of the reconstructed picture is improved as well after combining the output sub-sets Ri.

To recall, padding refers to increasing the size of the input (i.e. an input image) by generating new samples at the borders of the image (or picture) by either using sample values that are predefined or by using sample values at the positions in the input image. This is illustrated in FIG. 11. The generated samples are approximations of non-existing actual sample values. Therefore, a padded sample may be obtained e.g. based on one or more nearest neighbor samples of a sample to be padded. For example, a sample is padded by copying a nearest neighbor sample. If there are more neighbor samples at the same distance, the neighbor sample among them to be used may be specified by a convention (e.g. by standard). Another possibility is to interpolate the padding sample from a plurality of neighboring samples. Alternatively, padding may include using a zero-valued sample. Intermediate samples generated by the processing may also be needed to be padded. An intermediate sample may be generated based on the samples of the input sub-set including the one or more padded samples. Said padding may be performed before input of the neural network or within the neural network. However, the padding is to be performed before the processing of the one ore more layers.

For completeness, FIG. 19 shows another example where, after the output sub-sets Ri are subjected to cropping, the respective cropped regions Ri-crop are merged seamlessly without any overlap of the cropped regions. Contrary to the examples of FIGS. 17A, 17B, and 18, the regions Li are non-overlapping. The respective implementation may read as follows:
1. Determine N non-overlapping regions Li (i.e. first and second plurality of tiles) in the first and second tensor respectively, where at least one of the regions comprises a subset of the total receptive field of one of Rᵢ, where the union of Rᵢ make up the complete output (e.g. feature tensor y) of the first or second subnetwork.
2. Process each Lᵢ using NN independently to obtain regions Rᵢ.
3. Merge Rᵢ to obtain a merged output tensor

FIG. 19 illustrates this case, wherein the Li are selected as non-overlapping regions. This is a special case, where the total amount of computations necessary to obtain the whole reconstructed output (i.e. output picture) is minimized. However, the reconstruction quality might be compromised.

As mentioned above, the first and the second subnetworks are a part of a neural network. A subnetwork is itself a neural network and includes at least one processing layer. In an implementation, the first subnetwork performs processing by one or more layers including at least one convolutional layer and at least one pooling layer; and/or the second subnetwork performs processing by one or more layers including at least one convolutional layer and at least one pooling layer.

In an implementation example, the first subnetwork and the second subnetwork perform respective processing that is a part of picture or moving picture compression.

Moreover, the first subnetwork and/or the second subnetwork perform one of: picture encoding by a convolutional subnetwork; and rate distortion optimization quantization, RDOQ; and picture filtering. As explained above, the first and/or second subnetwork may be an encoding apparatus (or encoding processing) 901 or Q/RDOQ 902 of FIG. 9, where the input image x is processed first by encoder 901 performs picture encoding. Said encoder 901 may be part of an VAE encoder-decoder framework, as the one shown in FIGS. 6A and 6B, where the respective encoder “ga” performs the respective picture encoding by processing the input image through a sequence of conv layers 601 to 604, including processing via GDN layers. Likewise, the quantizer “Q” in FIGS. 6A and 6B may perform functions of a quantization or RDOQ being the first and/or second subnetwork. The same applies for the units Q or RDOQ 902 and 908 in FIG. 9. The picture post-filtering is not further illustrated in FIGS. 6A/B and 9. In general, some of the processing layers of the neural network at the decoding apparatus may have post-filtering or general filtering function.

For example, FIG. 16 shows an example of an encoding apparatus that may correspond to the neural network and includes an encoder subnetwork 1601 as the first subnetwork and an RDOQ subnetwork 1602 as the second subnetwork. However, the present disclosure is not limited to such an embodiment. The neural network may be a network for decoding of pictures or latent representations and include a decoding subnetwork and a post-filtering subnetwork. Further examples of subnetworks are possible, including a pre-processing subnetwork or other subnetworks.

As is illustrated in FIG. 16, the encoding apparatus (or encoding processing in general) may further include a hyper encoder 1603 and quantizer 1608 for the output z of the hyper encoder 1603, as well as arithmetic encoder 1609 for encoding quantized information (2) on hyperprior to be included into bitstream2.

The decoding apparatus (or decoding processing) may correspondingly further include arithmetic decoder 1610 of the hyperprior information followed by a hyper decoder 1607. The hyperprior part of the encoding and the decoding may correspond to the VAE framework with regard to FIGS. 6A and 6B or to its variations.

FIGS. 6A and 6B show an encoder within the NN-based VAE framework, with respective convolutional layers 601 to 606, where the respective size of the input image (picture data) is subsequently reduced by 2. For example, the plurality of samples (i.e. the samples of the picture data) used by the neural network (NN) may depend on the kernel size of the first input layer of the NN. The one or more layers of the neural network (NN) may include one or more pooling layers and/or one or more subsampling layers. The NN may generate the one sample of the output sub-set by pooling the plurality of samples via the one or more pooling layers. Alternatively or in addition, the one output sample may be generated by the NN through subsampling (i.e. downsampling) by one or more downsampling convolutional layers (e.g. conv layers 601 to 606 in FIG. 6B). Pooling and downsampling may be combined to generate the one output sample. FIG. 12 illustrates downsampling by two convolutional layers, starting with 7 samples of the total receptive field, providing one sample as output.

In FIGS. 6A and 6B, an input image 614 corresponds to the picture data. According to an implementation, the input tensor 614 is a picture or a sequence of pictures including one or more components of which at least one is a color component. Alternatively, the input tensor may be a latent space representation of a picture, which may be an output (e.g. output tensor) of a pre-processing. The one or more components are color components and/or depth and/or motion map and/or other feature map(s) associated with picture samples.

It is noted that the input tensor may represent other types of data (e.g. any kind of multi-dimensional data) with one or more spatial components that may be suitable for tiling and/or processing via subnetworks as described in the FIRST EMBODIMENT.

In an implementation, the input tensor has at least two components, namely a first component and a second component; and the first subnetwork divides the first component into a third plurality of tiles and divides the second component into a fourth plurality of tiles, wherein at least two respective collocated tiles of the third plurality of tiles and the fourth plurality of tiles differ in size. In principle, the present disclosure is not limited to any particular number of spatial components. There may be one spatial component (e.g. a gray scale picture). However, in the present implementation, there is a plurality of spatial components in the input tensor. The first and the second components may be color components. The tiling may then differ not only for the subnetworks, but also for the components processed by the same subnetwork.

Thus, in addition or alternatively, the second subnetwork divides the first component into a fifth plurality of tiles and divides the second component into a sixth plurality of tiles, wherein at least two respective collocated tiles of the fifth plurality of tiles and the sixth plurality of tiles differ in size. In other words, the tilings of the spatial components of the second input tensor may differ. Further details of a SECOND EMBODIMENT in which the tiling differs for different spatial input components are provided below. The SECOND EMBODIMENT is combinable with the presently described FIRST EMBODIMENT in which the tiling differs for different subnetworks of a neural network.

The encoding of FIG. 16 (similarly to FIGS. 6A and 6B) comprises further generating a bitstream by including into the bitstream an output of the processing by the neural network. The neural network may further include entropy coding. This is illustrated in FIG. 6A, where after encoding the input image 614 via the encoder neural network (conv layers 601 to 604), the output y of the encoder NN ga is subject to quantization (e.g. RDOQ) and arithmetic encoding 613 providing for bitstream Bitstream 1. Likewise, the hyperprior neural network takes the (bottleneck) feature map y (output of encoder NN ga) and processes it through conv layers 605 and 606 and the two ReLU layers and provides as output z entailing statistics of the input image. This is quantized and arithmetically encoded 615, so as to generate a bitstream Bitstream 2. The respective bitstream Bitstream 1 and Bitstream 2 are generated likewise via the processing show in FIG. 6B, FIG. 9, and FIG. 9A.

With the sizes of the tiles being determined as discussed above the generating of the bitstream further comprises including into a bitstream an indication of size of the tiles in the first plurality of tiles and/or an indication of size of the tiles of the second plurality of tiles. This bitstream may be a part of the bitstream including Bitstream 1 and Bitstream 2, i.e. of the bitstream generated by the entire encoding apparatus (encoding processing).

Further details and implementation examples on processing of components, including color components and signaling of tile sizes are discussed in the SECOND EMBODIMENT. Here, we simply refer to FIG. 20 showing an example of various kind of parameters (such as sizes of tiles of the first plurality of tiles and/or of the second plurality of tiles) respective indications are included into the bitstream.

The encoding processing of the input tensor has its decoding counterpart, sharing functional correspondence in the processing. In this exemplary and non-limiting embodiment, a method is provided for decoding a tensor representing picture data. The tensor can have a matrix form with width=w, height=h in two spatial dimensions, and a third dimension (e.g. depth or number of channels) whose size is equal to D. The method comprises processing an input tensor representing the picture data by a neural network that includes at least a first subnetwork and a second subnetwork. It is noted that the width and height of the input tensor of the decoder may be different from the width and height of the input tensor processed by the encoder. Moreover, as is clear for those skilled in the art, the first subnetwork and second subnetwork of the decoder may perform entirely or partly (e.g. functionally) inverse functions as the first subnetwork and second subnetwork of the encoder. However, inverse function may not be interpreted in a strict mathematical manner. Rather the term “inverse” refers to processing for the purpose of decoding a tensor, so as to reconstruct original picture data. It is understood by those skilled in the art that encoding compression and decoding decompression may include further processing which may not be needed for decoding and/or encoding. For example, the RDOQ shown in FIG. 16 is an encoder-only processing. It is noted further that the terms “first” and “second” subnetwork are mere labels to distinguish between the subnetworks of the decoder (and for that purpose also of the encoder discussed above).

Examples of the first and/or second subnetwork for the encoding branch is illustrated in FIG. 16, including decoder 1604 and post filter 1611. In the method, the processing comprises: applying the first subnetwork to a first tensor including dividing the first tensor in spatial dimensions into a first plurality of tiles and processing the first plurality of tiles by the first subnetwork; after applying the first subnetwork, applying the second subnetwork to a second tensor including dividing the second tensor in the spatial dimensions into a second plurality of tiles and processing the second plurality of tiles by the second subnetwork. In the example of FIG. 16, the first subnetwork is the decoder 1604, whose output is provided as input to the second subnetwork, which is the post filter 1611. Here, the first tensor is the quantized feature tensor y in latent space, which is decoded beforehand from a bitstream Bitstream 1 by arithmetic decoder 1606. In turn, the second tensor \hat{x}′ input to the second subnetwork 1611 for post filtering is a feature tensor, such as a feature a feature map or a feature map in latent space. Hence, similar to the processing of the encoder, the type of input tensor (e.g. first and second tensor) may depend on the processing performed by the preceding subnetwork. In the example of FIG. 16, said preceding subnetwork is the encoder 1604. The above term “after” does not limit above processing of the decoding to immediately after in terms of an output of the first subnetwork being directly input to the second subnetwork. Rather, “after” means that the first and second plurality of tiles are processed, for example, within a same pipe in a certain temporal order, which may not be immediate in time.

Moreover, the type of input may also depend on the layer (e.g. a layer of a neural network NN or a layer of a non-trained network) at which processed input data may be branched to be used as input to another (e.g. subsequent) subnetwork. Such a layer may, for example, be an output of a hidden layer. Similar to the encoding processing, the first and second tensor are divided into so-called tiles in the decoding processing, which have been defined already above.

In FIG. 16, the decoder 1604 may be the first subnetwork with processing 1 to processing N (processing pipelines 1 to N), As FIG. 16 depicts, the decoder 1604 takes the input feature tensor ŷ is divided into N tiles ŷ₁ to ŷ_{N} (first plurality of tiles). The respective tensor tiles are then processed by the respective blocks, i.e. processing 1 to processing N which do not have to interact with each other (e.g. wait for each other during the processing). The result of each processing provides N tiles \hat{x}₁′ to \hat{x}_{N}′(tensors). After the processing of the first plurality of tiles, the decoder subnetwork 1604 may merge the processed tiles into a first output tensor \hat{x}′. In FIG. 16, said first output tensor may be the second tensor used by post-filter 1611 as input. The post-filter 1611 may be the second subnetwork with processing 1 to processing N (processing pipelines 1 to N), Similar to decoder 1604, the post-filter 1611 divides input tensor \hat{x}′ into a second plurality of tiles \hat{x}₁′ to \hat{x}_{N}′, which are processed by the respective processing 1 to processing N of post filter 1611. Processing 1 to processing N provides as output a respective tile \hat{x}₁ to \hat{x}_{N}, which may be merged into tile \hat{x}. In the example of FIG. 16, the merged \hat{x} refers to the decoded tensor representing the reconstructed picture data. The merging may (but does not have to) involve cropping as illustrated in FIGS. 17 to 19. It is noted that the merge/combination into tensor \hat{x}′ or \hat{x} does not need to be performed. It is conceivable that a second subnetwork reuses the tiling of the first subnetwork and merely modifies it (refines the tiling by further division of tiles or coarsens the tiling by joining a plurality of tiles into one). In the example of FIG. 16, the processing 1 to N may perform the processing on a tile basis, i.e. processing i processes a tile i. Alternatively, processing i may process a component i among multiple components of an input tensor. In this case, processing i divides component i into a plurality of tiles and processes the tiles separately or in parallel.

Further, at least two respective collocated tiles of the first plurality of tiles and the second plurality of tiles differ in size. In other words, the subdivision into tiles can differ for each subnetwork, and hence each subnetwork can use different tile sizes. However, the input of each subnetwork (i.e. the first and second tensor) is split into a grid of tiles of the same size, except for tiles at bottom and right image boundary, which can have a smaller size.

Otherwise, properties and/or characteristics of the first and second plurality of tiles used in the decoding processing are similar to the one of the encoding processing discussed before. In particular, in the above exemplary implementation, tiles of the first plurality of tiles that are adjacent in at least one dimension of the spatial dimensions partly overlap; and/or tiles of the second plurality of tiles that are adjacent in at least one dimension of the spatial dimensions partly overlap. Examples for adjacent tiles along with partly overlap are shown in FIGS. 17A, 17B, 18, 19, and 20.

Further, in some exemplary implementations, tiles of the first plurality of tiles are processed independently by the first subnetwork; and/or tiles of the second plurality of tiles are processed independently by the second subnetwork. In other words, the processing of the tiles is independent from each other and thus, parallelizable. In an example, at least two tiles of the first plurality of tiles are processed in parallel by the first subnetwork; and/or at least two tiles of the second plurality of tiles are processed in parallel by the second subnetwork. FIG. 16 illustrates the parallel processing on the decoder side, where components (e.g. tiles and/or spatial components) ŷ₁ to ŷ_{N} of the first input tensor are processed by the decoder 1604 without interaction among the processing for components 1 to N. The result of each processing are output tensor components \hat{x}₁′ to \hat{x}_{N}′. They may be further combined to an output tensor \hat{x}′. The second subnetwork may be post-filter 1611 in FIG. 16, which takes as input the tensor \hat{x}′ from decoder 1604 (first subnetwork). In this example, the input of post-filer 1611 is directly connected to the output of decoder 1604. Alternatively, there may be further processing between the post-filter and decoder in FIG. 16. The input tensor \hat{x}′ is divided into N tiles \hat{x}₁′ to \hat{x}_{N}′ by the post-filter, which then processes the respective tiles independently or in parallel. The parallel processing is reflected in FIG. 16 in that the processing of component 1 to N may not interact among each other. The result of the parallel processing of the post filter are reconstructed tiles \hat{x}₁ to \hat{x}_{N}, which may be merged into one tensor î representing reconstructed picture data.

In addition, said dividing of the first tensor includes determining sizes of tiles in the first plurality of tiles based on a first predefined condition; and/or said dividing of the second tensor includes determining sizes of tiles in the second plurality of tiles based on a second predefined condition. For example, the first predefined condition and/or the second predefined condition is based on available decoder hardware resources and/or motion present in the picture data or other features as already described above with reference to the encoding.

The first and second subnetwork for the decoding processing may have a similar configuration as the subnetwork(s) for the encoding processing. Specifically, the first subnetwork performs processing by one or more layers including at least one convolutional layer and at least one pooling layer; and/or the second subnetwork performs processing by one or more layers including at least one convolutional layer and at least one pooling layer. FIGS. 6A and 6B show a decoder within the NN-based VAE framework, with respective convolutional layers 607 to 6012, where the respective size of the input tensor (feature map) ŷ is subsequently enlarged by 2 (upsampling). Moreover, the first subnetwork and the second subnetwork perform respective processing that is a part of picture or moving picture decompression. Such a processing may be provided by the VAE encoder shown in FIGS. 6A and 6B, taking as input feature tensor ŷ so as to decompress and reconstruct an output image as output of conv layer 607, representing the reconstructed picture data (i.e. decoded tensor). For example, the first subnetwork and/or the second subnetwork perform one of: picture decoding by a convolutional subnetwork; and picture filtering. As explained above, the first and/or second subnetwork for decoding processing may be decoder 904 of FIG. 9, which processes a feature map tensor ŷ so as to generate reconstructed picture data \hat{x} approximating original picture data x. As shown, in FIG. 9, said decoder 904 may be part of an VAE encoder-decoder frame work, as the one shown in FIGS. 6A and 6B, where the respective decoder “gs” performs the respective picture decoding by processing feature tensor ŷ through a sequence of conv layers 610 to 607, including processing via inverse IGDN layers. The picture filtering (e.g. post filter) is not further illustrated in FIGS. 6A/B and 9.

In an implementation, the input tensor is a picture or a sequence of pictures including one or more components of which at least one is a color component. Alternatively, the input tensor may be a latent space representation of a picture, which may be an output (e.g. output tensor) of a pre-processing. The one or more components are color components and/or depth and/or motion map and/or other feature map(s) associated with picture samples. The input tensor has at least two components, namely a first component and a second component; and the first subnetwork divides the first component into a third plurality of tiles and divides the second component into a fourth plurality of tiles, wherein at least two respective collocated tiles of the third plurality of tiles and the fourth plurality of tiles differ in size; and/or the second subnetwork divides the first component into a fifth plurality of tiles and divides the second component into a sixth plurality of tiles, wherein at least two respective collocated tiles of the fifth plurality of tiles and the sixth plurality of tiles differ in size.

The above described decoding method comprises further extracting the input tensor from a bitstream for the processing by the neural network. The neural network may further include entropy decoding. FIGS. 6A and 6B illustrate decoding the input tensor § for the decoder subnetwork gs from bitstream Bitstream 1 via arithmetic decoding. The entropy encoding is performed by subnetwork hs, where entropy tensor \hat{z} may be deocoded by arithmetic decoding from bitstream Bitstream 2, with \hat{z} being processed to obtain statistical information on the encoded picture data used for the decoding processing of ŷ. FIG. 6B shows further details on the entropy decoding, where information on the distribution given in terms of mean u, and variances σ₁, σ₂ are further input to a Gaussian entropy model 670 and used for the arithmetic decoding of ŷ. As discussed before, subnetwork hs (FIG. 6A) with the various upsampling conv layers 611 and 612, possibly including leaky ReLU layers 660 may be part of hyper decoder 907 shown in FIG. 9 and FIG. 9B. In an exemplary implementation, the second subnetwork performs picture post-filtering; and for at least two tiles of the second plurality of tiles one or more parameters of post-filtering differ and are extracted from said bitstream. Moreover, the decoding processing further comprises parsing from the bitstream an indication of size of the tiles in the first plurality of tiles and/or an indication of size of the tiles of the second plurality of tiles.

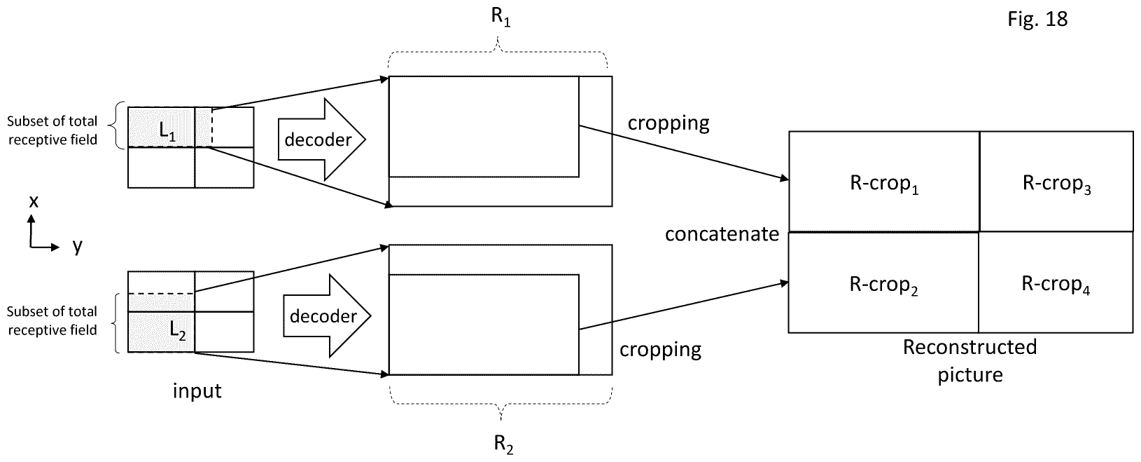

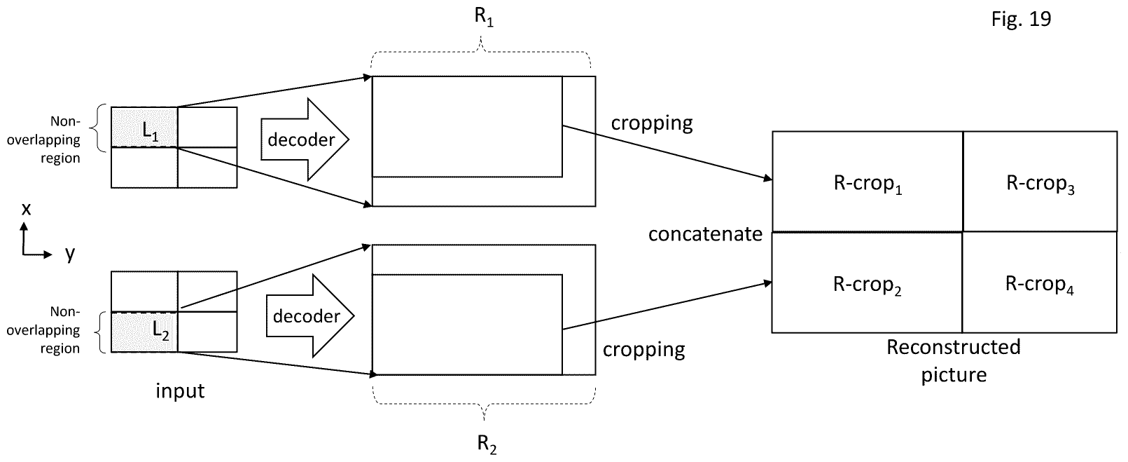

In this exemplary and non-limiting embodiment, provided is a computer program stored on a non-transitory medium comprising code which when executed on one or more processors performs steps of any of the encoding and decoding methods discussed above. The respective flowcharts of the encoding and encoding processing are shown in FIGS. 21 and 22. As to the encoding processing of FIG. 21, in step 2110 the first subnetwork processes the first tensor including dividing said first tensor into a plurality of tiles, which are then processed by the first subnetwork. Note that in FIG. 21 the picture data (i.e. the input tensor representing the picture data) is input to the first subnetwork illustrated by a dashed line. This means that the raw picture data may not necessarily input directly to the first subnetwork, which may depend on the processing performed by the first subnetwork with respect to an order of sequence of processing. In other words, the first tensor being the input for the first subnetwork originate from the picture data. In case of the first subnetwork being encoder 901 shown in FIG. 9, the first tensor may be the input tensor x. In step S2120, the first plurality of tiles is then processed further by the first subnetwork. After said processing by the first subnetwork, the second subnetwork processes a second tensor in step S2130 including dividing the second tensor into a second plurality of tiles. Again, the second tensor input to the second subnetwork indicated by a dashed line may not necessarily be the direct output from the first subnetwork. In the implementation example of FIG. 9, the feature tensor y of encoder 901 (first subnetwork) is directly input to RODQ 902 (second subnetwork). However, between encoder 901 and RDOQ 902 there may be additional processing. In step S2140, the second plurality of tiles are then processed further. The output of the processing of the second subnetwork, which may include further processing (not shown in FIG. 21) may include generating a bitstream (e.g. Bitstream 1 and/or Bitstream 2 in FIG. 9). Also, processing for determining of sizes of the tiles of the first and second plurality of tiles and/or including an indication of said sizes into the bitstream may be processing steps before providing the bitstream as an output of the neural network processing. As to the decoding processing of FIG. 22, the flowchart depicts inverse processing steps, starting with an input tensor, which may be a direct or indirect input to the first subnetwork, as indicated by the dashed line. Again, in the example implementation of FIG. 9, feature tensor ŷ is used as direct input to decoder 904, which is the first subnetwork in this case. In step S2220, the first plurality of tiles are processed by the first subnetwork (e.g. decoder 1604), as depicted in FIG. 16. After the processing of the first subnetwork, a second tensor is processed by the second subnetwork in step S2230 by dividing the second tensor into a plurality of tiles, which are then processed further by the second subnetwork in step S2240. In the example implementation of FIG. 16, the output \hat{x}′ of the first subnetwork of decoder 1604 is the second tensor, which is processed by post filer 1611 corresponding to the second subnetwork. The processing of the second plurality of tiles in the example of FIG. 16 provides as output \hat{x} corresponding to the reconstructed picture data. It is noted that, between the processing of decoder 1604 and post filer 1611 in FIG. 16, there may be further processing, in which case the output \hat{x}′ of decoder 1604 may not be directly input to post filer 1611.

Moreover, as already mentioned, the present disclosure also provides devices (apparatus(es)) which are configured to perform the steps of the methods described above.

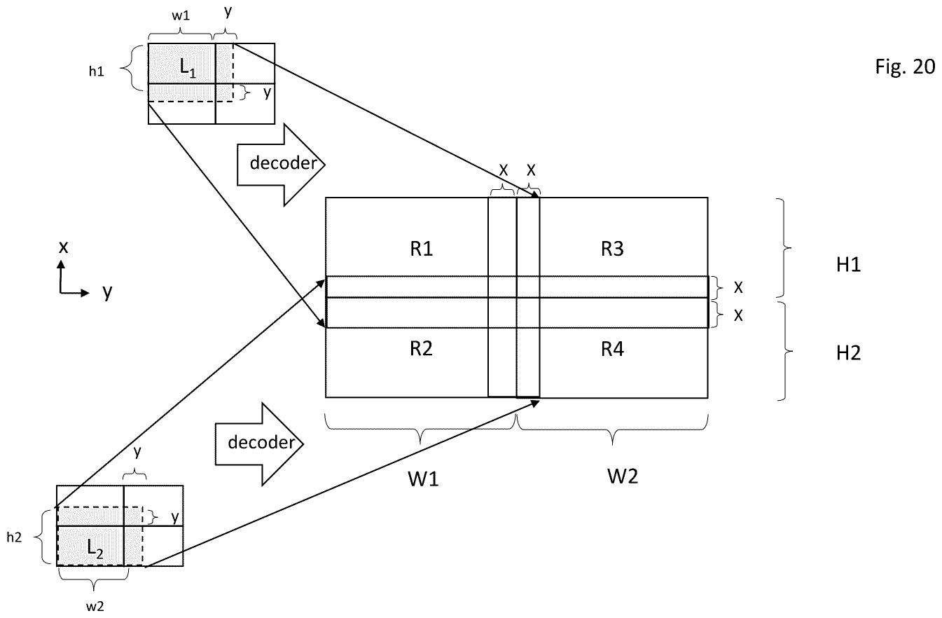

In this exemplary and non-limiting embodiment, a processing apparatus is provided for encoding an input tensor representing picture data. FIG. 23 shows the processing apparatus 2300 having respective modules to perform the steps of encoding processing, comprising processing circuitry 2310. The processing circuitry is configured to: process the input tensor by a neural network that includes at least a first subnetwork and a second subnetwork realized by NN processing module-subnetwork 1 2311 and NN processing module-subnetwork 2 2312. NN processing module-subnetwork 1 2311 may have a separate dividing module 1 2313 which divides the first tensor in spatial dimensions into a first plurality of tiles and processes the first plurality of tiles by the first subnetwork. Alternatively, the respective modules processing the first input tensor and/or the first plurality of tiles may be implemented in one single module, which may be included in a single circuitry or separate circuitry. Likewise, NN processing module-subnetwork 2 2312 and dividing module 2314 apply the second subnetwork to a second tensor including dividing the second tensor in the spatial dimensions into a second plurality of tiles and processing the second plurality of tiles by the second subnetwork. It is noted that processing of the second tensor after the processing of the first tensor may be implemented by wiring the respective modules such that the signals (in terms of their input and output signals) are input in the respective temporal (not necessarily immediate temporal) order. Alternatively or in addition, the respective order of signaling may be implemented by configuring modules by software. Modules 2313 and 2314 may further provide a function of determining sizes of the tiles of the first and/or second plurality of tiles. The processing apparatus may have further a bitstream module 2315, which provides a function of generating a bitstream, wherein an output of the neural network processing is included into the bitstream. Further, module 2315 provides the functionality of including into the bitstream an indication of sizes of the tiles of the first and/or second plurality of tiles.

In this exemplary and non-limiting embodiment, a processing apparatus is provided for encoding an input tensor representing picture data, the processing apparatus comprising: one or more processors; and a non-transitory computer-readable storage medium coupled to the one or more processors and storing programming for execution by the one or more processors, wherein the programming, when executed by the one or more processors, configures the encoder to carry out the method according to the encoding method described above.

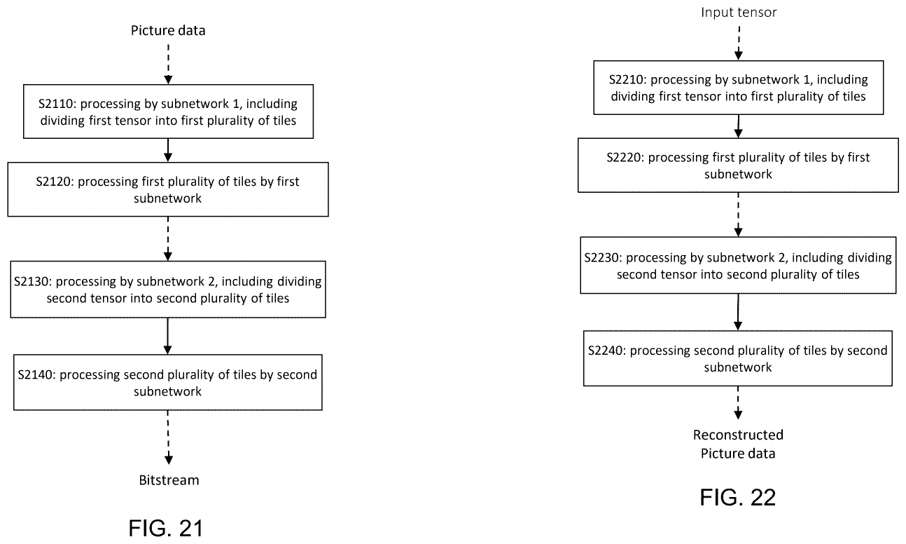

In this exemplary and non-limiting embodiment, a processing apparatus is provided for decoding a tensor representing picture data. FIG. 24 shows the processing apparatus 2400 having respective modules to perform the steps of decoding processing, comprising processing circuitry 2410. The processing circuitry is configured to: process an input tensor by a neural network that includes at least a first subnetwork and a second subnetwork realized by NN processing module-subnetwork 1 2411 and NN processing module-subnetwork 2 2412. NN processing module-subnetwork 1 2411 may have a separate dividing module 1 2413 which divides the first tensor in spatial dimensions into a first plurality of tiles and processes the first plurality of tiles by the first subnetwork. Alternatively, the respective modules processing the first input tensor and/or the first plurality of tiles may be implemented in one single module, which may be included in a single circuitry or separate circuitry. Likewise, NN processing module-subnetwork 2 2412 and dividing module 2414 apply the second subnetwork to a second tensor including dividing the second tensor in the spatial dimensions into a second plurality of tiles and processing the second plurality of tiles by the second subnetwork. Modules 2413 and 2414 may further provide a function of determining sizes of the tiles of the first and/or second plurality of tiles. Again, it is noted that processing of the second tensor after the processing of the first tensor may be implemented by, for example, wiring the respective modules such that the signals (in terms of their input and output signals) are input in the respective temporal (not necessarily immediate temporal) order. Alternatively or in addition, the respective order of signaling may be implemented by configuring modules by software. The processing apparatus may have further a parsing module 2415, providing a function of parsing from a bitstream an indication of size of the tiles of the first and/or second plurality of tiles. Module 2415 may further provide a function of extracting from the bitstream the input tensor.

In this exemplary and non-limiting embodiment, a processing apparatus for decoding a tensor representing picture data, the processing apparatus comprising: one or more processors; and a non-transitory computer-readable storage medium coupled to the one or more processors and storing programming for execution by the one or more processors, wherein the programming, when executed by the one or more processors, configures the encoder to carry out the method according to the decoding method described above.

The encoding and decoding processing described above and performed by the VAE-encoder-decoder shown in FIG. 16 may be implemented within the coding system 10 of FIG. 1A. Thereby, the source device 12 represents the encoding side, providing for the compression of input picture data 21 including the input tensor x of FIG. 16. In particular, encoder 20 of FIG. 1A may include modules for encoding processing according to the present disclosure, such as encoder 1601, quantizer or RDOQ 1602, and arithmetic encoder 1605. Encoder 20 may further include modules of the hyperprior such as hyper decoder 1603, quantizer or RDOQ 1608, and artithmetic encoder 1609. Likewise, the destination device 14 of FIG. 1A represents the decoding side, providing decompression of an input tensor representing the picture data. In particular, decoder 30 of FIG. 1A may include modules for decoding processing according to the present disclosure, such as decoder 1604 and post-filer 1611 of FIG. 16, along with arithmetic decoder 1606. In addition, decoder 30 may further include the hyperprior for decoding 2 arithmetic decoder 1610, hyper decoder 1607, and arithmetic decoder 1606. In other words, encoder 20 and decoder 30 of FIG. 1A may be implemented and configured such as to include any of the modules of FIG. 16 to realize the encoding or decoding processing according to the present disclosure, where multiple subnetworks process an input tensor divided into a first and second plurality of tiles, which are then processed as described in the FIRST EMBODIMENT. While FIG. 1A shows encoder 20 and decoder 30 separately, they may be implemented via processing circuitry 46 of FIG. 1B. in other words, processing circuitry 46 may provide the functionality of the encoding-decoding processing of the present disclosure by implementing respective circuitry for the respective modules of FIG. 16.

Similarly, the video coding device 200 with its coding module 270 of processor 230 of FIG. 2 may perform functions of encoding processing or decoding processing of the present disclosure. For example, the video coding device 200 may be an encoder or decoder having the respective modules of FIG. 16, so as to perform the encoding or decoding processing as described above.

The apparatus 300 of FIG. 3 may be implemented as encoder and/or decoder, which have the encoder 1601, quantizer or RDOQ 1602, decoder 1604, post-filer 1611, hyper encoder 1603, and hyper decoder 1607, along with arithmetic encoders 1605, 1609 and arithmetic decoders 1606, 1610, so as to perform processing of tiles as discussed according to the FIRST EMBODIMENT. For example, the processor 302 of FIG. 3 may have respective circuitry to execute the encoding and/or decoding processing according to the methods described before.

The example implementation of encoder 20 shown in FIG. 4 and of decoder 30 shown in FIG. 5 may implement as well the functions of encoding and decoding of the present disclosure. For example, partition unit 452 in FIG. 4 may perform the dividing of the first and/or second tensor into the first and/or second plurality of tiles as performed by encoder 1601 of FIG. 16. Thereby, the syntax elements 465 may include the indication(s) for the sizes and positions of the tiles, along with indication of filter index or the like. Likewise, quantization unit 408 may perform quantization or RDOQ of RDOQ module 1602, while entropy encoding unit 470 may implement functions of the hyperprior (i.e. modules 1603, 1605, 1607, 1608, 1609). In turn, entropy decoding unit 504 of FIG. 5 may perform the function of decoder 1604 of FIG. 16 by dividing of encoded picture data 21 (input tensor) into tiles, along with parsing the indications for the tiles sizes or positions etc. from the bitstream as syntax element 566. Entropy decoding unit 504 may further implement the of the hyperprior (i.e. modules 1606, 1607, 1610). The post filtering 1611 of FIG. 16 may be performed, for example, also by entropy decoding unit 504. Alternatively, post-filer 1611 may be implemented within the mode application unit 560 as additional unit (not shown in FIG. 5).

### Second Embodiment

In the previous exemplary implementation of the FIRST EMBODIMENT, the tiles of the first plurality of tiles and/or of the second plurality of tiles are processed by a first and second subnetwork respectively, as discussed before. Here, the encoding and decoding processing of components in multiple pipelines is discussed, where each pipeline processes one or more picture/image components, which can be color planes. As may be discerned from the following discussion below, the FIRST and SECOND EMBODIMENT partly share similar or same processing.

In this exemplary and non-limiting embodiment, a method is provided for processing an input tensor representing picture data. The input tensor can have a matrix form with width=w, height=h, and a third dimension (e.g. depth or number of channels) whose size is equal to D. Further, the input tensor may be processed by a neural network. In the method, a plurality of components of the input tensor are processed, with said components including a first component and a second component in spatial dimensions. The input tensor is a picture or a sequence of pictures including one or more components, among the plurality of components, at least one of which is a color component. In an implementation, the first component represents luma component of the picture data; and the second component represents a chroma component of the picture data. For example, the plurality of components of the input tensor may be in YUV format, with Y being the luma component and UV being chroma components. The luma component may be referred to as primary component, and the chorma components may be referred to as secondary components. It is noted that the terms “primary” and “secondary” are labels for putting more weight and/or importance on the primary component than on the secondary component(s). As is clear for a skilled person, even though the luma component is typically the component with higher importance, there may be instances of applications where another component different from luma is prioritized. Said prioritizing often comes with using information on the primary component (e.g. luma) as auxiliary information to process the secondary component (i.e. less important than luma). The plurality of components may be also in RGB format or any other format suitable for processing components in a respective processing pipeline. The method comprises processing the first component including dividing the first component in the spatial dimensions into a first plurality of tiles and processing the tiles of the first plurality of tiles separately; and processing the second component including dividing the second component in the spatial dimensions into a second plurality of tiles and processing the tiles of the second plurality of tiles separately. It is noted that separately does not mean independently, i.e. there may still be auxiliary information being shared to process the first and/or second component. Examples of tiles with rectangular shape are shown in FIG. 14, 17A, 17B, and 18 to 20. In the method, at least two respective collocated tiles of the first plurality of tiles and the second plurality of tiles differ in size. In other words, the tiles of the first plurality of tiles and the second plurality of tiles have different sizes. As to the sizes of tiles in the respective plurality of tiles, the sizes of all tiles in the first plurality of tiles is same and/or sizes of all tiles in the second plurality of tiles is same. Hence, the respective pipelines process tiles having the same sizes, which are different among the pipelines. In particular, Y and UV can have different block partitioning, which is different from VVC. Tiles are introduced to solve memory issue and may contain multiple blocks. Tiles are coded independently from each other and can be decoded in parallel. Blocks are part of tile/picture/slice, where each block uses its own way of coding, and decoding is sequential, so that coding tree (block structure) is needed for better local adaptation. In other words, in this exemplary and non-limiting embodiment, separate chroma codetrees may be used.

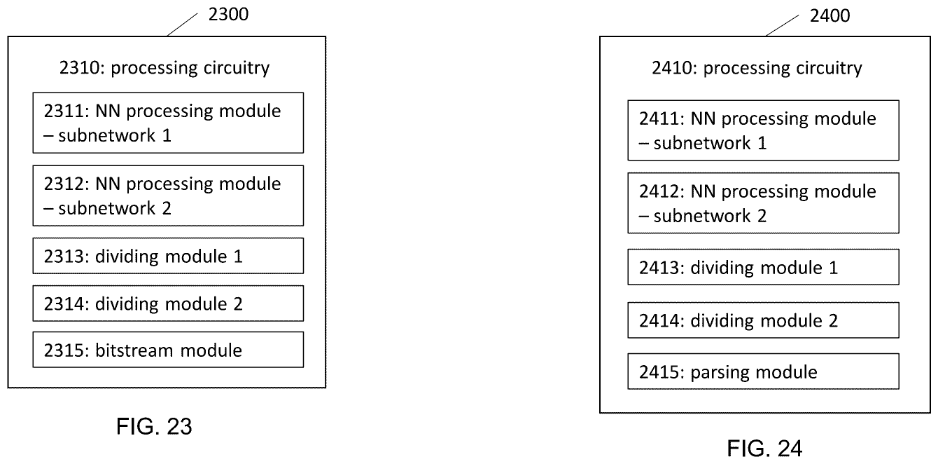

In an implementation, at least two tiles of the first plurality of tiles are processed independently or in parallel; and/or at least two tiles of the second plurality of tiles are processed independently or in parallel. FIG. 25 shows an example of an encoder-decoder processing for the case of the first component being luma and the second component being one of chroma U or V, which are processed in separate pipelines. It is noted that the chroma components U and V may be processed jointly as one chroma component, as depicted in FIG. 25. In an exemplary implementation, the processing of the input tensor includes processing that is part of picture or moving picture compression. For example, the processing of the first component and/or the second component includes one of: picture encoding by a neural network; and rate distortion optimization quantization, RDOQ; and picture filtering. The compression processing is depicted in FIG. 25 by the respective modules encoder 2501, 2508 and RDOQ 2502, 2509. Encoder 2501 and 2508 perform picture encoding of input picture x by a neural network (NN) for the luma Y and chroma component(s) UV. Modules RDOQ 2502 and 2509 quantize the feature tensor y by optimizing the rate distortion, and provide as output a quantized feature tensor ŷ for their respective component(s). The modules hyper encoder 2503, 2510 and RDOQ 2504, 2511 form parts of a hyperior network on the encoding side, which generate statistical information 2 of the picture data. Further, a bitstream is generated by including an output of the processing of the first component and the second component into the bitstream. In the example of FIG. 25, the quantized feature tensor y of the first (luma) and second (chroma) component is arithmetically encoded 1605, and included into bitstream Bitstream Y1 and Bitstream UV1, respectively. Likewise, the quantized statistical information 2 of the luma and chroma are arithmetically encoded 1609, and included into bitream Bitstream Y2 and Bitstream UV2, respectively. In the example of FIG. 25, two bitstreams are generated, allowing for decoupling encoded picture data from encoded statistics of said picture data.

Another exemplary implementation, the processing of the input tensor includes processing that is part of picture or moving picture decompression. For example, the processing of the first component and/or the second component includes one of: picture decoding by a neural network; and picture filtering. The decompression processing is depicted in FIG. 25 by the respective modules decoder 2506, 2513 and post filter 2507, 2514. Decoder 2506 and 2513 perform picture decoding of input picture x by a neural network (NN) for the luma Y and chroma component(s) UV by decoding quantized feature tensor ŷ for the luma and chroma component(s) from the respective bitsream Bitstream Y1 and Bitstream UV1. As noted above, the hyperior entails also modules for decoding, including hyper decoder 2505, 2512 which decode quantized statistical information 2 of the picture data from the bitstream Bitstream Y2 and Bitstream UV2 for the luma and chorma components. This information is input into arithmetic decoder 1606, whose output is provided to decoder 2505 and 2513. In an implementation example, the processing of the first component and/or the second component includes picture post-filtering. As FIG. 25 illustrates, the decoder outputs are input to post filter 2507 and 2514, which perform post filtering of the picture of the components and provide as output the reconstructed picture data \hat{x} for the reconstructed luma Ŷ and chroma(s) Û\hat{V}, respectively. The functional block (modules) shown in FIG. 25 resemble the same structural arrangement of the respective modules of the VAE encoder-decoder shown in FIG. 16 of the FIRST EMBODIMENT.

In the example of FIG. 25, the input tensor is YUV which has Y, U, and V as the plurality of components. In particular, the first component here is luma Y which is inout to encoder 2501 of the luma pipeline. Likewise, as mentioned above, U and V may be considered jointly as the second component, which is input into encoder 2508 of the chroma pipeline. It is noted that different reference signs have been assigned to the respective function modules (units) of the VAE encoder-decoder of the luma and chroma pipeline, since the modules may be configured differently such that processing of the respective tiles having different sizes for the luma and chroma pipeline may be enabled. Yet, the modules (e.g. encoder 2501 and encoder 2508) may perform same/similar functions in terms of encoding, RDOQ, decoding, post filtering etc. Said functions are the same as the ones performed by the respective modules of the VAE encoder-decoder of FIG. 16, and have been already described above. In an implementation, the processing of the second component includes decoding of a chroma component of the picture based on a representation of a luma component of the picture. This is illustrated in FIG. 25, where the luma component is the primary component and hence considered to have more importance than the chroma component UV. As shown, in the decoding processing of the luma and chroma, the luma feature tensor ŷ is obtained by arithmetic decoding 1606 from luma bitstream Bitstream Y1, which is used as input for decoder 2513 for decoding the UV components.

Similar to the FIRST EMBODIMENT, tiles of the first plurality of tiles that are adjacent in at least one dimension of the spatial dimensions partly overlap; and/or tiles of the second plurality of tiles that are adjacent in at least one dimension of the spatial dimensions partly overlap. Examples of adjacent tiles, which may be partly overlap has been discussed above with reference to FIGS. 17A, 17B, and 18 to 20. In an exemplary implementation, said dividing of the first component includes determining sizes of tiles in the first plurality of tiles based on a first predefined condition; and/or said dividing of the second component includes determining sizes of tiles in the second plurality of tiles based on a second predefined condition. For example, the first predefined condition and/or the second predefined condition is based on available decoder hardware resources and/or motion present in the picture data. A first and/or predefined condition may be memory resources of the decoder and/or encoder. When the available memory is lower than a predefined value of memory resources, the determined tile sizes may be smaller than tiles sizes when the available memory is equal to or larger than said predefined value. Alternatively or in addition, when the presence of motion may be pronounced, the tiles sizes may be determined to be smaller as to when said presence of motion is less pronounced. Whether a motion is pronounced (i.e. fast motion and/or fast/frequent motion changes), may be determined by respective motion vector(s) in terms of changes of its magnitude and direction, and compared to corresponding predefined values (thresholds) for magnitude and/or direction and/or frequency. In addition, another predefined condition may be region of interest (ROI), where the tile sizes may be determined to be small in case ROI size is smaller than a ROI reference size. For example, a ROI within the picture data may be based on detected objects (e.g. vehicles, bikes, motor cycles, pedestrians, animals etc.) which may have a different size, move fast or slowly, and/or alter their direction of motion fast or slowly and/or many times (i.e. more frequent with reference to a predefined value of frequency). A ROI may be further based on a degree of smoothness of a region within the picture data. For example, tiles sizes may be large for regions having a large degree of smoothness (e.g. measured with respect to a predefined value of smoothness), whiles small tile sizes may be used for regions being less smooth, i.e. regions having strongly pronounced e.g. spatial variations. In other words, the tile sizes may be determined based on the degree of texture of a region within the picture data. Moreover, larger tile sizes may be determined for the primary component, such as for luma for example. In turn, smaller tile sizes may be determined for secondary component(s) such as chroma(s). Hence, the tile sizes may be optimized to hardware resources jointly with content of the picture data, including scene-specific tile sizes. In a further implementation, said determining the sizes of tiles in the second plurality of tiles includes scaling the tiles of the first plurality of tiles. In other words, the tiles sizes of the first component are used as a reference, so as to derive the tiles sizes of the second component by scaling the tile sizes of the first component. The scaling may include enlarging (scaling up) such that the scaled tiles of the second plurality of tiles is larger than the sizes of the first plurality of tiles. Alternatively, scaling may include reducing (scaling down) such that the scaled tiles of the second plurality of tiles is smaller than the sizes of the first plurality of tiles. Whether scaling up or scaling down is used may depend on the importance of the first and/or second component. If at least one of the plurality of components being processed has at least one color component, the use of up or down scaling may depend on the specific color as well (e.g. a color component indicating “DANGER/WARNING” or the like).

Information of tiles sizes may be signaled and decoded from the bitstream in the following, various aspects of signaling and decoding of tile sizes and/or other suitable parameters are discussed. In an exemplary implementation, an indication of the determined sizes of tiles in the first plurality of tiles and/or in the second plurality of tiles is encoded into a bitstream. Moreover, the indication further includes positions of the tiles in the first plurality of tiles and/or in the second plurality of tiles. For example, the first component is a luma component and the indication of the sizes of the tiles of the first plurality of tiles is included in the bitstream; and the second component is chroma component and the indication of a scaling factor is included in the bitstream, wherein the scaling factor relates the sizes of the tiles of the first plurality of tiles and the sizes of the tiles of the second plurality of tiles.

Examples of signaling tile sizes and/or positions of the tiles for the components is shown in the tables below, with excerpts of code syntax to realize the signaling. The syntax tables are examples and may not be limited to this specific syntax. In particular, the syntax examples are for illustrative purposes as they may apply for signaling of respective indications for tiles sizes and/or tile positions etc. for luma and/or chroma components being included into the bitstream. The first syntax table refers to the autodecoder, while the second table refers to the post-filter. As evident from Table 1 and 2, same/similar indications may be used and included into the bitstream, but may be included separately for their use in the autodecoder (Table 1) and post filter (Table 2). In an implementation, for at least two tiles of the first plurality of tiles one or more parameters of post-filtering differ and are extracted from said bitstream; and for at least two tiles of the second plurality of tiles one or more parameters of post-filtering differ and are extracted from said bitstream. In other words, different tile-based post filter parameters may be signaled in the bitstream, and hence perform post filtering of tiles of each first and/or second plurality of tiles may be performed with high accuracy.

In the following, examples are discussed for parts of the modules of the encoder-decoder VAE of FIG. 25, and how the modules use the respective indication(s) referring to Table 1 and 2.

TABLE 1
Codeline

| | | | | Descriptor |
|---|---|---|---|---|
| tile_description_autodecoder ( ) { | | | | |
| | tiles_enabled_for_luma | | | u(1) |
| | tiles_enabled_for_chroma | | | u(1) |
| | if(tiles_enabled_for_luma \|\| | | | |
| | tiles_enabled_for_chroma) { | | | |
| | | tile_description_type | | u(2) |
| | } | | | |
| | if(tiles_enabled_for_luma && | | | |
| | tiles_enabled_for_chroma) { | | | |
| | | use_dependend_chroma_tiles | | u(1) |
| | } | | | |
| | if(tiles_enabled_for_luma) { | | | |
| | | if(tile_description_type == 0) { // defined | | |
| | | per level | | |
| | | | if( level == 0 ) { // level is defined | |
| in HLS parsed before tile_description | | | | |
| | | | // not coded, inferred by level, | |
| | | | for example | |
| | | | // tile_width_luma = 128 | |
| | | | // tile_height_luma = 128 | |
| | | | // tile_overlap_horizontal_luma = 32 | |
| | | | // tile_overlap_vertical_luma = 32 | |
| | | | } | |
| | | | if( level == 1 ) { // level is defined | |
| in HLS parsed before tile_description | | | | |
| | | | // not coded, inferred by level, | |
| | | | for example | |
| | | | // tile_width_luma = 256 | |
| | | | // tile_height_luma = 256 | |
| | | | // tile_overlap_horizontal_luma = 48 | |
| | | | // tile_overlap_vertical_luma = 48 | |
| | | | } | |
| | | | ... // other levels | |
| | | } | | |
| | | if(tile_description_type == 1) { // define | | |
| | | tile grid size manually | | |
| | | | tile_width_luma | ue(v) |
| | | | tile_height_luma | ue(v) |
| | | | tile_overlap_horizontal_luma | ue(v) |
| | | | tile_overlap_vertical_luma | ue(v) |
| | | } | | |
| | | if(tile_description_type == 2) { // defined | | |
| | | manually per tile | | |
| | | | num_luma_tiles | ue(v) |
| | | | for( i = 0; i< num_luma_tiles; | |
| | | | i++) { | |
| | | | tile_start_x[i] | ue(v) |
| | | | tile_start_y[i] | ue(v) |
| | | | tile_width[i] | ue(v) |
| | | | tile_height[i] | ue(v) |
| | | | // here overlaps can be inferred | |
| from the tile positions and sizes | | | | |
| | } | } | } | |

| | |
|---|---|
| if( | tiles_enabled_for_chroma) { |

| | |
|---|---|
| if( | !use_dependend_chroma_tiles) { |
| | // similar as for luma above |

}
else {

// chroma tiles are inferred from
chroma tiles
// for example for YUV444 they
could be the same, while

| | |
|---|---|
| for | YUV420 all sizes are |

| | |
|---|---|
| // divided by 2 | |
| chroma_tile_scaling_factor | ue(v) |

| | | |
|---|---|---|
| } | } | } |

TABLE 2
Codeline

| | | | | | Descriptor |
|---|---|---|---|---|---|
| tile_description_postfilter( ) { | | | | | |
| | tiles_enabled_for_luma | | | | u(1) |
| | tiles_enabled_for_chroma_U | | | | u(1) |
| | tiles_enabled_for_chroma_V | | | | u(1) |
| | if(tiles_enabled_for_luma \|\| | | | | |
| | tiles_enabled_for_chroma_U \|\| | | | | |
| tiles_enabled_for_chroma_V) { | | | | | |
| | | tile_description_type | | | u(2) |
| | } | | | | |
| | if(tiles_enabled_for_luma && | | | | |
| | (tiles_enabled_for_chroma_U \|\| | | | | |
| tiles_enabled_for_chroma_V)) { | | | | | |
| | | use_dependend_chroma_tiles | | | u(1) |
| | } | | | | |
| | if(tiles_enabled_for_luma) { | | | | |
| | | if(tile_description_type == 0) { // | | | |
| | | defined per level | | | |
| | | | if( level == 0 ) { // level is defined | | |
| in HLS parsed before tile_description | | | | | |
| | | | | // not coded, inferred by level, | |
| | | | | for example | |
| | | | | // tile_width_luma = 128 | |
| | | | | // tile_height_luma = 128 | |
| | | | | // tile_overlap_horizontal_luma = 32 | |
| | | | | // tile_overlap_vertical_luma = 32 | |
| | | | } | | |
| | | | if( level == 1 ) { // level is defined | | |
| in HLS parsed before tile_description | | | | | |
| | | | | // not coded, inferred by level, | |
| | | | | for example | |
| | | | | // tile_width_luma = 256 | |
| | | | | // tile_height_luma = 256 | |
| | | | | // tile_overlap_horizontal_luma = 48 | |
| | | | | // tile_overlap_vertical_luma = 48 | |
| | | | } | | |
| | | | ... // other levels | | |
| | | } | | | |
| | | if(tile_description_type == 1) { // define | | | |
| | | tile grid size manually | | | |
| | | | | tile_width_luma | ue(v) |
| | | | | tile_height_luma | ue(v) |
| | | | | tile_overlap_horizontal_luma | ue(v) |
| | | | | tile_overlap_vertical_luma | ue(v) |
| | | } | | | |
| | | if(tile_description_type == 2) { // defined | | | |
| | | manually per tile | | | |
| | | | num_luma_tiles | | ue(v) |
| | | | for( i = 0; i< num_luma_tiles; i++) { | | |
| | | | | tile_start_x[i] | ue(v) |
| | | | | tile_start_y[i] | ue(v) |
| | | | | tile_width[i] | ue(v) |
| | | | | tile_height[i] | ue(v) |
| | | | | // here overlaps can be | |
| inferred from the tile positions and sizes | | | | | |
| | | } | } | | |
| | | if(tile_description_type == 3) { | | | |
| | // same tile map as the one signaled for decoder, | | | | |
| | copy/use it | | | | |
| | } | } | | | |
| | ... | | | | |
| | ... | | | | |
| | if( | tiles_enabled_for_chroma_U) { | | | |
| | | if( | !use_dependend_chroma_tiles) { | | |
| | | | // similar as for luma above | | |
| | | } | | | |
| | | else { | | | |
| | | | // chroma tiles are inferred from | | |
| | | | chroma tiles | | |
| | | | // for example for YUV444 they | | |
| | | | could be the same, while | | |
| for | | YUV420 all sizes are | | | |
| | | | // divided by 2 | | |
| | } | } | | | |
| | if( | tiles_enabled_for_chroma_V) { | | | |
| | | // similar as for tiles_enabled_for_chroma_U | | | |
| | } | | | | |
| | // model modes per tile | | | | |
| | if( | tiles_enabled_for_luma) { | | | |
| | | same_model_for_all_luma | | | u(1) |
| | | if( same_model_for_all_luma ) { | | | |
| | | | model_idx_luma | | ue(v) |
| | | } | | | |
| | | else { | | | |
| | | | use_default_model_for_luma | | u(1) |
| | | | if(use_default_model_for_luma) { | | |
| | | | | default_model_idx_luma | ue(v) |
| | | | | for( i = 0; i<num_luma_tiles; | |
| | | | | i++) { | |
| | | | | // num_luma_tiles can | |
| be inferred from above signaling | | | | | |
| | | | | use_default_idx[i] | u(1) |
| | | | | if(!use_default_idx[i]) { | |
| | | | | model_idx_luma[i] | ue(v) |
| | | | } | }} | |
| | | | else { | | |
| | | | | for( i = 0; i<num_luma_tiles; i++) { | |
| | | | | // num_luma_tiles can be inferred from | |
| above signaling | | | | | |
| | | | | model_idx_luma[i] | ue(v) |
| | } | } | } | } | |

| if( | tiles_enabled_for_chroma_U) { |
|---|---|
| | // similar as for tiles_enabled_for_luma |
| } | |
| if( | tiles_enabled_for_chroma_V) { |
| | // similar as for tiles_enabled_for_luma |

| | |
|---|---|
| } | } |

### A. Decoder

In this implementation example, luma and chroma are decoded separately, as has been explained above with reference to FIG. 25 showing separate pipelines for decoding processing luma and chroma(s) components. However, as depicted by the dashed line pointing from arithmetic decoder 1606 of the luma pipeline to decoder 2513 of the chroma pipeline, decoding of the chroma component requires both chroma and luma latent space (i.e. CCS).

### Deriving of the Tile Map:

Several ways for obtaining the tile map are possible, as illustrated in Table 1:
1. A tile map is signaled explicitly only for the primary component. Other components use the same tile map (for YUV420 and CCS primary component would be luma/Y and the other component would be chroma/UV). Using the same tile map includes using the same tile map in a literal manner. In an implementation, the same tile map (e.g. of the luma component) is used to derive a tile map for the secondary component (e.g. chroma(s) UV) by scaling tile sizes of the luma components. For that purpose, an indication of a scaling factor is included into the bitstream. In Table 1, such scaling factor is “chroma_tile_scaling_factor”
2. A tile map is signaled explicitly for each component of the image.

In the signaling example of Table 1, whether or not tiles of each component is signaled, depends on the indication “tiles_enabled_for_chroma” and “tiles_enabled_for_luma”. Said indication may by a simple flag “0” or “1” indicating enabling turned OFF or ON.

When a tile map is signaled explicitly, this could be done in one of the following ways:
1. A regular grid of tiles with the same size (except at bottom and right boundaries) is used. An offset and a size value are signaled, from which the tile map can be derived (see below). In this case, the tiles of the first component (luma) have the same size, where the tile sizes is defined in terms of a width and height when the tile is rectangular. The respective indication of the tile sizes is “tile_width_luma” and “tile_height_luma” in Table 1. A similar indication for same tile sizes of chroma may be used, except that the chroma tiles sizes are different from the luma tile sizes.
2. A regular grid of tiles with the same size (except at bottom and right boundaries) is used. An offset and a size value are used, but not signaled directly. Instead size and offset value are derived from an already decoded level definition. The tile map can be derived from the size and offset value (see below).
3. An arbitrary grid of tiles is used. First the number of tiles is signaled, then for each tile its position and size are signaled (overlaps would implicitly be included in this signaling). In Table 1, the arbitrary grid is reflected in that, for a predefined number of luma tiles “num_luma_tiles”, each tile may have an individual size in terms of “tile_width [i]” and “tile_height [i]”. Further, an indication for tile positions (here start positions) is included also into the bitstream, with indication for tile positions being “tile_start_x [i]” and “tile_start_y [i]”. In the example, the tiles are in the 2D x-y space.
If chroma signaling is enabled, and the chroma component is independently processed from the luma component (Table 1: “!use_dependent_chroma_tiles”, i.e. the chroma tile do not depend on the luma tiles), a similar signaling with respective indications included into the bitstream are used.

Further indications for the overlap of tiles of the luma and/or chroma components may be included into the bitstream, and hence signaled to the decoder.

If the tile map is signaled via values (in signal space sizes/coordinates) for tile size (tile width equals height) and overlap, the N overlapping regions are derived as follows:

```
for tile_start_y in range(0, image_height − overlap,
tile_height − overlap):
  for tile_start_x in range(0, image_width − overlap,
  tile_width − overlap):
    height = min(tile_height, image_height − tile_start_y)
    width = min(tile_width, image_width − tile_start_x)
    im_tileᵢ = (tile_start_x, tile_start_y, width, height)
```

### Decoding of the Luma Component:

There are N overlapping regions (tiles) in the image. Each tile (im_tileᵢ) has a corresponding tile in the latent space (lat_tileᵢ). Further, im_tileᵢ covers only a subset of the total receptive field of lat_tileᵢ. For each im_tile in singal space, a matching lat_tile in the latent space is derived as follows. Here, alignment_size is a power of 2, which depends on the number of downsampling layers in the subnetwork:

```
image_tile = im_tileᵢ
lat_tile_start_y = image_tile.position.y // alignment_size
lat_tile_start_x = image_tile.position.x // alignment_size
if image_tile.size.height % alignment_size:
  height = math.ceil(image_tile.size.height / alignment_size)
else:
  height = image_tile.size.height // alignment_size
if image_tile.size.width % alignment_size:
  width = math.ceil(image_tile.size.width / alignment_size)
else:
  width = image_tile.size.width // alignment_size
lat_tileᵢ = (lat_tile_start_x, lat_tile_start_y, width, height)
```

Using lat_tile, the corresponding region of the latent space is extracted and processed by the decoder subnetwork. The decoder subnetwork also has the im_tile as auxiliary input, which is required in order to do the padding correctly, in particular at image borders, where the size of tile may not be multiple of the alignment_size. The output of the decoder is assigned to the region of the image specified by im_tile. This step can contain a cropping operation to remove the part of the reconstruction that would overlap with the reconstruction of another tile.

The need for cropping of regions R1 to R4 for processed tiles L1 to L4 has been discussed with reference to FIG. 17A and FIG. 18 to ensure seamless merging.

### Decoding of the Chroma Component:

There are N overlapping regions (tiles) in the image. In the examples shown in FIGS. 17A and 18, there are four tiles partly overlapping. Each tile (im_tileᵢ) has a corresponding tile in the latent space (lat_tileᵢ). Further, im_tileᵢ covers only a subset of the total receptive field of lat_tileᵢ. The N overlapping regions are derived based on signaled parameters for the tile size and tile overlap (tile width equals height). The sizes are signaled in signal space units (i.e. not latent space). Then the tile positions and sizes in signal space are derived as follows:

```
for tile_start_y in range(0, image_height − overlap,
tile_height − overlap):
  for tile_start_x in range(0, image_width − overlap,
  tile_width − overlap):
    height = min(tile_height, image_height − tile_start_y)
    width = min(tile_width, image_width − tile_start_x)
    im_tileᵢ = (tile_start_x, tile_start_y, width, height)
```

For each im_tile in singal space a matching lat_tile in latent space is derived as follows. Here, alignment_size is a power of 2, which depends on the number of downsampling layers in the subnetwork:

```
image_tile = im_tileᵢ
lat_tile_start_y = image_tile.position.y // alignment_size
lat_tile_start_x = image_tile.position.x // alignment_size
if image_tile.size.height % alignment_size:
  height = math.ceil(image_tile.size.height / alignment_size)
else:
  height = image_tile.size.height // alignment_size
if image_tile.size.width % alignment_size:
  width = math.ceil(image_tile.size.width / alignment_size)
else:
  width = image_tile.size.width // alignment_size
lat_tileᵢ = (lat_tile_start_x, lat_tile_start_y, width, height)
```

Using lat_tile, the corresponding region of the chroma latent space lat_UV is extracted. Further, the corresponding region of the luma latent space lat_Y is determined. For the example of YUV420, a possible way of doing this is downsampling the luma latent space by a factor of 2 followed by using the same lat_tile as for chroma to extract lat_Y. Both lat_Y and lat_UV are then processed by the decoder subnetwork. The decoder subnetwork has also the im_tile as auxiliary input, which is required in order to do the padding correctly, in particular at image borders, where the size of tile may not be multiple of the alignment_size. The output of the decoder is assigned to the region of the image specified by im_tile. This step can contain a cropping operation, to remove the part of the reconstruction that would overlap with the reconstruction of another tile.

### B. Post-Processing Filter:

### Deriving of the Tile Map:

Several ways for obtaining the tile map are possible, as illustrated in Table 2:
1. The same tile map as for the decoder is used. For the example of YUV420, this could be implemented such that, for filtering the Y component the same tiles are used as for luma/Y in the decoder, while for U and V the same tiles are used as used by decoder for chroma (UV). Such behaviour could be signaled with a single flag.
2. A tile map is signaled explicitly only for the primary component (e.g. luma component). Other components (e.g. chroma component(s)) use the same tile map. As shown in Table 2, the signaling of the tile map (i.e. tile size, position, and overlap) may be done in a similar manner as in Table 1 for the autodecoder.
3. A tile map is signaled explicitly for each component of the image. Again, the signaling of a tile map for each component may be done by use of same indications included into the bitstream as of Table 1.

Please note that, when filter selection uses multi-scale structural similarity (MS-SSIM) as distortion criterion (encoder), the tiles should be large enough for MS-SSIM (it includes some downsampling steps). If the tiles at bottom and right image boundary are too small, they are enlarged by taking areas away from their respective neighbor regions, i.e. regions which are adjacent. Since the decoder has to perform the same processing, this would be normative. When MSE and/or peak signal noise ratio (PSNR) is used as distortion criterion, there is no issue regarding tiles sizes possibly being too small.

When a tile map is signaled explicitly this could be done in one of the following ways:
1. A regular grid of tiles with the same size (except at bottom and right boundaries) is used. An offset and a size value are signaled, from which the tile map can be derived (see discussion follows).
2. A regular grid of tiles with the same size (except at bottom and right boundaries) is used. An offset and a size value are used, but not signaled directly. Instead, size and offset value are derived from an already decoded level definition. The tile map can be derived from the size and offset value (see discussion follows).
3. An arbitrary grid of tiles is used. First the number of tiles is signaled, then for each tile its position and size are signaled (overlaps would implicitly be included in this signaling).

### Deriving of the Used Filter Per Tile:

In a particular image component for a tiler, a filter specified by the filter index filter is used. In other words, the tile-based filter may be specified in terms of one parameter, i.e. the filter index. The selection of the filter for each tile can be signaled via one of the following ways, as illustrated in Table 2:
1. The same model/filter is used for all tiles of the image component. This can be signaled with a single flag along with the filter index filter. In Table 2, such flag is “same model for all luma” with the filter index being “model_idx luma”.
2. The model of the filter is signaled per tile of the image component.
   a. A default filter index is signaled. In Table 2, such default index is “default_model idx luma”. For each tiler (number of tiles is already known from the tile map), a flag is signaled to indicate whether the filter index differs from the default. In Table 2, such as flag for each tile is “use_default_idx [i]” with index “i” labeling the respective tile within the first or second plurality of tiles. If it differs, the filter index filter for the tile is signaled. In Table 2, the respective filter index is “model_idx luma [i]”. In other words, one or more parameters of the filter differ for at least two tiles of the first plurality of tiles. Similar applies for the one or more parameters regarding the second plurality of tiles.
   b. For each tiler (number of tiles is already known from the tile map), the filter index filter for the tile is signaled. In Table 2, the respective filter index is “model_idx_luma [i]”.

The filter indices for each component may be signaled explicitly as well. Alternatively, the filter indices for a component may be derived from those filter indices signaled for another component, e.g. the luma component.

When the selected model of the filter is signaled, the post filer may use the same tile map as of the one used by the decoder. This may reduce the overhead for signaling tile sizes.

### Filtering of a Component:

There are N overlapping regions (tiles) in the image. Each tile is processed independently (possibly in parallel). For a tiler, its position, size, overlap and the used filter index are known from the signaling described above. The reconstructed region is extracted from the reconstructed image based on the values for position and size. Then, a filtering based on the filter index is performed on this region. The output is cropped using the values of position, size and overlap, and is assigned to the filtered output image at the location described by the values of position and size.

### C. RDOQ

In this implementation, RDOQ is applied separately for luma and chroma components, i.e. the latent space for each component luma and chroma is optimized separately. FIG. 25 shows the respective RDOQ processing of the luma Y and chroma(s) UV in their separate pipelines by RDOQ modules 2502 and 2509, respectively. However, decoding of the chroma component requires both chroma and luma latent space (i.e. CCS). Hence, processing by RDOQ 2502 is first performed for luma, obtaining a new, optimized luma latent ŷ. The luma latent is then kept fixed and is used as additional input (i.e. as auxiliary information) to the optimization of the chroma latent space. in FIG. 25, this is depicted by the dashed line.

If the same tile map is used for luma and chroma in the RDOQ process, the optimization of the chroma component does not have to wait until the luma RDOQ optimization was done for all luma tiles. Instead, once optimization for a particular luma tile is finished, in can be directly be used as input for the optimization of the corresponding chroma latent tile.

### Deriving of the Tile Map:

Since RDOQ is an encoder-only process, the used tiles do not have to be signaled. In this implementation, a regular tile grids was used for the luma and chroma components. Each grid is described by an offset and a size value (encoder arguments). Using these, the tile map for a component can be derived (see follows).

### Optimization of the Luma Component:

RDOQ iteratively optimizes the cost for a tile given by:

cost=R+λD

Here, R is an estimate of the number of bits required to encode the tile, while D is a metric (such as peak-signal noise ratio (PSNR), multi-scale structural similarity (MS-SSIM), . . . ) for the distortion of the reconstruction (of the tile) compared to the original. λ is a parameter set according to the operation point of the encoder. R and D for an im_tileᵢ are obtained as follows:

There are N overlapping regions (tiles) in the image. Each tile (im_tileᵢ) has a corresponding tile in the latent space (lat_tileᵢ). Further, im_tileᵢ covers only a subset of the total receptive field of lat_tileᵢ. For each im_tile in signal space, a respective matching lat_tile in latent space is derived as follows. Here, alignment_size is a power of 2, which depends on the number of downsampling layers in the subnetwork:

```
image_tile = im_tileᵢ
lat_tile_start_y = image_tile.position.y // alignment_size
lat_tile_start_x = image_tile.position.x // alignment_size
if image_tile.size.height % alignment_size:
  height = math.ceil(image_tile.size.height / alignment_size)
else:
  height = image_tile.size.height // alignment_size
if image_tile.size.width % alignment_size:
  width = math.ceil(image_tile.size.width / alignment_size)
else:
  width = image_tile.size.width // alignment_size
lat_tileᵢ = (lat_tile_start_x, lat_tile_start_y, width, height)
```

Using lat_tile, the corresponding region of the latent space is extracted and processed by the decoder subnetwork to obtain a reconstructed tile. The decoder subnetwork has also the im_tile as auxiliary input, which is required in order to do the padding correctly, in particular at image borders, where the size of tile may not be multiple of the alignment_size. Using im_tile, the corresponding region is extracted from the original image. D can then be calculated as a function (such as peak-signal noise ratio (PSNR), multi-scale structural similarity (MS-SSIM), . . . ) of the original tile and the reconstructed tile. R is obtained by calling the encoding function for the extracted latent tile and measuring/estimating the amount of bits required to encode it. The RDOQ process is iterative, i.e. it is done repetively for a certain number of iterations (typically 10-30 iterations).

### Optimization of the Chroma Component:

RDOQ iteratively optimizes the cost for a tile given by:

cost=R+λD

Here, R is an estimate of the number of bit required to encode the tile, while D is a metric (such as peak-signal noise ratio (PSNR), multi-scale structural similarity (MS-SSIM), . . . ) for the distortion of the reconstruction (of the tile) compared to the original. λ is a parameter set according to the operation point of the encoder. In the proposed implementation, chroma is coded conditionally on luma. Hence, R includes here also the number of bits required to encode the corresponding luma tile:

R=Rₗᵤₘₐ+R_{chroma}

Rₗᵤₘₐ remains constant throughout the chroma RDOQ optimization process.

R_{chroma} and D for an im_tileᵢ are obtained as follows:

There are N overlapping regions (tiles) in the image. Each tile (im_tileᵢ) has a corresponding tile in the latent space (lat_tileᵢ). Further, im_tileᵢ covers only a subset of the total receptive field of lat_tileᵢ. For each im_tile in singal space a matching lat_tile in latent space is derived as follows. Here, alignment_size is a power of 2, which depends on the number of downsampling layers in the subnetwork:

```
image_tile = im_tileᵢ
lat_tile_start_y = image_tile.position.y // alignment_size
lat_tile_start_x = image_tile.position.x // alignment_size
if image_tile.size.height % alignment_size:
  height = math.ceil(image_tile.size.height / alignment_size)
else:
  height = image_tile.size.height // alignment_size
if image_tile.size.width % alignment_size:
  width = math.ceil(image_tile.size.width / alignment_size)
else:
  width = image_tile.size.width // alignment_size
lat_tileᵢ = (lat_tile_start_x, lat_tile_start_y, width, height)
```

Using lat_tile, the corresponding region of the chroma latent space lat_UV is extracted. Further, the corresponding region of the luma latent space lat_Y is determined. For the example of YUV420, a possible way of doing this is downsampling the luma latent space by a factor of 2 followed by using the same lat_tile as for chroma to extract lat_Y. Both lat_Y and lat_UV are then processed by the decoder subnetwork to obtain a reconstructed chroma tile. The decoder subnetwork also has the im_tile as auxiliary input, which is required in order to do the padding correctly, in particular at image borders, where the size of tile may not be multiple of the alignment_size. Using im_tile, the corresponding region is extracted from the original image. D can then be calculated as a function (such as peak-signal noise ratio (PSNR), multi-scale structural similarity (MS-SSIM), . . . ) of the original chroma tile and the reconstructed chroma tile. R_{chroma} is obtained by calling the encoding function for the extracted chroma latent tile and measuring/estimating the amount of bits required to encode it.

The RDOQ process is iterative, i.e. it is done repetively for a certain number of iterations (typically 10-30).

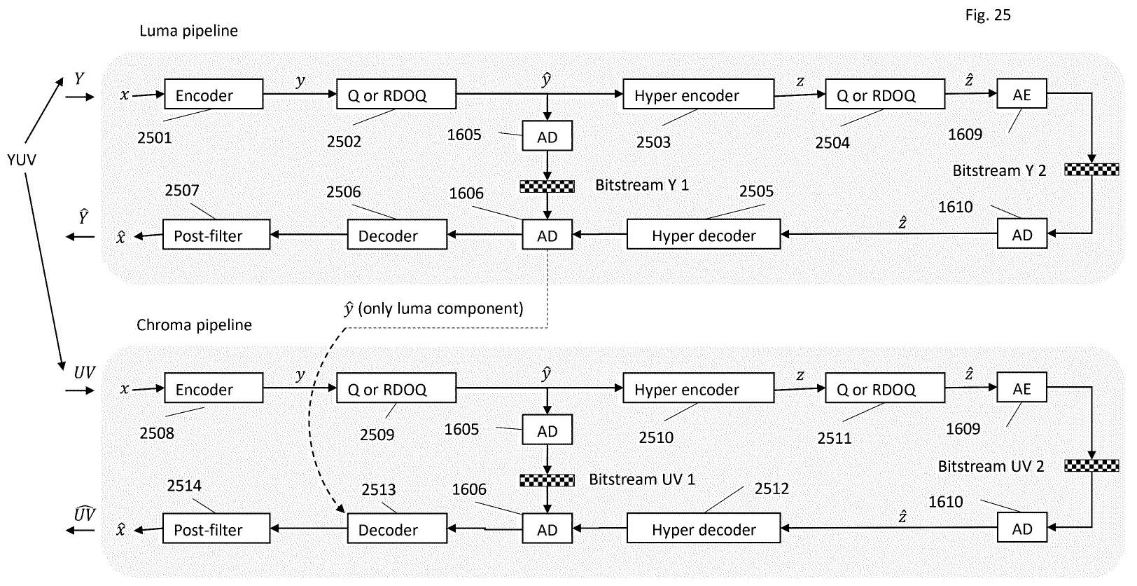

In this exemplary and non-limiting embodiment, provided is a computer program stored on a non-transitory medium comprising code which when executed on one or more processors performs steps of the method for processing an input tensor representing picture data discussed in the SECOND EMBODIMENT. The respective flowchart is shown in FIG. 26. In step S2610, a first component of an input tensor is processed including dividing the first component into a first plurality of tiles. Likewise, in step S2630, a second component of the input tensor is processed including dividing the second component into a second plurality of tiles. Each of the respective first and second plurality of tiles is then processed separately in steps S2620 and S2640. As the flowchart of FIG. 26 suggests, steps S2610 and S2620 are performed separately from the steps S2630 and S2640, reflecting the processing of the first and second component in two separate pipelines, as illustrated in FIG. 25 for the case of luma Y component (first component) and chroma component(s) UV (second component). The processing steps S2610 and/or S2630 of dividing the first and second tensor into a first and second plurality of tiles may be part of the encoding processing of encoder 2501 and/or encoder 2508. The further processing of the first and second plurality of tiles in a separate manner may include any of encoding, quantizing RDOQ, decoding, and post filtering, as performed by the respective modules shown in FIG. 25. At the end of the separate processing of the first and second plurality of tiles, a reconstructed first component and a reconstructed second component is provided. Said reconstructed components may be reconstructed picture data of the luma component y and of the chroma component(s) UV, as illustrated in FIG. 25. In the processing of FIG. 26, the dashed horizontal arrow indicates that the processing of the first and second plurality of tiles may interact in that, for example, auxiliary information from the processing of the first/second plurality of tiles may be used for the processing of the second/first plurality of tiles. As explained above in relation to FIG. 25, the processing of the UV chroma component(s) in the chroma pipeline may use information of the luma component of the processing of the luma pipeline as auxiliary information.

Moreover, as already mentioned, the present disclosure also provides devices (apparatus(es)) which are configured to perform the steps of the methods described for the

### Second Embodiment

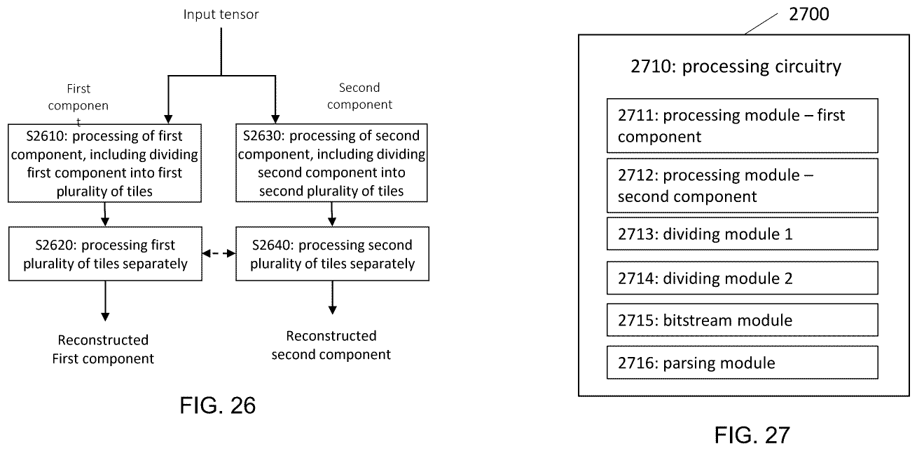

In this exemplary and non-limiting embodiment, an apparatus is provided for processing an input tensor representing picture data. FIG. 27 shows the apparatus 2700 comprising processing circuitry 2710 having respective modules to perform the method steps of FIG. 26. Module 2711 and 2712 are configured to perform processing of the first and second component, including processing of the respective first and second plurality of tiles. Further, two modules 2713 and 2714 are used for dividing the first and second component of the input tensor in the spatial dimensions into a first and second plurality of tiles, respectively. It is noted that, while FIG. 27 shows separate modules 2711 and 2712 and, respectively, modules 2713 and 2714, said modules may be combined into one module, but is configured that the first and second component are processed separately, including the separate processing of the first and second plurality of tiles to enable a pipeline-based processing of the respective components. In particular, modules 2711 and 2712 may provide functionalities of the individual modules shown in FIG. 25 for the respective pipeline, including encoder 2501 and 2508, quantizer RDOQ 2502 and 2509, decoder 2506 and 2513, and post filer 2507 and 2514. Further, the functionalities of the encoder-decoder hyperprior may be performed by the respective modules 2711 and 2712 for the respective pipeline. In FIG. 27, module 2715 performs processing including generating a bitstream Bitstream Y/UV 1 and Bitstream Y/UV 2, where also indications of the tile sizes of the first and/or second plurality of tiles may be included in the respective bitstream. Parsing module 2716 parses bitstreams Bitstream Y/UV 1 and Bitstream Y/UV 2, including extracting indication(s) of tiles sizes and/or positions from Bitstream Y/UV 1.

In this exemplary and non-limiting embodiment, an apparatus is provided for processing an input tensor representing picture data, the apparatus comprising: one or more processors; and a non-transitory computer-readable storage medium coupled to the one or more processors and storing programming for execution by the one or more processors, wherein the programming, when executed by the one or more processors, configures the apparatus to carry out the method discussed in the second embodiment.

### Further Details on Signaling

The indications for the tile sizes of the first and/or second plurality of tiles are included in the bitstream Bitstream Y/UV 1, as discussed above. This applies also for the indications for tile positions and/or tile overlap, and/or scaling and/or filter index etc. Alternatively, all or part of said indications may be included in side information. Said side information may then be included into the bitstream Bitstream 1 from which the decoder parses the side information to determine the tile sizes, positions etc. as needed for the decoding processing (decompression). For example, the indications related to tiles (e.g. tile sizes, position, and/or overlap) may be included in first side information. In turn, the indications related to scaling may be included in second side information, while the indications on the filter model (e.g. filter index etc.) may be included in third side information. In other words, the indications may be grouped and included in a group-specific side information (e.g. first to third side information). Thereby, group refers here to a group “tile”, “filter” or the like.

In the following, further details on signaling indications are provided for the example of tiles with reference to FIG. 20 illustrating some signaling examples on the decoder side. it is noted that same applies for the encoder side. FIG. 20 illustrates various parameters, such as the sizes of regions Li, Ri, and overlap regions etc., that may be included in (and parsed from) the bitstream. The regions Li refer to tiles of the first and/or second tensor which are processed (e.g. tiles of input tensor x of a component in FIG. 25) and regions Ri refer to corresponding tiles generated as output after processing of the tiles Li. For example, the tiles Ri may be the tiles of output y in FIG. 25 after processing of input tensor x.

For example, the side information includes an indication one or more of:
a number of the input sub-sets,
a size of the input set, i.e. the number of tiles (e.g. of luma and/or chroma components)
a size (h1, w1) of each of the two or more input sub-sets, i.e. the size of a tile to be processed,
a size (H, W) of the reconstructed picture (R),
a size (H1, W1) of each of the two or more output sub-set, i.e. the sizes of a tile after processing
an amount of overlap between the two or more input sub-sets (L1, L2), i.e. overlap between tiles to be processed
an amount of overlap between the two or more output sub-sets (R1, R2), i.e. overlap between tiles after processing.

Hence, the signaling of a variety of parameters through side information may be performed in a flexible manner. Accordingly, the signaling overhead may be adapted in dependence which of the above parameters are signaled in the side information, while other parameters are to be derived from those parameters being signaled. The size of each of the two or more input sub-sets may be different. Alternatively, input sub-sets may have a common size.

In one example, the position and/or the amount of the samples to be cropped is determined according to the size of the input sub-set indicated in the side information and a neural-network resizing parameter of the neural network specifying a relation between the size of the input to the network and size of the output from the network. Hence, the position and/or cropping amount may be determined more accurately by accounting for both the size of the input sub-set and characteristics of the neural network (i.e. its resizing parameter). Accordingly, the cropping amount and/or position may be adapted to properties of the neural network, which further improves the quality of the reconstructed picture data.

The resizing parameter may be an additive term, which is subtracted from the input size so as to obtain the output size. In other words, the output size of an output sub-set is related to its corresponding input sub-set by just an integer number. Alternatively, the resizing parameter may be a ratio. In this case, the size of the output sub-set is related to the size of the input sub-set by multiplying the size of the input sub-set by the ratio so as to obtain the size of the output sub-set.

As discussed above, the determination of Li, Ri, and the cropping amount can be obtained from a bitstream, according to predefined rules, or a combination of the two.
An indication indicating the amount of cropping can be included in (and parsed from) the bitstream. In this case, the cropping amount (i.e. overlap amount) is included in the side information.
The amount of cropping can be a fixed number. For example, such number may be pre-defined by a standard, or fixed once the relation between the size (dimensions) of the input and output are known.
The amount of cropping can be related to a cropping in horizontal direction, vertical direction, or both directions.

The cropping can be done according to a pre-configured rule. After the cropping amount is obtained, the cropping rule can be as follows:
According to the position of Ri in the output space (top-left, center, etc). Cropping can be applied on a side (top, left, bottom, or right), if that side of Ri does not coincide with the output boundary.

The sizes and/or coordinates of an Li (i.e. tile) can be included in the bitstream. Alternatively, the number of partitions can be indicated in the bitstream, and the sizes of each Li can be calculated based on the size of the input and the number of partitions.

The overlap amount of each input sub-set Li can be:
An indication indicating the amount of overlap can be included in (and parsed from or derived from) the bitstream.
The amount of overlap can be a fixed number. As mentioned above, “fixed” in this context means that it is known e.g. by a convention such as a standard or a proprietary configuration or pre-configured as a part of encoding parameters or parameters of the neural network.
The amount of overlap can be related to a cropping in a horizontal direction, vertical direction, or both directions.
The amount of overlap can be calculated based on the amount of cropping.

In the following, some numerical examples are provided to illustrate which parameters may be signaled via the side information included in the bitstream (and parsed therefrom), and how these signaled parameters are then used to derive the remaining parameters. These examples are merely exemplary and not limiting the present disclosure.

For example, in the bitstream the following information can be included related to signaling of Li:
Number of partitions in vertical axis=2. This corresponds to the examples of space L being divided vertically by 2 in FIG. 20.
Number of partitions in horizontal axis=2. This corresponds to the examples of space L being divided horizontally by 2 in FIG. 20.
Equal sized partition flag=True. This is exemplified in the figures by showing L1, L2, L3, and L4 with the same sizes.
Size of the input space L (wL=200, hL=200). The width w and the height h are measured in number of samples in these examples.
Overlap amount=10. The overlap is measured in number of samples in this example.

According to the information above, the sizes of the partitions can be obtained as w=(200/2+10)=110, h=(200/2+10)=110, since it is indicated that the overlap amount is 10 and partitions are equal-sized.

Furthermore, since the size of the partitions are (110, 110) and the number of partitions in each axis is 2, the top-left coordinates of the partitions can be obtained as:
top-left coordinate pertaining to the first partition, L1 (x=0,y=0),
top-left coordinate pertaining to the second partition, L2 (x=90,y=0),
top-left coordinate pertaining to the third partition, L3 (x=0,y=90),
top-left coordinate pertaining to the fourth partition, L4 (x=90,y=90).

The examples below exemplify different options of signaling all or some of the above parameters, which is illustrated with reference to FIG. 20. FIG. 20 shows how the various parameters related to the input subsets Li, the output sub-sets Ri, the input picture, and the reconstructed picture are linked.

It is noted that the above mentioned signaled parameters are not to limit the present disclosure. As is described below, there are many possible ways to signal information based on which the sizes of the input and output spaces as well as sub-spaces, cropping or padding, may be derived. Some further examples are presented below.

### First Signaling Example

FIG. 20 illustrates a first example where the following information is included into the bitstream:
Number of regions in the latent space (which corresponds to the input space at the decoder side), which is equal to 4.
The total size (height and width) of the latent space, which is equal to (h,w). (referred to as wL, hL above).
h1 and w1, used to derive the sizes of the regions (here the sizes of the four Li), i.e. input sub-sets.
Total size (H, W) of the reconstructed output R.
H1 and W1. H1 and W1 represent the size of the output sub-set.

In turn, the following information is predefined or predetermined:
The amount X of overlap between the regions Ri. For example, X determines also the cropping amount.
The amount of overlap y between the regions Li.

According to the information included in the bitstream and the information that are predetermined, the sizes of Li and Ri can be determined as follows:

$$L 1 = ( h 1 + y , w 1 + y )$$

$$L 2 = ( ( h - h 1 ) + y , w 1 + y )$$

$$L 3 = ( h 1 + y , ( w - w 1 ) + y )$$

$$L 4 = ( ( h - h 1 ) + y , ( w - w 1 ) + y )$$

$$R 1 = ( H 1 + X , W 1 + X )$$

$$R 2 = ( ( H - H 1 ) + X , W 1 + X )$$

$$R 3 = ( H 1 + X , ( W - W 1 ) + X )$$

$$R 4 = ( ( H - H 1 ) + X , ( W - W 1 ) + X ) .$$

As may be discerned from the first signaling example, the size (h1,w1) of input sub-set L1 is used to derive the respective sizes of all remaining input sub-sets L2 to L4. This is possible because the same overlap amount y is used for the input sub-sets L1 to L4 as shown in FIG. 20. In this case, only a few parameter need to be signaled. A similar argument applies to the output sub-sets R1 to R4, where only the signaling of the size (H1, W1) of output sub-set R1 is needed to derive the sizes of output sub-sets R2 to R4.

In the above, h1 and w1, and H1 and W1 are the coordinates in the middle of input and output spaces, respectively. Hence, in this first signaling example, single coordinates (h1,w1) and (H1,W1) are used to calculate the partitioning of the input and output spaces into 4, respectively. Alternatively, the sizes of more than one input subset and/or output sub-set may signaled.

In another example, it might be possible to calculate Ri from Li if one knows the structure of the NN that processes the Li, i.e. what will be the size of the output, if the size of the input is Li. In this case, the sizes (Hi, Wi) of the output sub-sets Ri may not be signaled through the side information. However, in some other implementations, since the determination of the size Ri might sometimes not be possible before one actually performs the NN operation, it might be desirable (as in this case) to signal the sizes Ri in the bitstream.

### Second Signaling Example

In the second example of the signaling includes determining H1 and W1 based on h1 and w1 according to a formula. The formula, for example, may read as follows:

$$H 1 = ( h 1 + y ) * scalar - X$$

$$W 1 = ( w 1 + y ) * scalar - X$$

wherein the scalar is a positive number. The scalar is related to a resizing ratio of the encoder and/or decoder network. For example, the scalar can be an integer number such as 16 for the decoder, and a fractional number such as 1/16 for the encoder. Hence, in the second signaling example, H1 and W1 are not signaled in the bitstream, but rather are derived from the signaled size of the respective input sub-set L1. Moreover, the scalar is an example of a resizing parameter.

### Third Signaling Example

In the third example of the signaling, the amount of overlap y between the regions Li is not predetermined, but rather signaled in the bitstream. The cropping amount X of an output sub-set is then determined based on the cropping amount y of the input sub-set according to a formula such as:
X=y*scalar wherein the scalar is a positive number. The scalar is related to a resizing ratio of the encoder and/or decoder network. For example, the scalar can be an integer number such as 16 for the decoder and a fractional number such as 1/16 for the encoder.

It is noted that the present disclosure is not limited to a particular framework. Moreover, the present disclosure is not restricted to image or video compression, and may be applied to object detection, image generation, and recognition systems as well.

The invention can be implemented in hardware (HW) and/or software (SW). Moreover, HW-based implementations may be combined with SW-based implementations.

For the purpose of clarity, any one of the foregoing embodiments may be combined with any one or more of the other foregoing embodiments to create a new embodiment within the scope of the present disclosure.

The encoding and decoding processing described above and performed by the VAE-encoder-decoder shown in FIG. 25 may be implemented within the coding system 10 of FIG. 1A. Thereby, the source device 12 represents the encoding side, providing for the compression of input picture data 21 including the input tensor x of FIG. 25, which may be the respective component Y and UV, respectively. In particular, encoder 20 of FIG. 1A may include modules for processing (e.g. compression and/or decompression) according to the present disclosure for processing multiple component independently. For example, encoder 20 of FIG. 1A may include encoder 2501, quantizer or RDOQ 2502, and arithmetic encoder 1605 for processing the luma component Y. Encoder 20 may further include modules of the hyperprior, such as hyper decoder 2503, quantizer or RDOQ 2504, and artithmetic encoder 1609. In addition, encoder 20 of FIG. 1A may include encoder 2508, quantizer or RDOQ 2509, and arithmetic encoder 1605 for processing the chroma component(s) UV. Encoder 20 may further include modules of the hyperprior, such as hyper decoder 2510, quantizer or RDOQ 2511, and artithmetic encoder 1609.

Likewise, the destination device 14 of FIG. 1A represents the decoding side, providing decompression of an input tensor representing the picture data. In particular, decoder 30 of FIG. 1A may include modules for decompression processing of the luma component Y, such as decoder 2506 and post-filer 2507 of FIG. 25, along with arithmetic decoder 1606. In addition, decoder 30 may further include the hyperprior for decoding 2, such as arithmetic decoder 1610, hyper decoder 2505, and arithmetic decoder 1606. Decoder 30 may further include the hyperprior for decoding 2, such as arithmetic decoder 1610, hyper decoder 2505, and arithmetic decoder 1606. For processing the chroma component(s) UV, decoder 30 may include decoder 2513 and post-filer 2514 of FIG. 25, along with arithmetic decoder 1606. In addition, decoder 30 may further include the hyperprior for decoding 2 for chroma(s), such as arithmetic decoder 1606, hyper decoder 2512, and arithmetic decoder 1610. In other words, encoder 20 and decoder 30 of FIG. 1A may be implemented and configured such as to include any of the modules of FIG. 25 to realize the encoding or decoding processing of multiple components in respective pipeline (e.g. luma and chroma pipeline) according to the present disclosure, where the input tensor has multiple components divided into multiple tiles and processed as described in the SECOND EMBODIMENT. While FIG. 1A shows encoder 20 and decoder 30 separately, they may be implemented via processing circuitry 46 of FIG. 1B. in other words, processing circuitry 46 may provide the functionality of the encoding-decoding processing of the present disclosure by implementing circuitry for the modules of FIG. 25 of the respective pipeline or both pipelines (luma and/or chroma).

Similarly, the video coding device 200 with its coding module 270 of processor 230 of FIG. 2 may perform functions of processing (compression and decompression) of the present disclosure. For example, the video coding device 200 may be an encoder or decoder having the respective modules of FIG. 25, so as to perform the encoding or decoding processing as described above.

The apparatus 300 of FIG. 3 may be implemented as encoder and/or decoder, which have the encoder 2501, 2508, quantizer or RDOQ 2502, 2509, decoder 2506, 2513, post-filter 2507, 2514, hyper encoder 2503, 2510, and hyper decoder 2505, 2512, along with arithmetic encoders 2505, 2509, and arithmetic decoders 2506, 2510, so as to perform the processing of tiles for each component, as discussed according to the SECOND EMBODIMENT. For example, the processor 302 of FIG. 3 may have respective circuitry to execute the compression and/or decompression processing according to the methods described before.

The example implementation of encoder 20 shown in FIG. 4 and of decoder 30 shown in FIG. 5 may implement as well the functions of encoding and decoding of the present disclosure. For example, partition unit 452 in FIG. 4 may perform the dividing of the first and/or second tensor into the first and/or second plurality of tiles for the first component and second component, respectively, as performed by encoder 2501 and 2508 of FIG. 25. Thereby, the syntax elements 465 may include the indication(s) for the sizes and positions of the tiles, along with indication of filter index or the like. Likewise, quantization unit 408 may perform quantization or RDOQ of RDOQ module 2502 and 2509 in FIG. 25, while entropy encoding unit 470 may implement functions of the hyperprior (i.e. modules 2503, 2505, 2510, 2511, 1605, 1608, 1609). In turn, entropy decoding unit 504 of FIG. 5 may perform the function of decoder 2506 and 2513 of FIG. 25 by dividing of encoded picture data 21 (input tensor) into tiles, along with parsing the indications for the tiles sizes or positions etc. from the bitstream as syntax element 566. Entropy decoding unit 504 may further implement the modules of the hyperprior (i.e. modules 2505, 2512, 1610). The post filtering 2507 and 2514 of FIG. 25 may be performed, for example, also by entropy decoding unit 504. Alternatively, post-filter 2507 and 2514 may be implemented within the mode application unit 560 as additional unit (not shown in FIG. 5).

### Further Embodiments

According to an aspect of the present disclosure, a method is provided for encoding an input tensor representing picture data, the method comprising steps of: processing the input tensor by a neural network that includes at least a first subnetwork and a second subnetwork, the processing comprising: applying the first subnetwork to a first tensor including dividing the first tensor in spatial dimensions into a first plurality of tiles and processing the first plurality of tiles by the first subnetwork; after applying the first subnetwork, applying the second subnetwork to a second tensor including dividing the second tensor in the spatial dimensions into a second plurality of tiles and processing the second plurality of tiles by the second subnetwork; and wherein at least two respective collocated tiles of the first plurality of tiles and the second plurality of tiles differ in size. As a result, an input tensor representing picture data may be more efficiently encoded by varying the tile size for different subnetworks. Moreover, hardware limitations and requirements may be taken into account.

In some exemplary implementations, tiles of the first plurality of tiles that are adjacent in at least one dimension of the spatial dimensions partly overlap; and/or tiles of the second plurality of tiles that are adjacent in at least one dimension of the spatial dimensions partly overlap. Thus, the quality of the reconstructed picture may be improved, in particular along the boundaries of the tiles. Hence, picture artefacts may be reduced.

In a further implementation, tiles of the first plurality of tiles are processed independently by the first subnetwork; and/or tiles of the second plurality of tiles are processed independently by the second subnetwork. For example, at least two tiles of the first plurality of tiles are processed in parallel by the first subnetwork; and/or at least two tiles of the second plurality of tiles are processed in parallel by the second subnetwork. As a result, the encoding of picture data may be performed faster.

According to an implementation example, said dividing of the first tensor includes determining sizes of tiles in the first plurality of tiles based on a first predefined condition; and/or said dividing of the second tensor includes determining sizes of tiles in the second plurality of tiles based on a second predefined condition. For example, the first predefined condition and/or the second predefined condition is based on available decoder hardware resources and/or motion present in the picture data. Hence, the tile sizes may be adapted and optimized according to available encoder and/or decoder resources and/or according to picture content.

In one example, the first subnetwork performs processing by one or more layers including at least one convolutional layer and at least one pooling layer; and/or the second subnetwork performs processing by one or more layers including at least one convolutional layer and at least one pooling layer. Thus, the input tensor data can be efficiently processed as the convolutional networks are particularly suitable for processing data in spatial dimensions.

In a further example, the first subnetwork and the second subnetwork perform respective processing that is a part of picture or moving picture compression. For example, the first subnetwork and/or the second subnetwork perform one of: picture encoding by a convolutional subnetwork; and rate distortion optimization quantization, RDOQ; and picture filtering. Hence, the encoding of picture data may involve subnetwork processing at a plurality of relevant stages and improve the coding efficiency.

According to an implementation example, the input tensor is a picture or a sequence of pictures including one or more components of which at least one is a color component. This may enable the encoding of a color component(s). In an example, the input tensor has at least two components, namely a first component and a second component; and the first subnetwork divides the first component into a third plurality of tiles and divides the second component into a fourth plurality of tiles, wherein at least two respective collocated tiles of the third plurality of tiles and the fourth plurality of tiles differ in size; and/or the second subnetwork divides the first component into a fifth plurality of tiles and divides the second component into a sixth plurality of tiles, wherein at least two respective collocated tiles of the fifth plurality of tiles and the sixth plurality of tiles differ in size. As a result, multiple components may be subject to encoding processing on a tile-basis with different tile sizes for a component, which may lead to a further improvement of coding efficiency and/or hardware implementation.

A further implementation example comprises generating a bitstream by including into the bitstream an output of the processing by the neural network. Said implementation comprises further including into the bitstream an indication of size of the tiles in the first plurality of tiles and/or an indication of size of the tiles of the second plurality of tiles. Thus, by providing the indication, the encoder and decoder may set the tile size in a corresponding and adaptive manner.

According to an aspect of the present disclosure, a method is provided for decoding a tensor representing picture data, the method comprising steps of: processing an input tensor representing the picture data by a neural network that includes at least a first subnetwork and a second subnetwork, the processing comprising: applying the first subnetwork to a first tensor including dividing the first tensor in spatial dimensions into a first plurality of tiles and processing the first plurality of tiles by the first subnetwork; after applying the first subnetwork, applying the second subnetwork to a second tensor including dividing the second tensor in the spatial dimensions into a second plurality of tiles and processing the second plurality of tiles by the second subnetwork; and wherein at least two respective collocated tiles of the first plurality of tiles and the second plurality of tiles differ in size. As a result, an input tensor representing picture data may be more efficiently decoded by varying the tile size for different subnetworks. Moreover, hardware limitations and requirements may be taken into account.

In some exemplary implementations, tiles of the first plurality of tiles that are adjacent in at least one dimension of the spatial dimensions partly overlap; and/or tiles of the second plurality of tiles that are adjacent in at least one dimension of the spatial dimensions partly overlap. Thus, the quality of the reconstructed picture may be improved, in particular along the boundaries of the tiles. Hence, picture artefacts may be reduced.

In a further implementation, tiles of the first plurality of tiles are processed independently by the first subnetwork; and/or tiles of the second plurality of tiles are processed independently by the second subnetwork. For example, at least two tiles of the first plurality of tiles are processed in parallel by the first subnetwork; and/or at least two tiles of the second plurality of tiles are processed in parallel by the second subnetwork. As a result, the encoding of picture data may be performed faster.

According to an implementation example, said dividing of the first tensor includes determining sizes of tiles in the first plurality of tiles based on a first predefined condition; and/or said dividing of the second tensor includes determining sizes of tiles in the second plurality of tiles based on a second predefined condition. For example, the first predefined condition and/or the second predefined condition is based on available decoder hardware resources and/or motion present in the picture data. Hence, the tile sizes may be adapted and optimized according to available encoder and/or decoder resources and/or according to picture content.

In one example, the first subnetwork performs processing by one or more layers including at least one convolutional layer and at least one pooling layer; and/or the second subnetwork performs processing by one or more layers including at least one convolutional layer and at least one pooling layer. Thus, the input tensor data can be efficiently processed as the convolutional networks are particularly suitable for processing data in spatial dimensions.

In a further example, the first subnetwork and the second subnetwork perform respective processing that is a part of picture or moving picture decompression. For example, the first subnetwork and/or the second subnetwork perform one of: picture decoding by a convolutional subnetwork; and picture filtering. Hence, the decoding of picture data may involve subnetwork processing at a plurality of relevant stages and improve the coding efficiency.

According to an implementation example, the input tensor is a picture or a sequence of pictures including one or more components of which at least one is a color component. This may enable the decoding of a color component(s). In an example, the input tensor has at least two components, namely a first component and a second component; and the first subnetwork divides the first component into a third plurality of tiles and divides the second component into a fourth plurality of tiles, wherein at least two respective collocated tiles of the third plurality of tiles and the fourth plurality of tiles differ in size; and/or the second subnetwork divides the first component into a fifth plurality of tiles and divides the second component into a sixth plurality of tiles, wherein at least two respective collocated tiles of the fifth plurality of tiles and the sixth plurality of tiles differ in size. As a result, multiple components may be subject to decoding processing on a tile-basis with different tile sizes for a component, which may lead to a further improvement of coding efficiency and/or hardware implementation.

A further implementation example comprises extracting the input tensor from a bitstream for the processing by the neural network. Thus, the input tensor may be quickly extracted.

According to an implementation, the second subnetwork performs picture post-filtering; for at least two tiles of the second plurality of tiles one or more parameters of post-filtering differ and are extracted from said bitstream. Hence, the decoding of picture data may involve subnetwork processing at a plurality of relevant stages and improve the coding efficiency. Moreover, the post filtering may be performed with filter parameters adapted to the tiles sizes, improving the quality of the reconstructed picture data.

In an example, further comprised is parsing from the bitstream an indication of size of the tiles in the first plurality of tiles and/or an indication of size of the tiles of the second plurality of tiles. Thus, by providing the indication, the encoder and decoder may set the tile size in the corresponding and adaptive manner.

According to an aspect of the present disclosure, provided is a computer program stored on a non-transitory medium comprising code which when executed on one or more processors performs steps of any of the previous aspects of the present disclosure.

According to an aspect of the present disclosure, a processing apparatus is provided for encoding an input tensor representing picture data, the processing apparatus comprising a processing circuitry configured to: process the input tensor by a neural network that includes at least a first subnetwork and a second subnetwork, the processing comprising: applying the first subnetwork to a first tensor including dividing the first tensor in spatial dimensions into a first plurality of tiles and processing the first plurality of tiles by the first subnetwork; after applying the first subnetwork, applying the second subnetwork to a second tensor including dividing the second tensor in the spatial dimensions into a second plurality of tiles and processing the second plurality of tiles by the second subnetwork; and wherein at least two respective collocated tiles of the first plurality of tiles and the second plurality of tiles differ in size.

According to an aspect of the present disclosure, a processing apparatus is provided for encoding an input tensor representing picture data, the processing apparatus comprising: one or more processors; and a non-transitory computer-readable storage medium coupled to the one or more processors and storing programming for execution by the one or more processors, wherein the programming, when executed by the one or more processors, configures the encoder to carry out the method related to encoding an input tensor representing picture data.

According to an aspect of the present disclosure, a processing apparatus is provided for decoding a tensor representing picture data, the processing apparatus comprising a processing circuitry configured to: process an input tensor representing the picture data by a neural network that includes at least a first subnetwork and a second subnetwork, the processing comprising: applying the first subnetwork to a first tensor including dividing the first tensor in spatial dimensions into a first plurality of tiles and processing the first plurality of tiles by the first subnetwork; after applying the first subnetwork, applying the second subnetwork to a second tensor including dividing the second tensor in the spatial dimensions into a second plurality of tiles and processing the second plurality of tiles by the second subnetwork; and wherein at least two respective collocated tiles of the first plurality of tiles and the second plurality of tiles differ in size.

According to an aspect of the present disclosure, a processing apparatus is provided for decoding a tensor representing picture data, the processing apparatus comprising: one or more processors; and a non-transitory computer-readable storage medium coupled to the one or more processors and storing programming for execution by the one or more processors, wherein the programming, when executed by the one or more processors, configures the decoder to carry out the method related to decoding a tensor representing picture data.

Summarizing, the present disclosure relates to neural-network-based picture encoding and decoding of image regions on tile-basis. An input tensor representing picture data is processed by the neural network, which includes at least a first and second subnetwork. The first subnetwork is applied to a first tensor where the first tensor is divided in a spatial dimensions into a first plurality of tiles. The first tiles are then further processed by the first subnetwork. After application of the first subnetwork, the second subnetwork is applied to a second tensor where the second tensor is divided in the spatial dimensions into a second plurality of tiles. The second tiles are then further processed by the second subnetwork. Among the first and second plurality of tiles there are at least two respective collocated tiles differing in size. In case of encoding, the first and second subnetworks perform part of compression, including picture encoding, rate distortion optimization quantization, and picture filtering. In case of decoding, the first and second subnetworks perform part of decompression, including picture decoding and picture filtering.

Moreover, the present disclosure relates to picture encoding and decoding of image regions on tile-basis. In particular, multiple components of an input tensor including a first and second component in spatial dimensions is processed within multiple pipelines. The processing of the first component includes dividing the first component in the spatial dimensions into a first plurality of tiles. Likewise, the processing of the second component includes dividing the second component in the spatial dimensions into a second plurality of tiles. The respective first and second plurality of tiles are then processed each separately. Among the first and second plurality of tiles there are at least two respective collocated tiles differing in size. In case of compression, the processing of the first and/or second component includes picture encoding, rate distortion optimization quantization, and picture filtering. In case of decompression, the processing includes picture decoding and picture filtering.

What is claimed is:

1. A method for processing an input tensor representing picture data, wherein the method is applied to an electronic device and comprises:
processing a plurality of components of the input tensor including a first component and a second component in spatial dimensions, including:
processing the first component including dividing the first component in the spatial dimensions into a first plurality of tiles and processing each tile of the first plurality of tiles separately;
processing the second component including dividing the second component in the spatial dimensions into a second plurality of tiles and processing each tile of the second plurality of tiles separately; and
wherein at least two respective collocated tiles of the first plurality of tiles and the second plurality of tiles differ in size.

2. The method according to claim 1, wherein
at least two tiles of the first plurality of tiles are processed independently or in parallel; and/or
at least two tiles of the second plurality of tiles are processed independently or in parallel.

3. The method according to claim 1, wherein
the first component represents luma component of the picture data; and
the second component represents a chroma component of the picture data.

4. The method according to claim 1, wherein
tiles of the first plurality of tiles that are adjacent in at least one dimension of the spatial dimensions partly overlap; and/or
tiles of the second plurality of tiles that are adjacent in at least one dimension of the spatial dimensions partly overlap.

5. The method according to claim 1, wherein:
the dividing of the first component further includes determining sizes of tiles in the first plurality of tiles based on a first predefined condition; and/or
the dividing of the second component further includes determining sizes of tiles in the second plurality of tiles based on a second predefined condition.

6. The method according to claim 5, wherein
the first predefined condition and/or the second predefined condition is based on available decoder hardware resources and/or motion present in the picture data.

7. The method according to claim 5, wherein the determining the sizes of tiles in the second plurality of tiles further includes scaling the tiles of the first plurality of tiles.

8. The method according to claim 5, wherein an indication of the determined sizes of tiles in the first plurality of tiles and/or in the second plurality of tiles is encoded into a bitstream.

9. The method according to claim 1, wherein sizes of all tiles in the first plurality of tiles is same and/or sizes of all tiles in the second plurality of tiles is same.

10. The method according to claim 8, wherein the indication further includes positions of the tiles in the first plurality of tiles and/or positions of the tiles in the second plurality of tiles.

11. The method according to claim 8, wherein
the first component is a luma component and the indication of the sizes of the tiles of the first plurality of tiles is included in the bitstream; and
the second component is a chroma component and the indication of a scaling factor is included in the bitstream, wherein the scaling factor relates the sizes of the tiles of the first plurality of tiles and the sizes of the tiles of the second plurality of tiles.

12. The method according to claim 8, wherein the processing of the input tensor further includes: processing that is part of a picture or moving picture compression.

13. The method according to claim 12, wherein the processing of the first component and/or the second component further includes one of:
picture encoding by a neural network;
rate distortion optimization quantization (RDOQ); and
picture filtering.

14. The method according to claim 12, further comprising:
generating the bitstream by including an output of the processing of the first component and the second component into the bitstream.

15. The method according to claim 8, wherein the processing of the input tensor further includes: processing that is part of a picture or moving picture decompression.

16. The method according to claim 15, wherein the processing of the first component and/or the second component further includes one of:
picture decoding by a neural network; and
picture filtering.

17. The method according to claim 16, wherein the processing of the second component further includes: decoding of a chroma component of the picture based on a representation of a luma component of the picture.

18. The method according to claim 12, wherein
the processing of the first component and/or the second component further includes picture post-filtering;
for at least two tiles of the first plurality of tiles, one or more parameters of post-filtering differ and are extracted from the bitstream; and
for at least two tiles of the second plurality of tiles, one or more parameters of post-filtering differ and are extracted from the bitstream.

19. The method according to claim 1, wherein the input tensor is a picture or a sequence of pictures including one or more components, among the plurality of components, at least one of which is a color component.

20. A non-transitory computer readable medium comprising code for execution by one or more processors, which upon executing the code is configured to perform the method according to claim 1.

21. An apparatus for processing an input tensor representing picture data, the apparatus comprising processing circuitry configured to:
process a plurality of components of the input tensor including a first component and a second component in spatial dimensions, including:
processing the first component including dividing the first component in the spatial dimensions into a first plurality of tiles and processing each tile of the first plurality of tiles separately;
processing the second component including dividing the second component in the spatial dimensions into a second plurality of tiles and processing each tile of the second plurality of tiles separately; and
wherein at least two respective collocated tiles of the first plurality of tiles and the second plurality of tiles differ in size.

22. An apparatus for processing an input tensor representing picture data, the apparatus comprising:
one or more processors; and
a non-transitory computer-readable storage medium coupled to the one or more processors and storing programming for execution by the one or more processors, wherein the programming, when executed by the one or more processors, configures the processing apparatus to carry out a method for processing an input tensor representing picture data, the method including:
processing a plurality of components of the input tensor including a first component and a second component in spatial dimensions, including:
processing the first component including dividing the first component in the spatial dimensions into a first plurality of tiles and processing each tile of the first plurality of tiles separately;
processing the second component including dividing the second component in the spatial dimensions into a second plurality of tiles and processing each tile of the second plurality of tiles separately; and
wherein at least two respective collocated tiles of the first plurality of tiles and the second plurality of tiles differ in size.
